(19) United States
(12) Patent Application Publication
(10) Pub. No.: US 2003/0231207 A1
(43) Pub. Date: Dec. 18, 2003

(54) Personal e-mail system and method

(76) Inventor: Baohua Huang, Fremont, CA (US)

Correspondence Address: RICHARD B. MAIN, PATENT ATTORNEY, 422 CAROLINA LANE, PALO ALTO, CA, 94306, US

(21) Appl. No.: 10/147,881

(22) Filed: May 20, 2002

Related U.S. Application Data
(60) Provisional application No. 60/374,276, filed on Apr. 22, 2002.
(60) Provisional application No. 60/370,615, filed on Apr. 9, 2002.
(60) Provisional application No. 60/370,616, filed on Apr. 9, 2002.
(60) Provisional application No. 60/371,248, filed on Apr. 10, 2002.
(60) Provisional application No. 60/370,618, filed on Apr. 9, 2002.
(60) Provisional application No. 60/370,617, filed on Apr. 9, 2002.
(60) Provisional application No. 60/367,249, filed on Mar. 26, 2002.
(60) Provisional application No. 60/371,247, filed on Apr. 10, 2002.
(60) Provisional application No. 60/366,942, filed on Mar. 25, 2002.

(51) Int. Cl. G09G 5/00

(52) U.S. Cl. 345/752

(57) ABSTRACT

A personal e-mail system comprises an ad-hoc computer host platform loaded with a personal e-mail application program. The host has Internet access and a user has previously established e-mail accounts at a variety of provider sites. The user is periodically delivered e-mail messages that are collected from such provider sites, and such are displayed according to any display limitations that exist with the particular host platform. The personal e-mail application program automatically and dynamically adjusts the protocols it uses to suit the particular provider site it is accessing, and uses user-provided user names and passwords to access the provider site to appear as if the user themselves has properly logged in. The personal e-mail application program then can send responses or issue new messages that are accepted by the provider site and issued by it as if originated from there.

### BACKGROUND OF THE INVENTION

1. Field of the Invention

The present invention relates to Internet e-mail, and more particularly to methods and devices for single-point accessing the e-mail accounts of a single individual hosted at a variety of diverse and proprietary mail servers on the Internet.

2. Description of Related Art

At the beginning of electronic-mail (e-mail) use in the United States, each user had one personal computer (PC) and they used it to access their one and only e-mail server. Collecting one's e-mail was simple. Later, users signed up with more than one e-mail server. But it was still pretty easy to access each e-mail server sequentially from the user-PC and answer messages. Application programs like OUTLOOK EXPRESS and EUDORA facilitated such access. Users also got more than one PC, and this too allowed the second PC to log on to each e-mail server one at a time. But if one of the PC's removed the messages from the server, it was no longer visible to the second PC.

E-mail has become an indispensable part of the way many people conduct their business and personal lives. Businesses recognize this and provide corporate e-mail accounts for their employees. Such businesses routinely restrict the employee's use of the business e-mail accounts to business use, and even go far as to police the use by monitoring messages. So individuals get their own personal e-mail accounts away from the office.

A wide variety of Internet Service Providers (ISP's) now provide monthly subscription access for individuals and small businesses to the Internet. These accounts always come with their own e-mail addresses and e-mail servers. Many such instances use standard mail protocols, such as post office protocol three (POP3), and can be readily accessed by Outlook Express, Eudora, and other e-mail application programs. But many ISP's have proprietary e-mail servers that require the user to be logged into their Internal URL-page on a browser, e.g., HOTMAIL, MSN, WEBMAIL, etc. Still others require that the user be logged into the particular ISP's dial-in or DSL modem before any access or any e-mails can be sent, e.g., America On-Line (AOL). Such requirements are enforced via proprietary, secret mail protocols and restricted Internet Protocol (IP) source addresses.

Popular ISP's in use in the United States include:

21stcentury.net, America Online (aol.com), ATT Broadband (attbi.com), ATT WorldNet (worldnet.att.net or att.net), BellSouth (bellsouth.net), Comcast (comcast.net), Compuserve 2000 (cs.com), Compuserve Classic (compuserve.com), concentric.net, chicagonet.net, core.com, corecomm.net, Delta Net (deltanet.com), Earthlink (earthlink.net), FreeServe (freeserve.net), Gateway (gateway.net), @home (home.com), Hotmail (hotmail.com), IHug (ihug.com.au), interaccess.com, Internet America (airmail.net), ioNET (ionet.net), itol.com, MauiNet (maui.net), MediaOne (mediaone.net), MindSpring (mindspring.com), MSN POP Mail (msn.com), MSN Web Mail (msn.com), NetCom (netcom.com.com), Netcom Canada (netcom.ca), netexpress.net, Netscape.net Free Web Mail (netscape.net), Netscape.net Premium POP (netscape.net), NetZero (netzero.net), Pacific Bell Internet (pacbell.net), Palm.net (palm.net), pcc.net, Pipeline (pipeline.com), Prodigy (prodigy.net), Smallville Communication (toto.net), SouthWestern Bell (swbell.net), Sprint Canada (sprint.ca), Sprynet (sprynet.com), SurfBest.Net (surfbest.net), Sympatico (sk.sympatico.ca), The Grid (thegrid.net), Usa.net (netaddress.com), Usa.net (netaddress.usa.net), US Internet (usit.net), WebCom (webcom.com), WebCombo (webcombo.net), WebTV (webtv.net), Yahoo (yahoo.com), etc.

As a result, a large number of e-mail users will have e-mail accounts at several, incompatible places. Collecting and sending mail from these diverse accounts requires logging into each and providing proper protocol, user names, and passwords. The chore can be onerous, and if the user is on the road away from home or office, it can be impossible because the available user-computer platforms may not be compatible or not logged-on through the required IP-addresses.

Personal digital assistants (PDA's) and cellphones are also now starting to provide e-mail access. In the case of cellphones, some have Internet browser capability, but their tiny displays prevent effective Internet surfing. So specialized and proprietary e-mail graphical user interfaces (GUI's) have appeared to support such PDA and cellphone e-mail users. Such devices are very compelling because they are so mobile and ubiquitous. But trying to use them to access e-mail accounts on enterprise, AOL, MSN, HOTMAIL, and other ISP, and combinations of these has proved difficult.

So, companies like ONEBOX.COM provide a mail-grabber product that allows users to get e-mail, voice e-mail, fax, and voicemail, all in one place. Such “unified messaging” combines a user's voice, fax, e-mail, conferencing, and mobile communications into one seamless platform. Onebox consolidates voicemail, email and faxes into one mailbox, accessible by computer or phone. A single graphical user interface (GUI) is presented for all messages. The ONEBOX product accesses each e-mail server a user has an account with, and collects them all at an inbox at the ONEBOX website. Answers to messages issue from the ONEBOX server. Therefore, a user must always check both the original e-mail server and the ONEBOX server to see if any further responses were received.

Openwave Systems, Inc. (Redwood City, Calif.: openwave.com) markets IP-based communications infrastructure software and applications, e.g., Openwave Unified Messaging. Subscribers can access voice, fax and email messages from a single mailbox using a wireline phone, wireless phone, Internet-enabled mobile phone, or PC. Openwave's solution offers subscribers an easy to use application with a consistent user interface and fully integrated PIM. Openwave Unified Messaging enables “Voicemail Anywhere”, allowing users to forward voice messages to anyone with an email address. In addition, users can “Reply-by-Voice” to any message, and can personalize the service so that they are notified of urgent emails or voice messages via PC, telephone, or pager.

For remote delivery, the transport software used depends on the nature of the link. Mail delivered over a network using TCP/IP commonly uses Simple Mail Transfer Protocol (SMTP), which is described in RFC-821. The SIMPLE MAIL TRANSFER PROTOCOL was published in a Request for Comments (RFC) by Jonathan B. Postel, August 1982, at the Information Sciences Institute, University of Southern California. It is now superceded by RFC-2821. SMTP was designed to deliver mail directly to a recipient's machine, negotiating the message transfer with the remote side's SMTP daemon. Today it is common practice for organizations to establish special hosts that accept all mail for recipients in the organization and for that host to manage appropriate delivery to the intended recipient.

SMTP is independent of the particular transmission subsystem and requires only a reliable ordered data stream channel. While this document specifically discusses transport over TCP, other transports are possible. Appendices to RFC 821 describe some of them.

An important feature of SMTP is its capability to transport mail across networks, usually referred to as “SMTP mail relaying” (RFC-2821 section 3.8). A network consists of the mutually-TCP-accessible hosts on the public Internet, the mutually-TCP-accessible hosts on a firewall-isolated TCP/IP Intranet, or hosts in some other LAN or WAN environment utilizing a non-TCP transport-level protocol. Using SMTP, a process can transfer mail to another process on the same network or to some other network via a relay or gateway process accessible to both networks. In this way, a mail message may pass through a number of intermediate relay or gateway hosts on its path from sender to ultimate recipient. The Mail exchanger mechanisms of the domain name system are used to identify the appropriate next-hop destination for a message being transported.

E-mail addresses are made up of at least two parts. One part is the name of a mail domain that will ultimately translate to either the recipient's host or some host that accepts mail on behalf of the recipient. The other part is some form of unique user identification that may be the login name of that user, the real name of that user in “Firstname.Lastname” format, or an arbitrary alias that are translated into a user or list of users. Other mail addressing schemes, like X.400, use a more general set of “attributes” that are used to look up the recipient's host in an X.500 directory server. How email addresses are interpreted depends greatly on what type of network one use. In SMTP the result of a user mail request is the establishment by the sender-SMTP of a two-way transmission channel to a receiver-SMTP. The receiver-SMTP may be either the ultimate destination or an intermediate. SMTP commands are generated by the sender-SMTP and sent to the receiver-SMTP. SMTP replies are sent from the receiver-SMTP to the sender-SMTP in response to the commands. Once the transmission channel is established, the SMTP-sender sends a MAIL command indicating the sender of the mail. If the SMTP-receiver can accept mail it responds with an OK reply. The SMTP-sender then sends a RCPT command identifying a recipient of the mail. If the SMTP-receiver can accept mail for that recipient it responds with an OK reply; if not, it responds with a reply rejecting that recipient, but not the whole mail transaction. The SMTP-sender and SMTP-receiver may negotiate several recipients.

When the recipients have been negotiated, the SMTP-sender sends the mail data, terminating with a special sequence. If the SMTP-receiver successfully processes the mail data it responds with an OK reply. The dialog is purposely lock-step, one-at-a-time. The SMTP provides mechanisms for the transmission of mail. Directly from the sending user's host to the receiving user's host when the two host are connected to the same transport service. Or via one or more relay SMTP-servers when the source and destination hosts are not connected to the same transport service. To be able to provide the relay capability the SMTP-server must be supplied with the name of the ultimate destination host as well as the destination mailbox name. The argument to the MAIL command is a reverse-path, which specifies who the mail is from. The argument to the RCPT command is a forward-path, which specifies who the mail is to. The forward-path is a source route, while the reverse-path is a return route. Such may be used to return a message to the sender when an error occurs with a relayed message.

When the same message is sent to multiple recipients, SMTP encourages the transmission of only one copy of the data for all the recipients at the same destination host. The mail commands and replies have a rigid syntax. Replies also have a numeric code. A command or reply word may be upper case, lower case, or any mixture of upper and lower case. Such is not true of mailbox user names. For some hosts the user name is case sensitive, and SMTP implementations must preserve the case of user names as they appear in mailbox arguments. Host names are not case sensitive.

There are three steps to SMTP mail transactions. The transaction is started with a MAIL command which gives the sender identification. A series of one or more RCPT commands follows giving the receiver information. Then a DATA command gives the mail data. And finally, the end of mail data indicator confirms the transaction. The first step in the procedure is the MAIL command. The <reverse-path> comprises the source mailbox. The MAIL <SP> FROM: <reverse-path> <CRLF> command tells the SMTP-receiver that a new mail transaction is starting and to reset all its state tables and buffers, including any recipients or mail data. It gives the reverse-path which can be used to report errors. If accepted, the receiver-SMTP returns a 250 OK reply. The <reverse-path> can contain more than just a mailbox. The <reverse-path> is a reverse source routing list of hosts and source mailbox. The first host in the <reverse-path> should be the host sending this command.

The second step in the procedure is the RCPT command. The RCPT <SP> TO: <forward-path> <CRLF> command gives a forward-path identifying one recipient. If accepted, the receiver-SMTP returns a 250 OK reply, and stores the forward-path. If the recipient is unknown the receiver-SMTP returns a 550 Failure reply. Such second step of the procedure can be repeated any number of times. The <forward-path> can contain more than just a mailbox. The <forward-path> is a source routing list of hosts and the destination mailbox. The first host in the <forward-path> should be the host receiving this command.

The third step in the procedure is the DATA command, DATA <CRLF>. If accepted, the receiver-SMTP returns a 354 Intermediate reply and considers all succeeding lines to be the message text.

When the end of text is received and stored the SMTP-receiver sends a 250 OK reply. Since the mail data is sent on the transmission channel the end of the mail data must be indicated so that the command and reply dialog can be resumed. SMTP indicates the end of the mail data by sending a line containing only a period. A transparency procedure is used to prevent this from interfering with the user's text. The mail data includes the memo header items such as Date, Subject, To, Cc, From. The end of mail data indicator also confirms the mail transaction and tells the receiver-SMTP to now process the stored recipients and mail data. If accepted, the receiver-SMTP returns a 250 OK reply. The DATA command should fail only if the mail transaction was incomplete, e.g., no recipients, or if resources are not available.

### SUMMARY OF THE INVENTION

An object of embodiments of the present invention is to provide a system and method for automatically accessing all the e-mail accounts of a particular user no matter where hosted.

Another object of embodiments of the present invention is to provide a system and method for responding to e-mail messages from the e-mail server that handled the original incoming message.

A further object of embodiments of the present invention is to provide a system and method for accessing and responding to e-mail messages on a wide diversity of standard and proprietary e-mail servers from whatever hardware/software platform the user presently has at their disposal.

Briefly, a personal e-mail embodiment of the present invention comprises an ad-hoc computer host platform loaded with a personal e-mail application program. The host has Internet access and a user has previously established e-mail accounts at a variety of provider sites. The user is periodically delivered e-mail messages that are collected from such provider sites, and such are displayed according to any display limitations that exist with the particular host platform. The personal e-mail application program automatically and dynamically adjusts the protocols it uses to suit the particular provider site it is accessing, and uses user-provided user names and passwords to access the provider site to appear as if the user themselves has properly logged in. The personal e-mail application program then can send responses or issue new messages that are accepted by the provider site and issued by it as if originally from there.

An advantage of the present invention is a method and device are provided for improved e-mail access.

Another advantage of the present invention is that a method and device are provided that simplify the chore experienced by a user in collecting e-mail messages from a variety of service providers.

Such and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a dataflow diagram of a personal e-mail system embodiment of the present invention;

FIG. 2 is a function block diagram of a personal e-mail system embodiment of the present invention, and represents one way to implement the system of FIG. 1;

FIG. 3 represents a virtual “one box” e-mail solution, and represents one way to implement the system of FIG. 2;

FIG. 4 is a diagram of a single interface technology that provides one standardized user interface for the same user experience on any mobile or desktop device and computer;

FIG. 5 is a diagram of a smart spam filter which processes incoming raw and decoded e-mail data, and is one way to implement a part of the system of FIG. 2;

FIG. 6 illustrates a smart spam mechanism method embodiment of the present invention, and is one way to implement a part of the system of FIG. 2;

FIG. 7 illustrates a guaranteed e-mail mechanism method embodiment of the present invention, and is one way to implement a part of the system of FIG. 2;

FIG. 8 illustrates an e-mail abstraction layer embodiment of the present invention, and is one way to implement a part of the system of FIG. 2;

FIG. 9 represents a typical email session using the abstraction layer, and is one way to implement a part of the system of FIG. 2;

FIG. 10 represents an encrypted e-mail processor embodiment of the present invention, and is one way to implement a part of the system of FIG. 2;

FIG. 11 represents a HOTMAIL system access method embodiment of the present invention, and is one way to implement a part of the system of FIG. 2;

FIG. 12 represents an MSN Webmail system access method embodiment of the present invention, and is one way to implement a part of the system of FIG. 2;

FIG. 13 represents an AOL system access method embodiment of the present invention, and is one way to implement a part of the system of FIG. 2; and

FIGS. 14A and 14B represent an MSN POP system access method embodiment of the present invention, and suggest one way to implement that part of the system of FIG. 2.

### DETAILED DESCRIPTION OF THE INVENTION

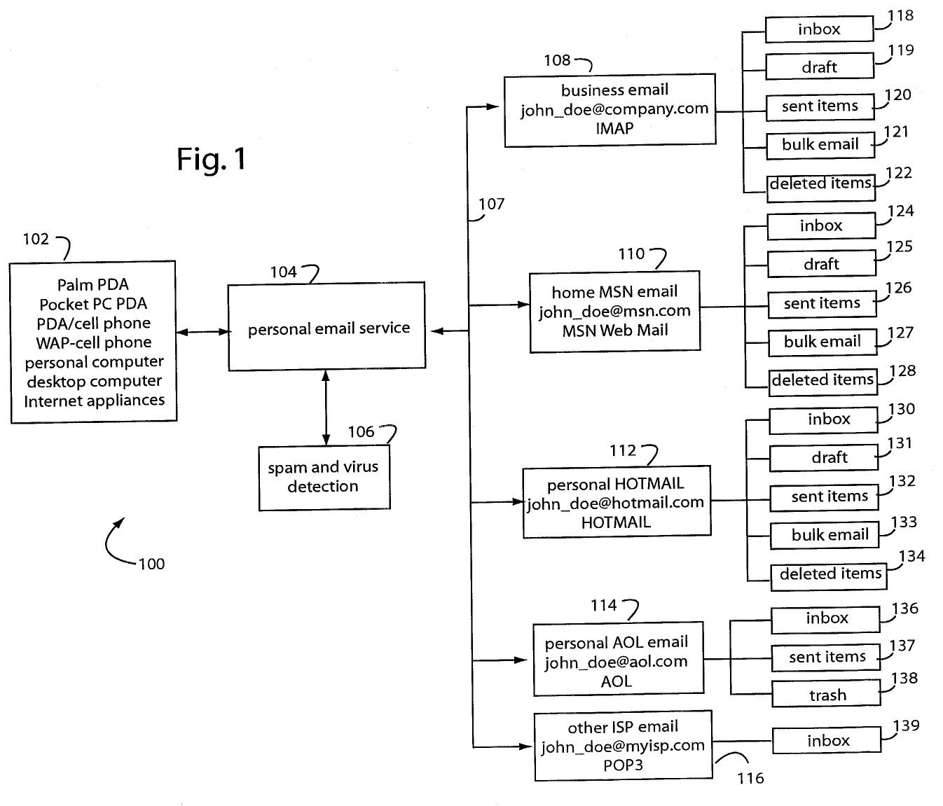

FIG. 1 represents a personal e-mail system embodiment of the present invention, and is referred to herein by the general reference numeral 100. The system 100 provides e-mail account access to remote Internet sites from an ad-hoc computer platform 102. For example, such ad-hoc computer platform 102 can be a Palm-type personal digital assistant (PDA), Pocket personal computer (PC) PDA, PDA/cellphone, WAP-cellphone, PC or Macintosh, desktop computer, Internet appliance, etc. Whatever the user has handy and available. A personal e-mail service program 104 is hosted on the ad-hoc computer platform 102 and provides centralized and automatic e-mail account access from corporate, Internet Service Provider (ISP), and web-based e-mail servers. A spam and virus filter 106 protects the personal e-mail service program 104 from unwanted messages and computer infections. Access is generally over an Internet connection 107, which can be digital subscriber link (DSL), dial-up modem, wireless, local area network (LAN), etc. The personal e-mail service program 104 is provided to the user as a one-time-purchase, monthly subscription, per-use fee, shareware, or freeware, according a business agreement. Such personal e-mail service program 104 can be preloaded in the ad-hoc computer platform 102, downloaded from the Internet, or installed from disk. The user then provides account identification (user-ID) and password to use with a variety of mail server sites, e.g., a company Internet Message Access Protocol (IMAP) 108, MSN Webmail 110, HOTMAIL 112, America On-Line (AOL) 114, and other ISP accounts (POP3) 116.

In the example of FIG. 1, the personal e-mail service program 104 accesses inbox, draft, sent-item, bulk e-mail, and deleted item folders, on behalf of the user. Access to the company IMAP 108 will allow communication with inbox folder 118, draft folder 119, sent-item folder 120, bulk e-mail folder 121, and deleted item folder 122. Similarly, access to the MSN Webmail 110 will allow communication with inbox folder 124, draft folder 125, sent-item folder 126, bulk e-mail folder 127, and deleted item folder 128. Access to the HOTMAIL 112 will allow communication with inbox folder 130, draft folder 131, sent-item folder 132, bulk e-mail folder 133, and deleted item folder 134. The AOL account 114 has an inbox 136, a sent items 137, and trash 138. Other POP3 accounts 116, e.g., john_doe@myisp.com, will have at least an inbox 139. A typical user, John Doe, can therefore access the servers in which e-mail was delivered to any and all of john_doe@company.com, john_doe@msn.com, john_doe@hotmail.com, john_doe@aol.com, and john_doe@myisp.com. Their responses will all actually or appear to come from those respective e-mail servers. Detailed information on the use and operation of such embodiments of the present invention are disclosed in the U.S. Provisional Patent Application of the present inventor, Baohua HUANG, serial No. 60/374,276, filed Apr. 22, 2002, titled PERSONAL E-MAIL SYSTEM. Such is incorporated herein by reference.

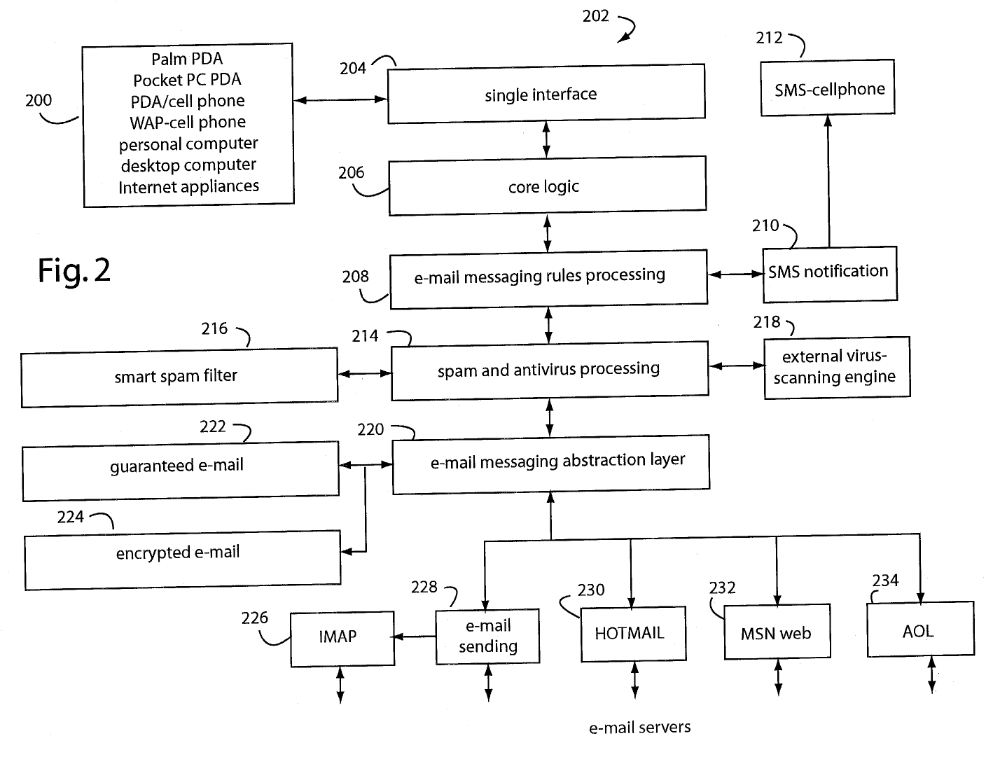

FIG. 2 represents a personal e-mail system embodiment of the present invention, and is referred to herein by the general reference numeral 200. The system 200 provides e-mail account access to remote e-mail servers. A host platform 202 is provided with a single interface 204 that allows users to display and manipulate their e-mails in a standardized way. A core logic 206 provides an interface and some data manipulation. An e-mail messaging rules processor 208 provides a standardized SMTP electronic mail RFC-821-type of e-mail interface from the many incompatible e-mail types being transferred at lower levels, e.g., IMAP, POP, MSN Webmail, HOTMAIL, AOL, etc.

Most digital cell phones have the ability to receive short text messages. Such is sometimes called short message service (SMS) or text paging. So an SMS notification module 210 is connected to relay messages to and from an SMS-cellphone 212.

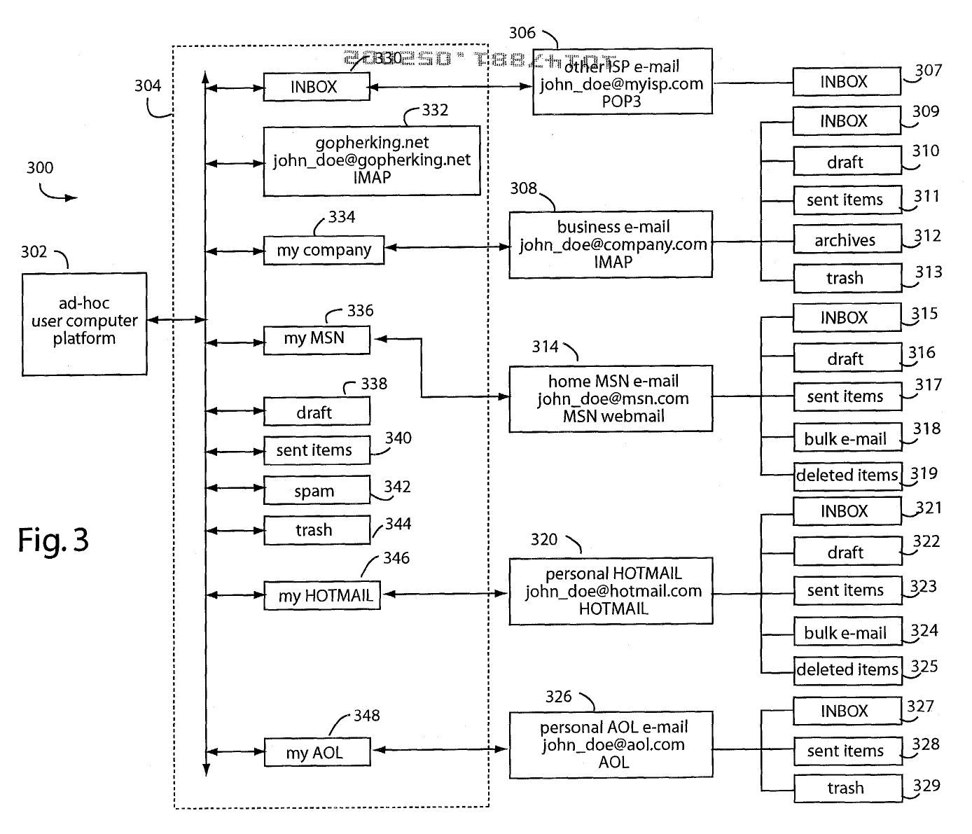

Spam and virus protection is so necessary and critical today, that a spam and antivirus processor 214 is needed. Such is supported by a smart spam-filter 216 and an external virus-scanning engine 218. A commercial product and service like MCAFEE and NORTON can be used for the virus scanning engine. An e-mail abstraction layer 220 process and strips out the important parts of e-mail messages trafficking through the system 100. Such is supported by a guaranteed e-mail service 222 and encrypted e-mail service 224. Specific e-mail accounts on the Internet are accessed an IMAP engine 226, an e-mail sender 228, a HOTMAIL engine 230, an MSN Webmail engine 232, an AOL engine 234, etc. Details on several of these processors, engines, and services are described in more detail in connection with FIGS. 3-13.

FIG. 3 represents a virtual “one box” e-mail solution 300 that begins with whatever user computer platform 302 is available. A personal e-mail application 304 is hosted on the platform 302 to access all e-mail accounts that a particular user, e.g., John Doe, may have at various mail servers. For example, an ordinary POP3 account 306 could be hosted at an ISP named myisp.com. An INBOX 307 is accessible there. A business e-mail account 308 is hosted at a company mail server with IMAP mail protocol rules, e.g., john_doe@company.com. Such account has an INBOX folder 309, a drafts folder 310, a sent-items folder 311, an archives folder 312, and a trash folder 313. An MSN Webmail account 314 is accessed with e-mail address, john_doe@msn.com. Such account has an INBOX 315, a drafts folder 316, a sent-items folder 316, a bulk e-mail folder 318, and a deleted items folder 318. A HOTMAIL account 320 is accessed with e-mail address, john_doe@hotmail.com. Such account has an INBOX 321, a drafts folder 322, a sent-items folder 323, a bulk e-mail folder 324, and a deleted items folder 325. A personal AOL account 326 is accessed at e-mail address, john_doe@aol.com. Such account has an INBOX 327, a sent-items folder 328, and a trash folder 329.

The purpose of personal e-mail application 304 is to gather all the remote folders to local resources within, and then to send items back out to the original accounts 306, 308, 314, 320, and 326. It does this by authenticating against each original account into accepting the personal e-mail application 304 as a live, authorized user who has properly logged in. The personal e-mail application 304 has an INBOX 330, its own IMAP account 332, a my-company folder 334, a my-MSN folder 336, a drafts folder 338, a sent items folder 340, a spam folder 342, a trash folder 344, a my-HOTMAIL folder 346, and a my-AOL folder 348. These let the user direct which folders and accounts 306-329 are accessed and how messages are to be responded to.

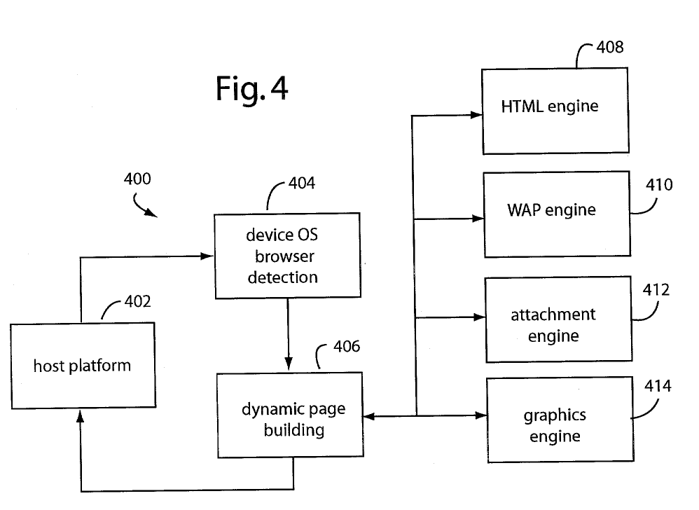

FIG. 4 details a single interface technology 400 that provides one standardized user interface for the same user experience on any mobile or desktop device and computer. The user only should learn the user interface once and the knowledge can be used with any device and computer. Starting with a particular user host platform 402, the single interface technology 400 comprises a device/browser/capability detection module 404 and a content-building module 406. Clients need to be divided according to their respective browsers and screen sizes. The single interface technology 400 further includes an HTML engine 408, a WAP engine 410, an attachment engine 412, and a graphics engine 414.

Detailed information on the single-interface technology useful in embodiments of the present invention is disclosed in the U.S. Provisional Patent Application of the present inventor, Baohua HUANG, serial No. 60/370,615, filed Apr. 9, 2002, and titled SINGLE INTERFACE TECHNOLOGY. Such is incorporated herein by reference.

The main hurdle in sending universal content to different devices is their variation in screen sizes. The screen resolution can vary from 100×60 for a cellphone, to 1280×10²⁴ for a desktop computer. These different screens, browsers and screens are divided into six categories, as listed in Table I.

TABLE I

| Category | | Screen Size | Explanation |
|---|---|---|---|
| 1. | Desktop | 640 × 480 to | All desktop computers with Internet |
| | Computer | 1600 × 1200 | Explorer, Netscape, Opera or any |
| | | or higher | other browser |
| 2. | PocketPC | 160 × 160 to | All Windows CE and Pocket PC |
| | and Internet | 800 × 600 | devices, Internet Appliances, Set- |
| | Appliances | | top boxes, Webpads, NTT DoCoMo |
| | | | devices, Psion devices, Palm OS |
| | | | devices using a Browser |
| 3. | Palm OS | 160 × 160 to | All Palm OS devices using Web |
| | Devices using | 240 × 240 | Clipping |
| | Web Clipping | | |
| 4. | WAP cell | 100 × 60 to | All WAP-enabled cell phones |
| | Phones | 320 × 80 | |
| 5. | Offline | All | All offline browsers, including |
| | Browsers | | Avantgo, Offline browser, Whatck |
| | | | Force, etc. |
| 6. | Text | All | All text-only browsers, Lynx, etc. |
| | Browsers | | |

If a particular browser or operating system (OS) cannot be detected, the default is preferably to category-1, regular HTML. For the best content presentations, four additional parameters are included in each category, as listed in Table II.

TABLE II
Additional Parameters

| | | | | Language |
|---|---|---|---|---|
| Category | Cookie | Javascript | SSL | Served |
| Desktop | Y | Y | Y | HTML 4.0/3.0 |
| Computer | | | | |
| PockPC and | U | U | Y | HTML 3.0/cHTML |
| Internet | | | | |
| Appliances | | | | |
| Palm OS | U | N | Y | Web Clipping |
| Devices using | | | | HTML |
| Web Clipping | | | | |
| WAP cell | N | N | N | WAP |
| Phones | | | | |
| Offline | U | N | U | HTML 2.0 |
| Browsers | | | | |
| Text Browsers | U | N | U | HTML 2.0 |

Cookies support is detected in real-time using the following cookie-detection routine. Javascript support is detected in real-time using a javascript-detection routine. There is no easy way to detect if the browser supports SSL or not. Such browsers are known to support SSL, except Eudora Web 2.0 and lower. These are detected and used accordingly. For Palm Web Clipping, cookie support is enabled since OS 4.1, but it's not reliable, so instead of using Cookie, the Device ID of the Palm is used. These will not support Javascript anytime soon. Palm Web Clipping always supports SSL. A small number of WAP cell phones supports cookies, however, this is turned off to accommodate the majority of the cell phones. A small number of WAP cell phones supports SSL, however, this is turned off to accommodate the majority of the cell phones. Javascript support is turned off to save bandwidth usage. SSL support is derived from browser. For example, with Avantgo browser, SSL is turned off because Avantgo uses its own encryption. Language served for these different categories are defined by both the category and the known capability of the browsers.

Cookie support of browsers is preferably detected in real-time by placing a cookie on the client device, then by trying to retrieve it. Such detection only uses the scripting language on the server, and no client-side script is required.

```
For example, Client requests page 1, page1.html comprises two lines,
set_cookie(“supportcookies”,“yes”,time() +300,“/”,“ ”,0); // set a
cookie named supportcookie to yes for 5 minutes
header(“Location: “page2.html”); // then redirect to page2.html
Then client gets the redirect and requests page 2, in the header of
page2.html embodiments can detect the “supportcookies” cookie and
see if it exists,
if (getcookie(“supportcookies”) == “yes”)
{
  // Yes cookie is enabled
}
else
{
  // No cookie is disabled
}
```

Javascript support of browsers is preferably detected in real-time by using a piece of client-side Javascript on the page and refreshes the page with an extra field, then check the field's property and see if it matches. Such detection uses both Javascript on the client-side and the scripting language on the server-side.

```
For example,
Client requests page1, page1.html, comprises this javascript in the
page,
<SCRIPT LANGUAGE=“JavaScript”><!--
var js_enabled = window.location.search.substring(1);
if (!js_enabled)
{
  location.href = ‘page1.html?&js=1’;
}
//--></SCRIPT>
This is the client-side Javascript.
If the browser supports Javascript, it will reload the page with an
additional parameter added to the URL - “js=1”. And inside the
reloaded page, embodiments have the server-side script
if (js == 1)
{
  // Javascript enabled - EXECUTED
}
else
{
  // Javascript disabled
}
```

If the browser does not support Javascript, it will ignore the code and continue on. And inside the reloaded page, embodiments have the same the server-side script as above, but with Javascript disabled. A “js_enabled” variable in the Javascript block is used to prevent loop of Javascript refresh of the page.

All modern browsers have the identification string in the HTTP_USER_AGENT variable. As in Table III, Examples.

TABLE III
Examples

| | | Version/ | | | |
|---|---|---|---|---|---|
| User Agent | Browser | Subvers. | OS | Vers. | Cat |
| Mozilla/4.0 | Internet | 5.0 | Macintosh | N/A | 1 |
| (compatible; | Explorer | | | | |
| MSIE 5.0; | | | | | |
| Mac_{—} | | | | | |
| PowerPC) | | | | | |
| Mozilla/5.0 | Gecko | 20020214 | Linux | N/A | 1 |
| (X11; U; | (Netscape) | | i686 | | |
| Linux i686; | | | | | |
| en - US; | | | | | |
| rv:0.9.8) | | | | | |
| Gecko/ | | | | | |
| 20020214 | | | | | |
| Mozilla/4.0 | Internet | 5.0 | Windows | 95 | 1 |
| (compatible; | Explorer | | | | |
| MSIE 5.0; | | | | | |
| Windows 95; | | | | | |
| DigExt) | | | | | |
| Mozilla/4.0 | Internet | 5.5 | Windows | NT | 1 |
| (compatible; | Explorer | | | 5.0 | |
| MSIE 5.5; | | | | | |
| Windows | | | | | |
| NT 5.0) | | | | | |
| Mozilla/4.0 | Opera | 6.1 | Windows | XP | 1 |
| (compatible; | | | | | |
| MSIE 5.0; | | | | | |
| Windows XP) | | | | | |
| Opera 6.01 | | | | | |
| [en] | | | | | |
| Mozilla/1.22 | Eudora | 2.1 | Palm OS | 3.0 | 2 |
| (compatible; | Web | | | | |
| MSIE 5.01; | | | | | |
| PalmOS 3.0) | | | | | |
| EudoraWeb | | | | | |
| 2.1 | | | | | |
| UPG1 UP/4.0 | Blazer | 1.0 | N/A | N/A | 2 |
| (compatible; | | | | | |
| Blazer 1.0) | | | | | |
| Mozilla/2.0 | Pocket | 3.02 | Windows | N/A | 2 |
| (compatible; | Explorer | | CE/Pocket | | |
| MSIE 3.02; | | | PC | | |
| Windows | | | | | |
| CE; PPC; | | | | | |
| 240×320) | | | | | |
| DoCoMo/ | NTT | 1.0 | N/A | N/A | 2 |
| 1.0/SO503i/ | DoCoMo | | | | |
| c 10 | | | | | |
| Mozilla/2.0 | Go/Web | 6.2 | RIM857 | N/A | 2 |
| (compatible; | | | | | |
| Go.Web/6.2; | | | | | |
| Hand | | | | | |
| HTTP 1.1; | | | | | |
| Elaine/1.0; | | | | | |
| RIM857) | | | | | |
| Mozilla/2.0 | Elaine — | 3.0 | N/A | N/A | 3 |
| (compatible; | Palm.net | | | | |
| Elaine/3.0) | proxy | | | | |
| | server | | | | |
| MOT-MCCA/ | Up.Browser — | 4.1.23 | Motorola | N/A | 4 |
| 7582 UP. | Openwave | | | | |
| Browser/4.1.23 | | | | | |
| UP.Link/4.3.3.5 | | | | | |
| Nokia6510/1.0 | Up | 4.2.2.9 | Nokia | N/A | 4 |
| (03.22) | Browser — | | | | |
| UP.Link/4.2.2.9 | Openwave | | | | |
| Mozilla/3.0 | Avantgo — | 3.2 | N/A | N/A | 5 |
| (compatible; | Avantgo | | | | |
| AvantGo 3.2) | offline | | | | |
| | browser | | | | |
| Lynx/ | Lynx | 2.3.3dev | N/A | N/A | 6 |
| 2.8.3dev.18 | | .18 | | | |
| libwww- | | | | | |
| FM/2.14 | | | | | |

Identification strings can be used to discern the browser type and version. Some also have the OS and version included. The key to detection is the exact browser/OS does not need to be identified. Only the correct category of client should be resolved. Table IV provides a two-stage algorithm for this.

TABLE IV
Two-Stage Detection Algorithm

```
void browser_category_detection (http_user_agent, http_accept) {
  if (browser_detect_category_6(http_user_agent))
  {
    // detect known text-only browsers from agent string
  }
  else if (browser_detect_category_5(http_user_agent))
  {
    // detect known offline browsers from agent string
  }
  else if (browser_detect_category_4(http_user_agent,
http_accept))
  {
    // detect known WAP browsers from BOTH agent string AND
http_accept string —this is important
  }
  else if (browser_detect_category_3(http_user_agent))
  {
    // detect known Palm web clipping proxy browsers from
agent string
  }
  else if (browser_detect_category_2(http_user_agent))
  {
    // detect known PocketPC/Internet Appliance/Set-top
Box/Palm browsers from agent string
  }
  else
  {
    // default category 1 browser
    browser_html_compatibility =
browser_detect_html_compatibility(http_user_agent));
  }
  ♯
}
```

The Strings to Match need to be known in the two-stage algorithm, e.g., as determined in Table V.

TABLE V

| | | | Strings to Look |
|---|---|---|---|
| | | Strings to Look For in | For in |
| Category | | HTTP_USER_AGENT | HTTP_ACCEPT |
| 1. | Desktop | N/A | N/A |
| | Computer | | |
| 2. | PockPC and | Windows CE, WebTV, | N/A |
| | Internet | AOLTV, DoCoMo, | |
| | Appliances | MME, MobileExplorer, Blazer, | |
| | | Go/Web, EudoraWeb (only 2.1 | |
| | | supports SSL), pdQbrowser | |
| | | (no SSL) | |
| 3. | Palm | Elaine | N/A |
| | OS Devices | | |
| | using Web | | |
| | Clipping | | |
| 4. | WAP | Ericsson, Nokia, Motorola, | VND.WAP.WML |
| | cell | 4thpass.com Kbrowser, | |
| | Phones | UP.Browser or UP.Link (but NOT | |
| | | Blazer or Go/Web or Elaine) | |
| 5. | Offline | Avantgo, Offline Explorer, | N/A |
| | Browsers | WebWhacker, Ruksun.WebHound | |
| 6. | Text | Lynx, Links, Emacs-W3 | N/A |
| | Browsers | | |

The browser_html_compatibility is used to determine the level of HTML support in the browser in Category 1. Only Internet Explorer 4.0 and above, Netscape Browser/Navigator 4.0 and above, and Opera Browser 4.0 and above are assumed to have HTML 4.0 compatibility. All others and unknown browsers are assigned HTML 3.0.

Whenever SSL support is detected or extrapolated from the browser/platform, SSL support is enabled. Such is realized by redirecting the client (Response 302 Server Redirect) to the SSL-secured web site. Once the category of the browser is detected, embodiments can move on to build the corresponding content (or Document).

Content-Building Module 406 build content at a generic level, generic tags are developed to fit the need. The entire document is divided into major sections, with sub-sections, e.g.,

Document_Header
Document_Body
Document_Body_Start
Document_Body_Content
Document_Body_End
Document_Footer.
Document Header
string document_header (document_category, document_cookie_{—}
support,
document_javascript_support, document_cookie_block,
document_html_level, document_title, document_content_type,
document_refresh_metatag, document_other_meta_tags,
document_style_sheet, document_relative_location,
document_javascript_block, document_fav_icon)

This function returns the entire header as a string.

TABLE VI

| | | Used in |
|---|---|---|
| Input Parameter | Explanation | Category |
| document_category | this is the category of the | All |
| | document (1-6) | |
| document_cookie_support | true or false | All |
| document_javascript_{—} | true or false | All |
| support | | |
| document_cookie_block | cookies to be set on this | ignored if |
| | page, ignored if | document_cookie_{—} |
| | document_cookie_support is | support is |
| | false | false |
| document_html_level | only used when | 1 |
| | document_category is 1. | |
| document_title | title of the document | All |
| document_content_type | used in HTML document, also | 1, 2, 3, 5, 6 |
| | set encoding, ignored on | |
| | WAP | |
| document_refresh_metatag | used if page should be | 1, 2, 6 |
| | refreshed, ignored on WAP | |
| document_other_meta_{—} | array of other meta tags | 1, 2, 3, 5, 6 |
| tags | like description, keywords, | |
| | etc., ignored on WAP | |
| document_style_sheet | style sheet for HTML 3.0 | 1, 2 (partial) - |
| | and 4.0 browsers, ignored | note that |
| | on others | style sheets |
| | | on |
| | | Windows/Mac/Linux |
| | | are |
| | | different for |
| | | the same page, |
| | | mostly because |
| | | font size |
| | | differences |
| document_relative_location | used if page defines a base | 1 |
| | location, used in HTML 3.0 | |
| | and 4.0 only, ignored on | |
| | others | |
| document_javascript_{—} | used if page has a | 1, 2 |
| block | Javascript block in the | |
| | header, ignored on browsers | |
| | that does not support | |
| | Javascript | |
| document_fav_icon | used only if browser is | 1 (partial) |
| | Internet Explorer 4.0 or | |
| | 5.0, used to define the | |
| | favorite icon, ignored on | |
| | others | |

```
Sample Output, HTML 4.0, most of the input fields are used
<!DOCTYPE HTML PUBLIC “-//W3C//DTD HTML 4.0 Transitional//EN”>
<HTML>
<HEAD>
<TITLE>Gopher King</TITLE>
<META HTTP-EQUIV=“content-type” CONTENT=“text/html; charset=utf-8”>
<META NAME=“AUTHOR” CONTENT=“Bob Huang, Copyright 2001-2002”>
<META NAME=“description” CONTENT=“Gopher King is a service allows
one to check your e-mail, and a lot of other functions from anywhere
on a whole variety of devices.”>
<META NAME=“keywords”
CONTENT=“hotmail,msn,mobile,mail,palm,palmos,Palm,windows,ce,CE,web,
tv,WebTV,wap,WAP,wml,WML,nttdocomo,NTTDoCoMo,docomo,pqa,omnisky,palm
.net,icq,email,e-mail,e-mail,E-
mail,map,direction,starbucks,whois,dns,dictionary,translate, translation”>
<LINK REL=“SHORTCUT ICON” HREF=“/favicon.ico”>
  <style type=“text/css”>
  <!--
  body { font-family: Arial, Helvetica, sans-serif; font-size:
10pt; }
  a { color: #003366. Text-decoration: underline; }
  a:hover { color: #FF9900; }
  small { font-size: 8pt; }
  big { font-size: 12pt; }
  td { font-size: 10pt; }
  .bodytext_normal {
    font-family: Arial, Helvetica, sans-serif;
    font-size: 10pt;
    color: #000000;
  }
  .htextwht {
    font-family: Arial, Helvetica, sans-serif;
    font-size: 10pt;
    color: #ffffff;
    text-decoration: none;
  }
```

| | |
|---|---|
| a.htextwht:active | { color: #ffffff; } |
| a.htextwht:link | { color: #ffffff; } |
| a.htextwht:visited | { color: #ffffff; } |
| a.htextwht:hover | { color: #ffcc33; } |

```
  .htextmenu {
    font-family: Arial, Helvetica, sans-serif;
    font-size: 10pt;
    color: #003366;
    text-decoration: none;
  }
```

| | |
|---|---|
| a.htextmenu:active | { color: #ff9900; } |
| a.htextmenu:link | { color: #003366; } |
| a.htextmenu:visited | { color: #003366; } |
| a.htextmenu:hover | { color: #ff9900. Text-decoration: |

```
underline; }
  -->
  </style></HEAD>
Sample Output, Palm Web clipping category 3,
<HTML>
<HEAD>
<TITLE>Gopher King</TITLE>
<META HTTP-EQUIV=“content-type” CONTENT=“text/html; charset=utf-8”>
<META NAME=“palmcomputingplatform” CONTENT=“true”>
<META NAME=“palmlauncherrevision” CONTENT=“1.90”>
<META NAME=“historylisttext” CONTENT=“Gopher King”>
</HEAD>
Sample Output, WAP - only the document_title field is used
<?xml version=“1.0”?>
<!DOCTYPE wml PUBLIC “-//WAPFORUM//DTD WML 1.1//EN”
“http://www.wapforum.org/DTD/wml_1.1.xml”>
<wml><card id=“GopherKing” title=“Gopher King”>
Document Body Start
string document_body_start (document_category,
document_javascript_support, document_html_level,
document_javascript_block, document_colors)
```

This function returns the start of the body as a string.

TABLE VII

| Input Parameter | Explanation | Used in Category |
|---|---|---|
| document_category | this is the | All |
| | category of the | |
| | document (1-6) | |
| document_javascript_support | True or false | All |
| document_html_level | only used when | 1 |
| | document_category | |
| | is 1. | |
| document_javascript_block | | 1, 2 |
| document_colors | Array of colors | 1, 2 and used in |
| | in the body, | conjunction with |
| | e.g., bgcolor, | the style sheet in |
| | text, link, | document_header |
| | vlink, alink. | |

Sample Output, HTML 4.0, most of the input fields are used
<body bgcolor=“#FFFFFF” text=“#000000” link=“#003366”
vlink=“#000000” alink=“#000000”>
Sample Output, WAP - nothing because none of field is used

The body content is built dynamically from the data using generic tags. Generic tags are replacements of regular HTML and WAP tags.

```
For example, the following is the line begin generic tag,
string generic_paragraph_begin (document_category,
paragraph_alignment)
Sample Output, HTML 4.0,
<p align=“center”>
Sample Output, WAP
<p>
Another Example, the following is the http_link generic tag,
string generic_paragraph_begin (document_category, http_url,
http_target)
{
  string return_data = “<a href=\”“.http_url.”\“”;
  if (document_category == 1)
  {
    return_data.=“ target=\”“.http_target.”\“”;
  }
  return_data.=“>”;
  return return_data;
}
Sample Output, HTML 4.0,
<a href=“http://www.gopherking.com” target=“_blank”>
Sample Output, WAP
<a href=“http://www.gopherking.com”>
```

One can build as many generic tags as one should. However, attention must be paid to forms, because WAP requires another code block to submit the form.

Document Body End
string document_body_end (document_category)

This function returns the end of the body as a string.

TABLE VIII

| Input Parameter | Explanation | Used in Category |
|---|---|---|
| document_category | this is the category | All |
| | of the document (1-6) | |

Sample Output, MTML 4.0, most of the input fields are used
</body>
Sample Output, WAP - nothing because none of field is used
Document Footer
string document_footer (document_category)

This function returns the entire footer as a string.

TABLE IX

| Input Parameter | Explanation | Used in Category |
|---|---|---|
| document_category | this is the category | All |
| | of the document (1-6) | |

Sample Output, all HTML pages,
</html>
Sample Output, WAP,
</card></wml>

Page Cache Control

Since most of the pages are built dynamically and should be rebuilt when requested, they should force the browser to reload instead of using the copy in the cache.

```
if (dynamic_page)
{
  // Nokia does not like the Expires: −1 directive
  if (!device_is_nokia)
  {
    Header(“Expires: −1”);
  }
  Header(“Pragma: no-cache”);
  Header(“Cache-Control: no-cache, must-revalidate”);
  Header(“Last-Modified: “.gmdate(“D, d M Y H:i:s”).” GMT”);
}
```

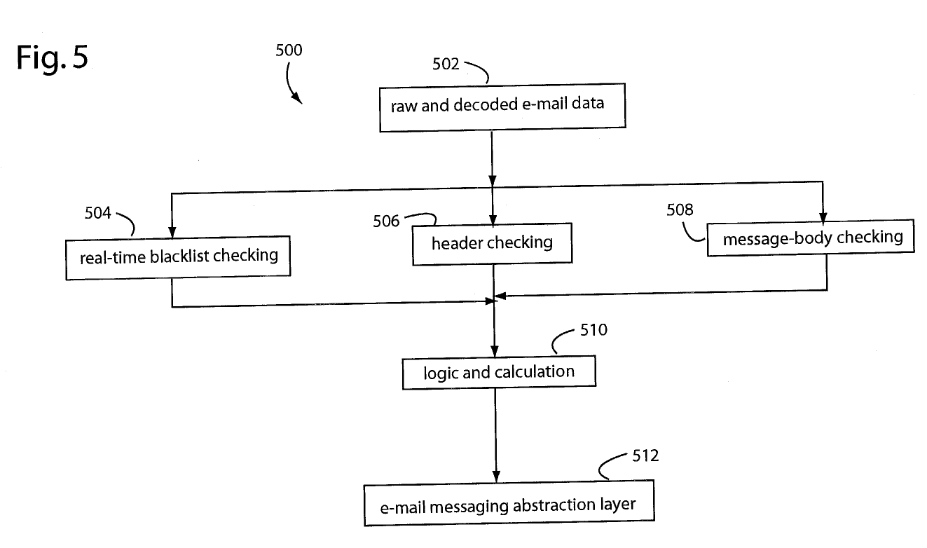

FIG. 5 illustrates a smart spam filter 500 which processes incoming raw and decoded e-mail data 502. The smart spam filter 500 comprises a real-time blacklist (RBL) checker 504, a header checker 506, a message body checker 508, and a logic and calculation module 510. The processed messages are passed on to an e-mail messaging abstraction layer 512. Because most users are using mobile devices, and the bandwidth available to these devices is quite limited, spam e-mails have become a major problem and they consume valuable user resources. The smart spam filter (SSF) technology described here adapts a unique spam rating system, which eliminates spam e-mails before they reach user's mobile device.

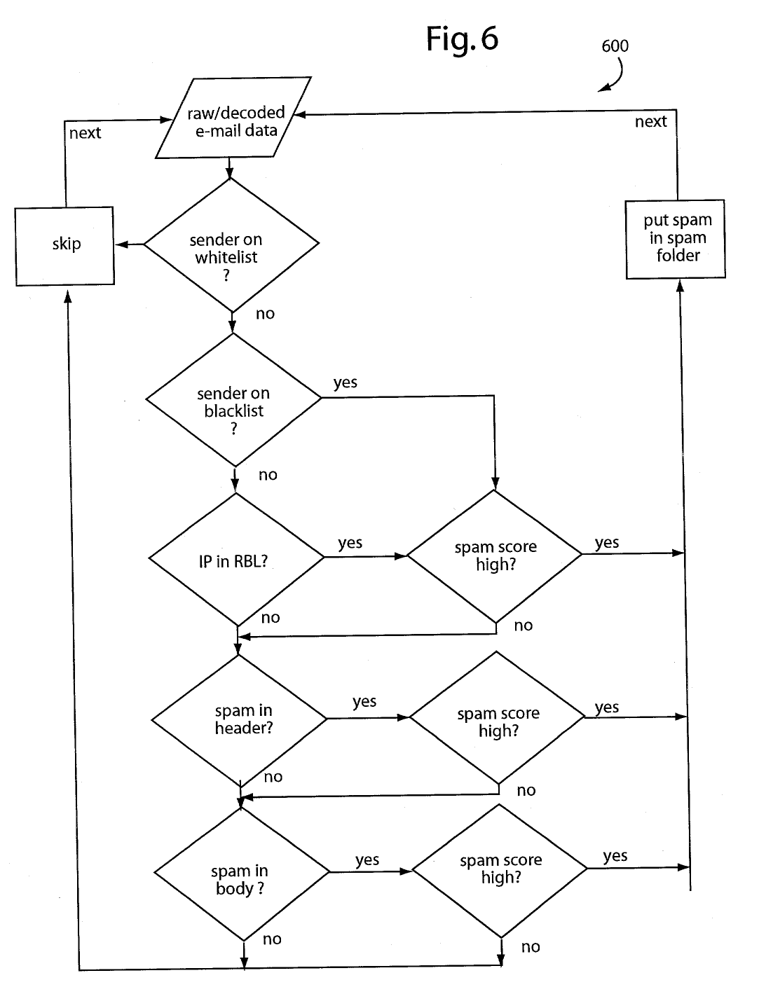

FIG. 6 illustrates a smart spam mechanism method embodiment of the present invention, and referred to herein by the general reference numeral 600.

Active versus passive spam removal is novel. In prior art e-mail applications, conventional spam filters delete the spam messages while downloading all messages from the INBOX, e.g., passive spam removal. In embodiments of the present invention, the spam filter goes out to individual e-mail servers and removes the spam messages from the INBOX. It also places them in to a separate spam folder on the original e-mail server or in a database. The user can define that folder, or a database for inspection. The active spam removal mechanism does not rely on any e-mail client or application, and the scan intervals can be adjusted by the user from minutes to days.

In a spam rating system, instead of using a standard “yes” or “or” spam evaluation mechanism, embodiments devised a spam rating system that is based the total spam score of each e-mail message.

If the total spam score of a particular e-mail message is higher than the allowed threshold, the message is deemed as spam and processed accordingly. The threshold and the total spam score of each individual criterion can be defined by the system or the user.

Within a single message, spam scores collected from each field are combined into a single spam score and compared against the threshold.

A threshold and spam score can be defined by the system or the user. For example, embodiments define the following rules (arbitrarily). If the message subject comprises both sex and picture, then the total spam score is 50. If the message body comprises sex and picture, then the total spam score is 25. If the message header comprises IP addresses in the RBL, then the total spam score is 50. If the total spam score is less then 50, then it is not a spam. If the total spam score is higher than 50 but less than 100, then it is a spam suspect. If the total spam score is higher than 100, then it must be a spam. The threshold and the scores are all defined arbitrarily by the system or the user.

For a user whitelist, the user can define the criteria that certain messages will never be treated as spam. In this case, all other modules will be ignored. The following fields can be defined to be criteria of a while list,

| Field | Explanation |
|---|---|
| From | When the From filed comprises a certain name or e- |
| | mail address - e-mail address is more reliable |
| To | When the To field comprises a certain name or e-mail |
| | address - e-mail address is more reliable |
| Cc | When the Cc field comprises a certain name or e-mail |
| | address |
| To or Cc | When the To or Cc field comprises a certain name or |
| | e-mail address |
| Replyto | When the Replyto field comprises a certain name or e- |
| | mail address |
| Subject | When the Subject field comprises a certain keyword or |
| | phrase |
| Body Text | When the Body Text comprises a certain keyword or |
| | phrase |
| Attachment | When the attachment is a certain type or the name of |
| | the attachment comprises certain keyword or phrase |

If a match is found, the message will be treated as “not a spam” and will be left alone.

For a User Blacklist, the user can define the criteria that certain messages will always be treated as spam. In this case, the RBL module will be ignored. The following fields can be defined to be criteria of a black list,

| Field | Explanation |
|---|---|
| From | When the From filed comprises a certain name or e- |
| | mail address - e-mail address is more reliable |
| To | When the To field comprises a certain name or e-mail |
| | address - e-mail address is more reliable |
| Cc | When the Cc field comprises a certain name or e-mail |
| | address |
| To or Cc | When the To or Cc field comprises a certain name or |
| | e-mail address |
| Replyto | When the Replyto field comprises a certain name or e- |
| | mail address |
| Subject | When the Subject field comprises a certain keyword or |
| | phrase |
| Body Text | When the Body Text comprises a certain keyword or |
| | phrase |
| Attachment | When the attachment is a certain type or the name of |
| | the attachment comprises certain keyword or phrase |

If a match is found, the message will be treated as “spam” and will be removed from the INBOX and processed accordingly.

A Logic and Calculation Module 510, e.g., “spam Score Calculation Module”, is used to determine if an e-mail message is a spam or not. The calculation could be logic (yes or no,) or arithmetic (sum). Each time a spam match is found in any of the modules, the Logic and Calculation Module is called immediately to see if the total spam score is high enough. If it is, then the rest of the module and other modules will be skipped and the message will be treated as spam and processed accordingly. This can save a lot of time and resources when processing large quantities of e-mail messages.

The purpose of a spam sender is to get a recipient to do one of the following, or the combination of two or more, and embodiments can catch them using one of the modules,

| Action | Spam Checking |
|---|---|
| Reply to the certain e-mail | Check the From or Replyto fields |
| address | in Header Checking Module, or |
| | find a match of the e-mail |
| | address in the Body Checking |
| | Module |
| Click on a link in the e-mail | Find a match of the web site in |
| to go to a certain Web site | the Body Checking Module |
| Send money/payment to a certain | Find a match of the physical |
| address | address in the Body Checking |
| | Module |
| Call a certain phone number | Check the Subject filed in Header |
| | Checking Module, or find a match |
| | of the phone number in the Body |
| | Checking Module |
| Being infected with a certain | Find a attachment |
| virus/viruses | name/type/binary data match in |
| | the Body Checking Module |

The RBL Checking Module 504 can be implemented with products from Mail Abuse Prevention System (MAPS) LLC. A Real-time Blackhole List (RBL) consists of IP addresses whose owners refuse to stop the proliferation of spam. The RBL usually lists server IP addresses from ISPs whose customers are responsible for the spam and from ISPs whose servers are hijacked for spam relay.

The same IP checking mechanism can be used to see if the e-mail message is coming from one of the RBL IP addresses, if yes, an “RBL” match spam score will be added to the total spam score.

In the Header Checking Module 506, the header of the e-mail is checked for decoded and raw modes.

In the decoded mode, the header is decoded and separated into different fields, and each field is compared with its own criteria set.

The following fields can be used against criteria in the header,

| Field | Explanation |
|---|---|
| From | When the From filed comprises a certain name or e-mail |
| | address - e-mail address is more reliable |
| To | When the To field comprises a certain name or e-mail |
| | address - e-mail address is more reliable |
| Cc | When the Cc field comprises a certain name or e-mail |
| | address |
| To or | When the To or Cc field comprises a certain name or e- |
| Cc | mail address |
| Replyto | When the Replyto field comprises a certain name or e-mail |
| | address - many Spammers uses a different replyto address |
| | than the sending address |
| Subject | When the Subject field begins with or comprises a certain |
| | keyword or phrase like ADV, ADV ADULT, or “secrets to |
| | multilevel marketing on the internet” |
| Date | Many spam mailers have trouble converting the date/time |
| | to the correct RFC format, embodiments can check a |
| | malformed date field and determine the spam mailer type |

If a match is found, the Logic and Calculation Module will be called immediately to add the new spam score.

Sample Criteria in the To Field
#field0#
#field1#
Undisclosed.Recipients
Undisclosed Recipients
UndisclosedRecipients
Undisclosed-Recipient
Sample Criteria in the Subject Field
I bet that I make more money in the Web design business than one do
Welcome to the Internet Treasure Chest
All Natural Alternative to Viagra
Let Us Steer One Out Of Debt
Unlimited Access - Porn Sex Celebrities
Become a Judgment Processing Professional
FIND DIRT ON ANYONE INSTANTLY

In the raw mode, the entire e-mail header is examined as a whole to find certain keywords or extra fields. For example, if the raw header comprises these extra fields, it's considered spam.

X-Advertisement
X-Bulke-mail
X-Distribution: Bulk
X-Distribution: Mass
X-Distribution: Moderate
X-Mailer: E-Mail Magnet
X-Mailer: e-mailer Platinum
X-Mailer: eMarksman
X-Mailer: Extractor
X-Mailer: Floodgate
X-Mailer: Group Mail
X-Mailer: Groupmail
X-Mailer: Millennium Mailer
X-Mailer: SuperSpam
X-Removal
X-Sender

In an Advanced Raw Mode, the e-mail return-path and the e-mail route can also be checked for bogus domains and IP addresses.

For example, the following header indicates that the sender sent an e-mail with the telkom.net domain but from an IP address on the chello.fr (in France) network, this is highly suspicious and should be considered a spam.

Return-Path: <bzdfgzdfg@telkom.net>
Received: from mta3.plasa.com (cha212186189190.chello.fr
[212.186.189.190]) by southgate01.SouthgateEngineering.com with SMTP
(Microsoft Exchange Internet Mail Service Version 5.5.1960.3)
id H77G6FYW; Sat, 30 Mar 2002 10:45:26 −0800

For Automatic RBL Submission, if the total spam score from the Advanced Raw Mode match is high enough, embodiments can also submit the IP addresses used in the Header to the RBL automatically.

In the body-checking module 508, the body of the e-mail message is always checked in the decoded mode, and if the original message is an “multipart/alternative” e-mail, both the text and html portion of the e-mail will be checked as if they are individual e-mails, and the results will be combined.

Such decode checking is necessary because many spam senders disguise the web site address, physical address, or e-mail address in encoded form in the raw e-mail body. Also the usage of “@” sign to separate fake Web site address from real Web site address. They also disguise the entire e-mail by base64-encode the e-mail body, so the raw e-mail body is only binary data. Some even use Javascript in the body of the e-mail to replace the Web site address and e-mail addresses in real-time.

For example,
This is a base64-encoded spam message,
PGZvbnQgc2l6ZT0yPjxwIGFsaWduPWxlZnQ+TyC6uyC43sDPwLogwaS6uMXrvcW4wSDA
zL/rw8vB+CC51yDBpLq4urjIoyC17r+hILD8x9Eguf23/CDBpiA1MMG2v6EgwMewxcfR
IFuxpLDtXSC43sDPwNS0z7TZPEJSPk8gZS1tYWlswda80rTCIMDOxc2z3bvzv6G8rSDD
67Xmx8+/tMC4uOcsIMHWvNK/3CC+7rawx9EgsLPAziDBpLq4tbUgsKHB9rDtIMDWwfyg
vsq9wLTPtNk8QlI+PC9mb250PjxIUj48QlI+DQoNCjxodG1sPg0KPGJvZHk+DQo8cD4g
KsHBwLogs68gtce9yr3Dv+QuILCou+fH1bTPtNkuIA0Kv/jEoSC+ysC4vcO46SDAzLje
wM+89r3FsMW6zrimILStt6/B1r3KvcO/5C48QSBocmVmPSJodHRwOi8vMjExLjEwOC42
Mi4xNzEvbWFpbF9yZWZ1c2UuYXNwIiB0YXJnZXQ9ImJsYW5rIj48SU1HIGJvcmRlcj0i
MCIgc3JjPSJodHRwOi8vMjEwLjIxOS4xMjAuMTk5L1JlamVjdF9lbWFpbC5KUEciPjwv
QT4NCiANCjxhIGhyZWY9Imh0dHA6Ly9iMDAyLmVuczIxLmNvLmtyIiB0aXRsZT0iwdaw
ob+5w/jHwbfOsde3pSBFbnMyMSIgdGFyZ2V0PSJibGFuayI+PGI+wdawoSC/ucP4IMfB
t86x17elILTZv+4gud6x4jwvYj48L2E+PGJyPjxicj4NCjxhIGhyZWY9Imh0dHA6Ly9i
MDAyLmVuczIxLmNvLmtyIiB0aXRsZT0iwdawob+5w/jHwbfOsde3pSBFbnMyMSIgdGFy
Z2V0PSJibGFuayI+PGltZyBzcmM9Imh0dHA6Ly8yMTEuMTA4LjYyLjE3MS9pbWcvYjAw
Mi0xLmdpZiI+PC9hPg0KPC9ib2R5Pg0KPC9od!
G1sPg0KCjxIUj48cCBhbGlnbj0ibGVmdCI+PGZvbnQgc2l6ZT0iMiI+TyC758D8IMfjt
vS++MDMILjewM/AuyC6uLO7sNQgtcjBoSC757D6teW4s7TPtNkuPEJSPk8guN7AzyC89
r3FwLsgv/jHz73DwfYgvsrAuL3DuOkmbmJzcDsgtNnAvcC7IMWsuK/H2CDB1ry8v+Q8L
2ZvbnQ+PEJSPjxhIGhyZWY9Imh0dHA6Ly93d3cub3pzeXN0ZW1zLmNvLmtyL2Jpbi9fX
1JlamVjdE1haWwuY2dpP1VzZXJJZD15bW5hMSZFbWFpbD1sZ21AY3liZXJjYWJsZS50b
S5mciZTdWJqZWN0PSU1YiViMSVhNCViMCVlZCU1ZCUyMCViZCVjNyViYyVmNiViZSVmO
CViNCVjMiUyMCVjMSVkNiViZCVjNCUyMCVjMCVmYyViOSVhZSViMCVhMSViNyVjZSUyM
CViOCViOCViNSVlOSViZSVlZSUyMCViNSVlNSViOCViMyViNCVjZiViNCVkOS4lMjAlY
jAlYTglYmIlZTclYzclZDUlYjQlY2YlYjQlZDkiPjxpbWcgc3JjPWh0dHA6Ly93d3cub
3pzeXN0ZW1zLmNvLmtyL2Jpbi9kZW55bWFpbC5naWYgd2lkdGg9IjEyMiIgaGVpZ2h0P
SIzMSIgYm9yZGVyPSIwIj48L2E+

The link, http://www.%4con%67%61%4e%64%75%45s%6ces%73%77%6f%52%64%46%4f%72%73% 70%41c %65%52%65a %53%6f %6e%73.com@202.101.18.228/bp/merl/index.html Actually points to 202.101.18.228/bp/merl/index.html, all the coding in front of the “@” is only a disguise.

Inside a spam e-mail, a construct like:

<form action=“mailto: kevinh216@excite.com” method=“post”>
<input type=“text” name=“yourname”>

actually sends an e-mail to the Spammer using a free e-mail account (kevin21@excite.com). Many of the free e-mail services have been turned into the paradise of Spammers. However this trends is changing, since many of the free e-mail providers are now charging for services. It is also notable that many of the Spammers are moving onto free e-mail providers in other countries, Russia, China, France, etc.

Various features are checked inside a decoded e-mail body to check for spam.

| Feature | Explanation | Examples |
|---|---|---|
| URL | If a spam e-mail wants | netemail.com |
| | a recipient to click on | http://216.240.140.55 |
| | a link and go to a Web | http://www.newsamo.com |
| | site, the URL must be | http://32.97.166.75 |
| | in the body of the e- | If the domain name |
| | mail. Embodiments can | comprises “sex, slut, porn, |
| | compare the e-mail body | teen”, etc. |
| | to a list of known spam | |
| | URLs. | |
| Phone | Similarly, if the spam | 1-214-764-3317 |
| Number | e-mail wants the | 1*8*8*8*2*4*8*4*9*4*2 |
| | recipient to call a | |
| | certain phone number, | |
| | embodiments can check | |
| | for that. | |
| e-mail | If the spam e-mail | Raymond2@btamail.net.cn |
| Address | wants the recipient to | (Programming Help spam) |
| | reply to an e-mail | |
| | address in the e-mail | |
| | body, embodiments can | |
| | check for that. | |
| Physical | If the spam e-mail | FLORIDA=2C32245-7481 |
| Address | wants a recipient to | |
| | send payment to a | |
| | certain address, | |
| | embodiments can check | |
| | for that. | |
| Company | If a spam e-mail wants | Kaleidoscope promotions |
| Name | to advertise a company | Ltd, West One House |
| | name, embodiments can | |
| | check for that. | |
| Product | If a spam e-mail wants | Liquid Viagra |
| Name | to advertise a certain | |
| | product, embodiments | |
| | can check for that. | |
| Other | Other unique keywords, | “No required tests, |
| Keywords | phrases that can only | classes, books, or |
| | be used in a spam | interviews” |
| | | “free password to major |
| | | porn sites” |
| Attachment | If an attachment to the | joke.exe |
| | e-mail is a certain | dialer.exe |
| | type (PIF, BAT, EXE, | |
| | COM) or its name | |
| | comprises certain | |
| | keywords, embodiments | |
| | can check for that. | |
| | Embodiments can also | |
| | scan the attachment(s) | |
| | for viruses. If found, | |
| | embodiments can clean | |
| | the attachment or | |
| | delete the entire e- | |
| | mail. | |

To speed up the matching speed, a unique matching algorithm is used to do the matching in each of such field/feature.

```
int email_spam_match(field_or_feature, data) {
// connect to database and get the spam samples by usage descending
- this is very important to speed up the matching process
result_set=dblookup(“SELECT id, spam_sample_data FROM
spam_samples
WHERE spam_sample_type=field_or_feature ORDER BY
spam_sample_usage_count DESC”);
if (match_spam_data(data, haystack_spam_sample))
{
    // yes a match is found
    // increase spam sample usage count by 1
dbupdate(“UPDATE spam_samples SET
spam_sample_usage_count=spam_sample_usage_count+1
WHERE id=id”);
    return 1;
}
else
{
      return 0;
}
}
```

The spam_sample_usage_count is increased by one each time a spam match is found, this ensures that in future database lookups the mostly used spam samples will be matched against the data first. The slowest execution will happen when no spam is found, because the system has to go through matching each individual spam sample data.

Detailed information on the smart spam filter technology useful in embodiments of the present invention is disclosed in the U.S. Provisional Patent Application of the present inventor, Baohua HUANG, serial No. 60/370,616, filed Apr. 9, 2002, and titled SMART SPAM FILTER. Such is incorporated herein by reference.

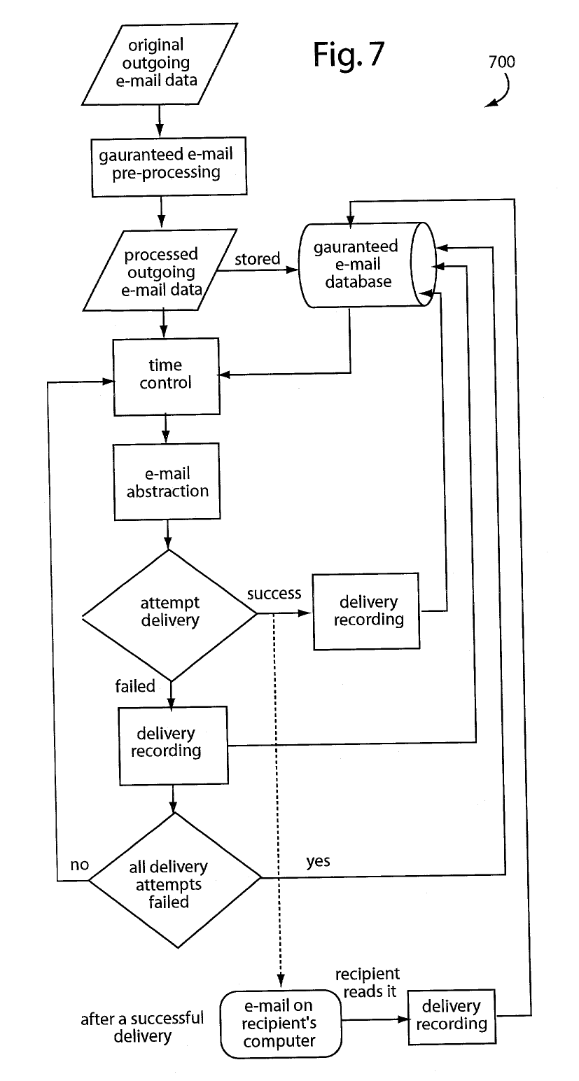

FIG. 7 illustrates a guaranteed e-mail mechanism method embodiment of the present invention, and referred to herein by the general reference numeral 700.

The guaranteed e-mail system 700 provides fast and guaranteed delivery of e-mails and documents. The sender of the guaranteed e-mail message can track the entire delivery process, and know when the message was attempted, delivered and read.

Message tracking of each e-mail message is done through two steps, Delivery Tracking—when and where (which e-mail server and IP address) the message was delivered, and Usage Tracking—when and where (which the e-mail recipient computer and IP address) the message was read

The e-mail delivery process is standard SMTP e-mail delivery. The tracking result is obtained directly from the SMTP delivery process and recorded into the Guaranteed e-mail database. Embodiments achieve this goal by utilizing standard SMTP e-mail delivery system through the e-mail Abstraction Layer and extract the response code (and possibly the response message).

A mail server will reply to every request a client (such as your email program) makes with a return code. This code consists of three numbers. The first generally tells whether the server accepted the command and if it could handle it. The five possible values are:

(1) The server has accepted the command, but does not yet take action.

(2) A confirmation message is required. Currently, this is not used.

(3) The server has completed the task successfully.

The server has understood the request, but requires further information to complete it.

(4) The server has encountered a temporary failure. If the command is repeated without any change, it might be completed. This is hardly ever used by e-mail servers.

(5) The server has encountered an error.

The second number gives more information. Its six possible values are:

(0) Syntax error has occurred.

(1) Indicates an informational reply, for example to a HELP request.

(2) Refers to the connection status.

(3) and (4) are unspecified (unused).

(5) Refers to the status of the mail system as a whole and the mail server in particular

List of All ESMTP Server Response Codes

211 A system status message.
214 A help message for a human reader follows.
220 Service ready.
221 Service closing.
250 Requested action taken and completed. The best message of them
all.
251 The recipient is not local to the server, but it will accept and
forward the message.
252 The recipient cannot be VRFYed (verified), but the server
accepts the message and attempts delivery.
354 Start message input and end with <CRLF>.<CRLF>. This indicates
that the server is ready to accept the message itself.
421 The service is not available and the connection will be closed.
450 The requested command failed because the user's mailbox was
unavailable (for example since it was locked).
451 The command has been aborted due to a server error. Not your
fault.
452 The command has been aborted because the server has insufficient
system storage.
500 The server could not recognize the command due to a syntax
error.
501 A syntax error was encountered in command arguments.
502 This command is not implemented.
503 The server has encountered a bad sequence of commands.
504 A command parameter is not implemented.
550 The requested command failed because the user's mailbox was
unavailable (for example because it was not found, or because the
command was rejected for policy reasons).
551 The recipient is not local to the server. The server then gives
a forward address to try.
552 The action was aborted due to exceeded storage allocation.
553 The command was aborted because the mailbox name is invalid.
554 The transaction failed.

Response Code Handling

Embodiments only look at response codes in the 2xx, 4xx and 5xx series. Message with 4xx and 5xx response code is treated as “failed.”

In 2xx series, if the response code is not 252, then message is treated as “success”; if the response code is 252, embodiments need to mark the message as “possible success,” and see if there is any bounced messages.

Information tracked by the Server-side Mechanism

Date and Time the message was attempted.
Date and Time the message was delivered.
IP address of the server which accepted/rejected the message.

The response code and possibly the response message from the

server. Such information can also be recorded multiple times if the
e-mail was destined to multiple recipients. The Delivery Recording
Module takes the information and stores it in the database.

The usage of the e-mail is tracked via one of the following client-side tracking mechanism on the e-mail client once the recipient receives it. The Pre-Processing Module is used to add the client-side tracking mechanism to the original e-mail message itself.

Using embedded picture-script, this is the best mechanism, if the e-mail client supports HTML e-mails. A script embedded as an invisible picture inside an HTML e-mail, it is executed when the e-mail is opened on the client. The corresponding information is recorded on the server. For example, this tag, <img src=“http://www.myserver.com/myscript.cgi” height=“1” width=“1” alt=“ ”>, puts a 1X1 pixel invisible picture inside the e-mail and it executes the myscript.cgi script on the http://www.myserver.com server.

Using Javascript/VBscript, similar to the embedded picture-script, a piece of Javascript/VBscript is executed when the HTML e-mail is opened. It records the corresponding information on the server. This is not ideal became many e-mail clients have disabled all script processing for fear of virus problems. Using Java Applet. Instead of executing a script, a Java applet is loaded when the HTML e-mail is opened, and the applet collects and sends the corresponding information back to the server.

Using pure text link. This is the most universal mechanism, and it does not require the e-mail client to be able to read HTML e-mails. However, it requires the recipient to actively click on a link to tell the server the status of the e-mail.

Information tracked by the Client-side Mechanism

Date and Time the message was opened.
IP address of the computer on which the message was opened. The
recipient who opened the e-mail. This is done by adding the
recipient's ID or e-mail address to the tracking script. The
tracking number of the e-mail. This is done by inserting a tracking
number into the tracking script.

Such information can also be recorded multiple times if the e-

mail was opened multiple times or the e-mail was forwarded and read
by other people. The Delivery Recording Module takes the
information and stores it in the database.

The combined data from the Delivery Tracking and Usage Tracking can provide a clear picture to the sender (and recipient, if allowed) the entire e-mail message delivery process.

Time Control Module—Re-Delivery and Options.

The sender or system can specify the number of re-delivery attempts if the original attempt fails. The succeeded/failed attempts are also recorded into the database.

The sender or system can specify when the message should be delivered, immediately or delayed or on a certain date/time.

The Time Control Module is designed to take control of these functions, and deliver the e-mail messages according to the schedule. This can be implemented as a scheduling daemon or a simple AT job.

Guaranteed e-mail provides the broadest compatibility of all existing e-mail servers and clients.

The data delivered by the guaranteed e-mail system 700 is standard HTML or text e-mail data, and is compatible with all existing e-mail servers. The data delivered by the guaranteed e-mail system 700 is standard HTML or text e-mail data, and is compatible with all existing e-mail clients. However, for the tracking mechanism to work correctly, the client must have Internet connectivity and must be able to reach the tracking web site via any browser.

Detailed information on the guaranteed e-mail technology useful in embodiments of the present invention is disclosed in the U.S. Provisional Patent Application of the present inventor, Baohua HUANG, serial No. 60/370,618, filed Apr. 9, 2002, and titled GUARANTEED E-MAIL SYSTEM. Such is incorporated herein by reference.

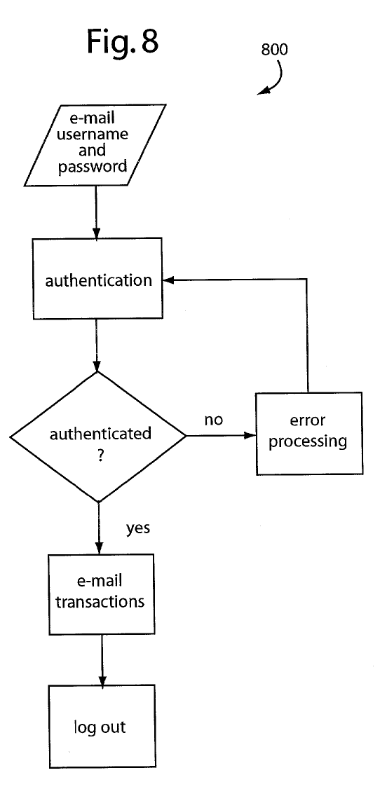

FIG. 8 illustrates an e-mail abstraction layer embodiment of the present invention, and referred to herein by the general reference numeral 800.

Access to multiple-protocol, multiple-standard e-mail platforms is based on an e-mail Abstraction Layer that provides a generic interface to higher-level system calls. Higher-level code deals only with the generic interface and do all e-mail transactions without dealing with all the details of individual e-mail protocols and platforms.

The Abstraction Layer is composed of the following components,

Authentication module
Mailbox manipulation module
Message manipulation module
Logout module

Authentication Module

E-mail systems require a username and password pair in order to authenticate. This is true for all existing e-mail system today.

The following function is pseudo-code for the authentication module, it returns true (1) and the corresponding e-mail link (through which all following e-mail transactions will be done) when the authentication is a success, and returns false (0) when authentication fails, the corresponding error number and error description are also returned.

```
int email_authentication (username, password, protocol, server,
port, &error_no, &error_disp) {
  if (protocol == “POP”)
  {
    pop_login (username, password, server, port, &error_no);
  }
  else if (protocol == “IMAP”)
  {
    imap_login (username, password, server, port, &error_no);
  }
  else if (protocol == “HOTMAIL”)
  {
    hotmail_login (username, password, server, port,
&error_no);
  }

[symbol]

  error_disp = email_error_message (error_no); // convert error
number to error message
  error_handling; // handle error

[symbol]

}
```

If the authentication is successful, the system may go on with the e-mail transactions; if not, the user must re-authenticate.

Mailbox Manipulation Module

Under an e-mail account, there must be at least one (INBOX) or more e-mail mailboxes (INBOX plus others). In some documents, Mailboxes are also referred to as folders. This module is used to do functions on these mailboxes.

Function List Mailboxes

```
array email_mailbox_list (protocol, email_link, pattern,
boolean_count_number_of_messages,
boolean_count_number_of_new_messages,
&error_no, &error_disp) {
  if (protocol == “POP”)
  {
    verify_email_link; // make sure link is there
    return “INBOX”; // POP protocol only supports INBOX
  }
  else if (protocol == “IMAP”)
  {
    imap_list_mailboxes (email_link, pattern);
  }
  else if (protocol == “HOTMAIL”)
  {
    hotmail_list_mailboxes (email_link, pattern);
  } [symbol]
  // other e-mail protocols
}
```

This function is used to list mailboxes under an e-mail account, based on the pattern chosen. Under POP and SPOP protocols, only one mailbox “INBOX” is returned because these protocols only supports a single mailbox. Under other protocols, other mailboxes, like “Sent Items,” “Trash,” “Deleted Items,” and “Drafts,” in addition to “INBOX” may be found. The returned array comprises the names of the mailboxes, the number of total and new messages in each of the mailboxes if selected.

Function Rename Mailbox

int email_mailbox_rename (protocol, email_link,
original_mailbox_name, new_mailbox_name,
&error_no, &error_disp)

This function is used to rename a mailbox to a different name, the original name and the new name must be different. The mailbox cannot be “INBOX” or other system mailboxes. System mailboxes vary from system to system and from protocol to protocol. If the mailbox is a system mailbox and cannot be renamed, an error number and description will be returned to indicate that. This function is not available in POP/SPOP protocols because only “INBOX” mailbox is available and it cannot be renamed.

Function Delete Mailbox

int email_mailbox_delete (protocol, email_link, mailbox_name,
&error_no, &error_disp)

This function is used to delete a mailbox together all e-mail inside it. The mailbox cannot be “INBOX” or other system mailboxes. System mailboxes vary from system to system and from protocol to protocol. If the mailbox is a system mailbox and cannot be deleted, an error number and description will be returned to indicate that. This function is not available in POP/SPOP protocols because only “INBOX” mailbox is available and it cannot be deleted.

Function Move Mailbox

int email_mailbox_move (protocol, email_link, source_mailbox_name,
destination_parent_mailbox_name, &error_no, &error_disp)

This function is used to move a mailbox under a new parent folder. The mailbox cannot be “INBOX” or other system mailboxes. System mailboxes vary from system to system and from protocol to protocol. If the mailbox is a system mailbox and cannot be moved, an error number and description will be returned to indicate that. This function is not available in POP/SPOP protocols because only “INBOX” mailbox is available and it cannot be moved.

Function Mailbox Number of Messages

int email_mailbox_number_of_messages (protocol, email_link,
mailbox_name, &error_no, &error_disp)

This function is used to count the number of messages in a particular mailbox.

Function Mailbox Number of New Messages

int email_mailbox_number_of_messages (protocol, email_link,
mailbox_name, &error_no, &error_disp)

This function is used to count the number of new messages in a particular mailbox.

Function Mailbox Get Messages

array email_mailbox_get_messages (protocol, email_link,
mailbox_name, sort_order, start_message_no, end_message_no,
&error_no, &error_disp)

This function is used to retrieve an array of message components from a particular mailbox for a pre-defined range (start_message_no and end_message_no define the range). The returned array comprises the following elements as defined by the sort order (could be any field ascending or descending),

string email_message_unique_id - the unique ID of the e-mail on the
e-mail system
array email_message_from - the From name and e-mail address
array email_message_to - the To name and e-mail address
array email_message_cc - the Cc name and e-mail address
array email_message_bcc - the Bcc name and e-mail address
string email_message_subject - the subject of the e-mail
int email_message_unix_date - the date of the e-mail in Unix time.
int email_message_byte_size - the size of the message in bytes
int email_message_priority - the priority of the message
array email_message_flags - the flags of the message, including New,
Seen, Replied, Deleted, etc. These are used to determine the
message status.
array email_message_other_header_entries - other header entries in
the e-mail header, e.g., X-Mailer, X-Maillist, etc.

On e-mail systems that do not offer unique message Ids (POP and SPOP), the unique ID is formulated using the following algorithm,

email_message_unique_id = email_message_unix_date + ″.″ +
email_message_byte_size + ″.″ + crc32 (email_message_subject) + ″.″
+ crc32 (email_entire_message_header)

Cyclic Redundancy Checksum or Cyclic Redundancy Check (CRC) is a “digital signature” representing data. The most common CRC is CRC32, in which the “digital signature” is a 32-bit number. The ideal CRC algorithm has several characteristics about it. First, if CRC is done on the same data more than once, it must get the same CRC every time. Secondly, if CRC is done on two different pieces of data, they should have very different CRC values. With a 32-bit CRC there are over 4 billion possible CRC values. To be exact that's 232 or 4,294,967,296. With the combination of the email_message_unix_date, email_message_byte_size, and CRC of both the subject and the header, embodiments of the present invention can neglect the possibility of two messages having the same unique ID, because no two e-mails should have the exact size, date, subject and header in the real world.

Function Mailbox Delete Messages

int email_mailbox_delete_messages (protocol, email_link,
mailbox_name, email_message_unique_ids, &error_no, &error_disp)

This function is used to delete an array of messages from a particular mailbox. The email_message_unique_ids define the unique Ids of the messages to be deleted.

Function Mailbox Move Messages

int email_mailbox_delete_messages (protocol, email_link,
from_mailbox_name, to_mailbox_name, email_message_unique_ids,
&error_no, &error_disp)

This function is used to move an array of messages from a particular mailbox to another. The email_message_unique_ids define the unique Ids of the messages to be moved. This function is not available for POP and SPOP protocols.

Function Mailbox Append Message

int email_mailbox_append_message (protocol, email_link,
mailbox_name, email_message_data, &error_no, &error_disp)

This function is used to append a new message to the end of a mailbox. Only IMAP and SIMAP protocols support this function. The message data must be properly formatted RFC 821 e-mail message.

Message Manipulation Module

These functions are done on a particular message or messages within a particular mailbox.

Function Message Get

array email_message_get (protocol, email_link, mailbox_name,
email_message_unique_id, &error_no, &error_disp)

This function is used to get a message from a particular mailbox based on its unique message ID. The array returned comprises,

array email_message_from - the From name and e-mail address
array email_message_to - the To name and e-mail address
array email_message_cc - the Cc name and e-mail address
array email_message_bcc - the Bcc name and e-mail address
string email_message_subject - the subject of the e-mail
int email_message_unix_date - the date of the e-mail in Unix time.
int email_message_byte_size - the size of the message in bytes
int email_message_priority - the priority of the message
array email_message_flags - the flags of the message, including New,
Seen, Replied, Deleted, etc. These are used to determine the
message status.
array email_message_other_header_entries - other header entries in
the e-mail header, e.g., X-Mailer, X-Maillist, etc.
string email_message_complete - complete email message in RFC 821
format. This is processed to extract pictures, attachments, etc,
and proper encoding. The e-mail decoding process will be discussed
later in this document.

Function Message Delete

int email_message_delete (protocol, email_link, mailbox_name,
email_message_unique_id, &error_no, &error_disp)

This function is used to delete a message from a particular mailbox based on its unique message ID.

Function Message Move

int email_message_delete (protocol, email_link, from_mailbox_name,
to_mailbox_name, email_message_unique_id, &error_no,
&error_disp)

This function is used to move a message from a particular mailbox based on its unique message ID to another mailbox. This function is not available for POP and SPOP protocols.

Function Message Set/Clear Flags

int email_message_set_flags (protocol, email_link, mailbox_name,
email_message_unique_id, new_email_message_flags, &error_no,
&error_disp)

This function is used to set/clear the flags on a message in a particular mailbox based on its unique message ID. The new_email_message_flags parameter is an array that comprises the message flags to be set or cleared, e.g., these will mark the e-mail message as new.

Seen, 0 - clear the Seen flag
New, 1 - set the New flag

Function Message Send

```
int email_mailbox_delete_messages (protocol, email_link,
save_a_copy, sent_items_mailbox_name, from, to, cc, bcc,
email_message_data, &error_no, &error_disp) {
  if (protocol == “POP”)
  {
    verify_email_link; // make sure link is there
    pop_send_email;
    bcc_to_sender;
  }
  else if (protocol == “IMAP”)
  {
    verify_email_link; // make sure link is there
    imap_send_email;
    email_mailbox_append_message;
  }
  else if (protocol == “HOTMAIL”)
  {
    hotmail_send_email(save_a_copy); // hotmail can send and
save to sent items in one step
  } [symbol]
  // other e-mail protocols
}
```

This function is used to send a new message and if chose, save a copy to the sent items folder. Only The message data must be properly formatted RFC 821 e-mail message. In e-mail protocols/platforms that does not support save a copy to sent items folder, or append to mailbox, the sender will get a bcc copy if “save_a_copy” is set.

Function Message Decode

array email_message_decode (email_message_complete, &error_no,
&error_disp)

This function is used to decode an e-mail message and return all pieces in an array. The array returned comprises,

array email_message_from - the From name and e-mail address
array email_message_to - the To name and e-mail address
array email_message_cc - the Cc name and e-mail address
array email_message_bcc - the Bcc name and e-mail address
string email_message_subject - the subject of the e-mail
int email_message_unix_date - the date of the e-mail in Unix time.
int email_message_byte_size - the size of the message in bytes
int email_message_priority - the priority of the message
array email_message_flags - the flags of the message, including New,
Seen, Replied, Deleted, etc. These are used to determine the
message status.
array email_message_other_header_entries - other header entries in
the e-mail header, e.g., X-Mailer, X-Maillist, etc.
string email_message_raw_header - raw header from the message
string email_message_raw_body - raw body from the message
array email_message_body - decoded body of the message in different
formats (HTML and text for different mobile devices)
array email_message_attachments_raw - the name and decoded binary
data of attachments
array email_message_attachments_preview - the name and preview data
of attachments if the file format is supported by preview
array email_message_inline_images - the name (if available) and
decoded binary data of inline images (inline images are referred to
by the “cid:” tag in the e-mail body
Message body data formats
HTML 4.0 for regular desktop browsers (e.g., Netscape 4 and above,
Internet Explorer 4 and above)
Simplified HTML 4.0 for Pocket PC with Pocket Internet Explorer, and
PalmOS devices with Blazer browsers
HTML 3.0 for older desktop browser (e.g., Netscape 3 and below,
Internet Explorer 3 and below) and PalmOS devices with other
browsers
cHTML for NTT DoCoMo devices
HTML 2.0 for text browsers
Web Clipping HTML for Palm VII devices
Special HTML for Avantgo
WAP for cell phones
Text only

File Format Supported by Preview

These file formats are converted automatically to readable formats for the particular body data formats.

doc - MS Word file
xls - MS Excel file
ppt - MS Power Point file
pdf and epdf - Adobe Acrobat PDF and Enhanced PDF files
ps, eps, eps2, epsf, epsi, ept, and epi - All Postscript files
zip - Zip file
txt and.text and log - text file
htm and html - html file.
tgz and tar.gz- tar and zip file for Unix platforms
gif, jpg, bmp, png, pct, tif, and tiff - picture and image

Logout Module

Once all e-mail transactions are completed, the logout module is used to close the e-mail link.

The following function is pseudo-code for the log out module, it returns true (1) and the closes corresponding e-mail link (through which all previous e-mail transactions have been done) when the logout is a success, and returns false (0) when authentication fails, the corresponding error number and error description are also returned.

```
int email_logout (username, password, email_link, &error_no,
&error_disp) {
  if (protocol == “POP”)
  {
    pop_logout (username, password, email_link, &error_no);
  }
  else if (protocol == “IMAP”)
  {
    imap_logout (username, password, email_link, &error_no);
  }
  else if (protocol == “HOTMAIL”)
  {
    hotmail_logout (username, password, email_link,
&error_no);
  }

[symbol]

  error_disp = email_error_message (error_no); // convert error
number to error message
  error_handling; // handle error

[symbol]

}
```

Extension of the Abstraction Layer

To add a new e-mail protocol/platform to the Abstraction Layer, one will need to add the corresponding handler to each of such functions in each module.

Important factors to consider when extending the modules:

The sequence of authentication schemes: some e-mail servers support multiple authentication schemes. One should always try the most secure ones first, then fall back to the less secure ones. For example, on some Exchange servers, they support both AUTH NTLM and LOGIN, one should always try AUTH NTLM first, if that fails, try LOGIN.

If an e-mail protocol/platform does not support certain functions, one should still write a handler to indicate that it is not supported.

Always close the connection (email_link) to the e-mail server before closing the Abstraction Layer, failing to do so may prohibit future authentication, because the connection would be still open.

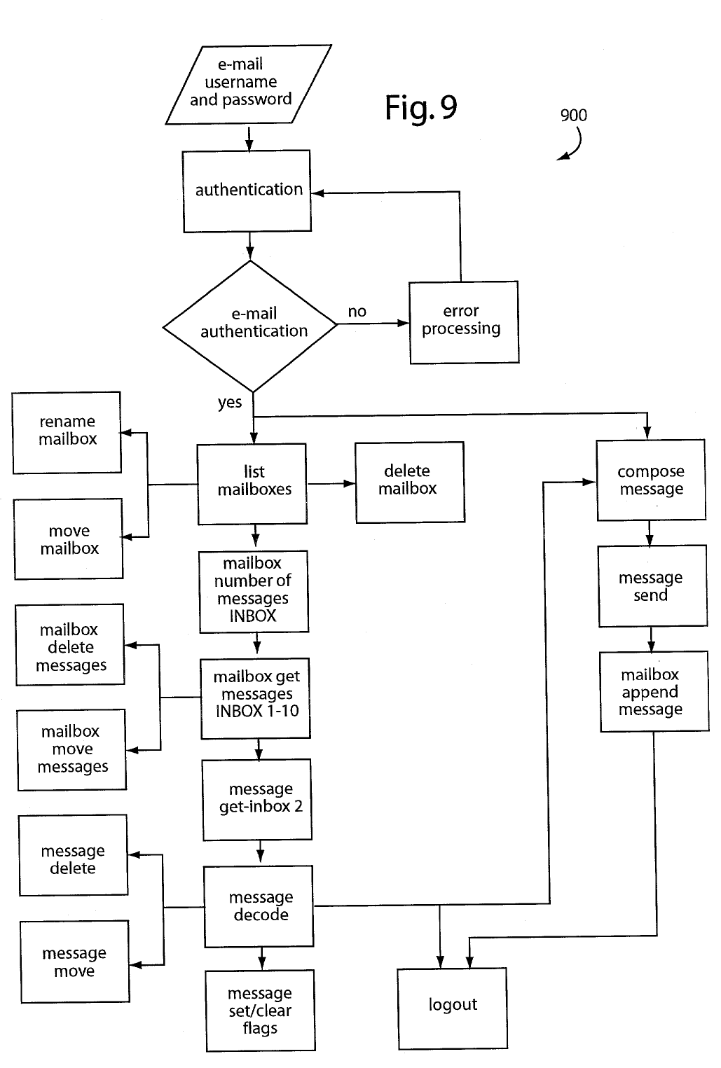

FIG. 9 represents a typical email session using the abstraction layer. In this example, the entire email session is done on the abstraction layer. The higher system does not need to interact with the email system directly, instead it talks to the generic abstraction layer.

Detailed information on the e-mail abstraction layer technology useful in embodiments of the present invention is disclosed in the U.S. Provisional Patent Application of the present inventor, Baohua HUANG, serial No. 60/370,617, filed Apr. 9, 2002, and titled E-MAIL ABSTRACTION LAYER SYSTEM. Such is incorporated herein by reference.

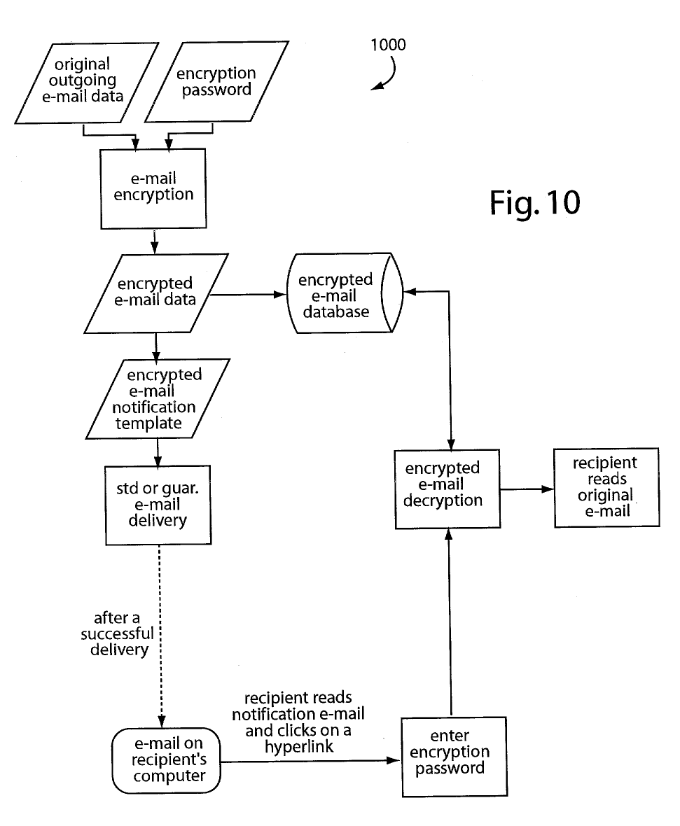

FIG. 10 represents an encrypted e-mail processor 1000, in an embodiment of the present invention, which provides a way to transmit an electronic document in an encrypted format. Such does not rely on a public/shared key server (e.g., PGP), and so can be implemented easily without the help of third-party servers and applications.

The real e-mail message with its content never actually gets delivered to the recipient. Instead, a notification e-mail is sent to the recipient to pick up the e-mail from a link or a form.

Encrypted e-mail processor 1000 uses a single shared secret, e.g., a password, to encrypt the original e-mail data. There are many selections of possible encryption algorithms, but it must be able to do two-way encryption/decryption, that is, it must be able to decrypt the encrypted message using the same key it used to encrypt the message. Examples of possible encryption algorithms include: BLOWFISH, TWOFISH, DES, TripleDES, 3-WAY, SAFER-sk64, SAFER-sk128, SAFER+, LOKI97, GOST, RC2, RC6, MARS, IDEA, RIJNDAEL-128 (AES), RIJNDAEL-192, RIJNDAEL-256, SERPENT, CAST-128 (known as CAST5), CAST-256, ARCFOUR and WAKE.

All such mechanisms require the original and a key or password to enable the encryption. The original e-mail data is in complete RFC821 compliant e-mail data format.

string email_encrypt(email_data, email_password) { [symbol]
// encrypt email_data with email_password
}

In password generation and transmission, the password is a shared secret between the sender and the recipient. The sender must communicate the password to the recipient before the recipient may decrypt and read the original e-mail message. The password can be generated by the system, or chosen by the user. However, the password must be checked for minimum length, and against a common word dictionary to avoid possible brute force attacks.

Encrypted data is stored in an encrypted e-mail database, and the data is decrypted and retrieved by the recipient using the password obtained from the sender.

The e-mail that the recipient initially receives comprises a notification, in the form of an HTML form or a direct text link.

HTML Form Example

<p>Sender at testuser@gopherking.net has sent you an encrypted e-
mail message, you must fill in the correct password in the following
box to be able to decrypt the message and view it. Contact the
sender if you do not have the correct password.</p>
<form name=“email_decrypt” method=“post”
action=“http://www.myserver.com/email_decrypt.cgi”>
<input type=“hidden” name=“tracking_number”
value=“1ACF112430234”>
<input type=“hidden” name=“recipient_email”
value=“testuser2@gopherking.net”>
<p>Password: <input type=“text” name=“password” value=“ ”
length=“24”>
<input type=“button” name=“submit” value=“Submit”>
</form>

Direct Text Link Example

Sender at testuser@gopherking.net has sent you an encrypted e-mail
message, please click on the following link, and you must fill in
the correct password in the following box to be able to decrypt the
message and view it. Contact the sender if you do not have the
correct password.
http: //www.myserver.com/email_decrypt.cgi?tra
tracking_number=1ACF112430234& recipient_email=
testuser2@gopherking.net

The HTML form and the directly link can also be combined into a single e-mail message which comprises “multipart/alternative” message components (text and HTML). This will ensure the message to be compatible with any e-mail client.

In standard delivery and guaranteed delivery, the notification e-mail can be sent via standard e-mail delivery system or combined with the guaranteed e-mail delivery system. When guaranteed delivery and encrypted e-mail is combined, it provides the ultimate protection for the sender and recipient.

If the user chooses to save a copy to sent items folder, they can also choose to save the original unencrypted e-mail or the notification e-mail or both, in the sent items folder.

In order for a user to read an encrypted e-mail, the client must have an internet connection, and the client must have an internet browser capable of ssl.

If the recipient's e-mail client supports html e-mail, what they will see is an html form, which asks him to fill in the password in order to read the e-mail. The user will enter the correct password obtained from the sender and a new browser window will pop up which comprises the decrypted e-mail message.

If the recipient's e-mail client does not support html e-mail, what they will see is a text link, they can open the link in a browser window. The web page will ask him to fill in the password in order to read the e-mail. The user will enter the correct password obtained from the sender and a new browser window will pop up which comprises the decrypted e-mail message.

Decryption Module

string email_decrypt(encrypted_email_data, email_password) { [symbol]
// decrypt encrypted_email_data with email_password
}

The decrypted data is exactly the same as the original e-mail data sent by the sender.

On a web page, the recipient has the option to,

Read the e-mail;
Download the attachment(s) from the e-mail;
Download the entire e-mail in different formats for import into
other e-mail clients or storage (RFC821 text, Microsoft Outlook,
Microsoft Outlook Express, Eudora, etc.);
Delete the e-mail entirely;
Forward/Redirect the e-mail as a regular e-mail without Encryption
to other recipient(s);
Forward/Redirect the e-mail as a new Encrypted e-mail to other
recipient(s);
If the recipient is an existing Gopher King user, move the e-mail as
a regular e-mail into one of his own e-mail accounts/folders.

When a recipient opens a decrypted e-mail on a web site, the following information can be captured to track the usage of the e-mail, and it can be made available to the sender and/or recipient.

Date and Time the message was opened.
IP address of the computer on which the message was opened.
The recipient who opened the e-mail. (This is done by adding the
recipient's ID or e-mail address to the tracking script).
The tracking number of the e-mail. (This is done by inserting a
tracking number into the tracking script).
The above information can also be recorded multiple times if the e-
mail was opened multiple times or the e-mail was forwarded and read
by other people. The Delivery Recording Module takes the
information and stores it in the database.

If needed, the sender can specify a specific IP address or IP address range, in which the recipient is allowed to open the e-mail. If the recipient IP address is not part of the specification, the request will be denied. This can be used to ensure reader of the e-mail is the designated recipient.

[image]

[image]

[image]

[image]

[image]

[image]

[image]

[image]

[image]

[image]

[image]

[image]

[image]

[image]

[image]

[image]

[image]

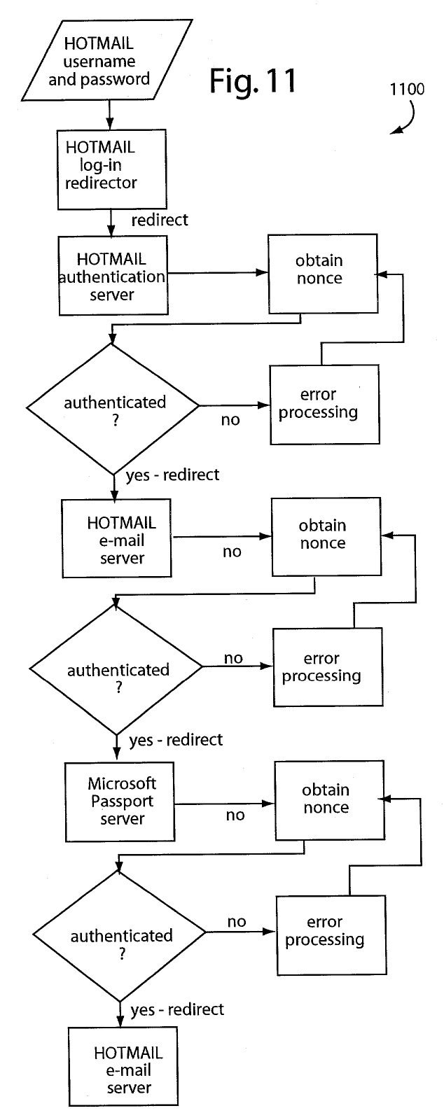

FIG. 11 represents a HOTMAIL system access method embodiment of the present invention, and is referred to herein by the general reference numeral 1100.

Hotmail e-mail system access is based on a unique login process and a protocol, e.g., so-called “WebDAV”. This document describes the Hotmail Login process, and the Hotmail implementation of the WebDAV protocol. More information about the WebDAV protocol is available at the WebDAV web site (www.webdav.org).

The Hotmail system provides for web-only access, so all transactions are done under http (port 80) and/or https protocols (port 443). Hotmail therefore extends the WebDAV protocol to handle e-mail messages using GET, POST, MOVE, PROPFIND, and PROPPATCH. XML schema and data are used as the core of the WebDAV protocol. The e-mail client must be able to parse and extract necessary data from XML.

The Hotmail Login Process starts with a redirector, or Hotmail Authentication Server. Once the user is authenticated with a correct username and password, the user is redirected to an actual Hotmail e-mail server with the credentials stored in the form of cookies.

Hotmail Login process depends on cookie support. It assumes the e-mail client is able to handle cookies and is able to send standard WebDAV commands. Currently, only e-mail clients that are made by Microsoft are able to fit these criteria, Microsoft Outlook (97 and newer) and Microsoft Outlook Express (5.0 and newer). None of the other e-mail clients are able to handle this Login process and WebDAV component.

PROPFIND Method. Traditional http and https request methods include GET, POST, PUT, etc. These methods are enough to handle regular web site transactions, but not enough to handle a user authentication process or e-mail capabilities. PROPFIND as part of the WebDAV implementation is able to handle these requirements.

The construction of the PROPFIND method is very similar to the POST method; for example, this is sample request to the server.

```
PROPFIND /svcs/hotmail/httpmail.asp HTTP/1.1
Depth: 0
Content-Type: text/xml
Brief: t
Host: services.msn.com
Content-Length: 357
Connection: Keep-Alive
Cache-Control: no-cache
Cookie: MC1=V=2&GUID=F6665142F24947A8AFC53FA2D50FBFDD;
SITESERVER=ID=UID=F6665142F24947A8AFC53FA2D50FBFDD;
mh=MSFT
<?xml version=“1.0”?>
<D:propfind xmlns:D=“DAV:”
xmlns:h=“http://schemas.microsoft.com/hotmail/”
xmlns:hm=“urn:schemas:httpmail:”>
  <D:prop>
    <h:adbar/>
    <hm:contacts/>
    <hm:inbox/>
    <hm:outbox/>
    <hm:sendmsg/>
    <hm:sentitems/>
    <hm:deleteditems/>
    <hm:drafts/>
    <hm:msgfolderroot/>
    <h:maxpoll/>
    <h:sig/>
  </D:prop>
</D:propfind>
```

The data portion of the PROPFIND command is an XML schema for FIND_BASE_FOLDERS, embodiments of the present invention will talk about this in the next part.

Hotmail Login Redirector

The initial Hotmail Login Request is sent to the Hotmail Login Redirector. This server is defined as a constant http://services.msn.com/svcs/hotmail/httpmail.asp. See sample source code above, PROPFIND is used to contact the server.

However, it seems that Microsoft keeps moving things around, so this Hotmail Authentication Server is just a redirector to another the real Hotmail Authentication Server. At the moment when this document is written, the Actual Hotmail Authentication Server is http://oe.hotmail.com/cgi-bin/hmdata. See the following response from the Hotmail Authentication Server details,

HTTP/1.1 302 Object moved
Server: Microsoft-IIS/5.0
Date: Sun, Sep 23, 2001 16:11:51 GMT
P3P:CP=“BUS CUR CONo FIN IVDo ONL OUR PHY SAMo TELo”
Connection: close
Location: http://oe.hotmail.com/cgi-bin/hmdata
Content-Length: 157
Content-Type: text/html
Expires: Sun, Sep 23, 2001 16:11:51 GMT
Cache-control: private
<head><title>Object moved</title></head>
<body><h1>Object Moved</h1>This object may be found <a
HREF=“http://oe.hotmail.com/cgi-bin/hmdata”>here</a>.</body>

If the e-mail client does not understand the “302” response, object moved, such client will not be able to continue with the authentication.

The Hotmail Authentication Server is contacted to retrieve the 302 responses, then the Location directive extracted to get the Hotmail Authentication Server.

Authenticate Against Hotmail Authentication Server

Once the URL of the Hotmail Authentication server is obtained, requests can be sent to it, e.g.,

```
PROPFIND /cgi-bin/hmdata HTTP/1.1
Depth: 0
Content-Type: text/xml
Brief: t
Content-Length: 357
Connection: Keep-Alive
Cache-Control: no-cache
Authorization: Digest username=“testuser@hotmail.com”,
realm=“hotmail.com”, qop=“auth”, algorithm=“MD5”, uri=“/cgi-
bin/hmdata”,
nonce=“MTAwMTI2MTIwNDphMDE2MDYyMmVjNjIyZmIyZjE0NWUwNmIxNzFiM2NjMA==”
, nc=00000002, cnonce=“65cb68164b560ed2e339548ed69f3fff”,
response=“457f4c996cc7b3f0e409dc4c395b0f42”
Host: oe.hotmail.com
<?xml version=“1.0”?>
<D:propfind xmlns:D=“DAV:”
xmlns:h=“http://schemas.microsoft.com/hotmail/”
xmlns:hm=“urn:schemas:httpmail:”>
  <D:prop>
    <h:adbar/>
    <hm:contacts/>
    <hm:inbox/>
    <hm:outbox/>
    <hm:sendmsg/>
    <hm:sentitems/>
    <hm:deleteditems/>
    <hm:drafts/>
    <hm:msgfolderroot/>
    <h:maxpoll/>
    <h:sig/>
  </D:prop>
</D:propfind>
```

In such example, a Hotmail user with e-mail address testuser@hotmail.com is being authenticated using digest MD5.

Field Used in Digest MD5 Authentication

| Field | Details |
|---|---|
| Username | The full Hotmail e-mail address, including @ and domain |
| | name - Case insensitive |
| Realm | Constant, always hotmail.com |
| Qop | Constant, always auth |
| Algorithm | Constant, always MD5 - Case insensitive |
| Uri | The URI to the authentication script, without host name |
| Nonce | Nonce sent by the server to challenge the client |
| Nc | Counter, must be incremented by 1 each time a response |
| | is sent to the server |
| Cnonce | Client Nonce, generated randomly by the client to make |
| | the MD5 routine more random |
| Response | The digest MD5 response, see the following topic for |
| | details |

An important field is the “response” filed, which is calculated using the following MD5 scheme,

response=MD5 (MD5(“username:realm:password”) .
“:nonce:nc:cnonce:qop:” .
MD5(“{request_method}:{request_uri}”) ) ;
password is the user's Hotmail password
request_method is the request method of this request - PROPFIND,
case sensitive
MD5 stands for regular MD5 routine, which is irreversible

This is done is to avoid sending the password in clear text and thus avoid any possible breach of security.

The data sent after the PROPFIND header is an XML scheme requesting the basic folder structure of the Hotmail account, embodiments of the present invention will talk about this in the second stage.

Once all the fields and the response are received by the server, the server compares the response to the response calculated from the username and password stored in the Hotmail database. If a match is found, then the client is authenticated. If not, then a 401 error (Authentication Required) is sent back to the client. In our example, since this is the first time our client is logging in after a long period of time, embodiments of the present invention receive a 401, see example.

HTTP/1.1 401 Authorization Required
Server: Microsoft-IIS/5.0
Date: Sun, Sep 23, 2001 16:11:51 GMT
P3P:CP=“BUS CUR CONo FIN IVDo ONL OUR PHY SAMo TELo”
Connection: close
Content-Type: text/html
WWW-Authenticate: Digest realm=“hotmail.com”,
nonce=“MTAwMTI2MTUxMTo4MjE5ZjdkZTE2MDVjMDQwODQ4MjExNjhkYjkzZTk5OA==”
, qop=“auth”
X-Dav-Error: 401 Invalid digest
HMServer: H: DAV5.law5.internal.hotmail.com V: WIN2K 09.03.12.0005
i D: Sep 12, 2001 13:39:51

Now the client need to extract the digest realm, nonce, opaque and qop from the server response, then do another authentication using the new values.

```
PROPFIND /cgi-bin/hmdata HTTP/1.1
Depth: 0
Content-Type: text/xml
Brief: t
Content-Length: 357
Connection: Keep-Alive
Cache-Control: no-cache
Authorization: Digest username=“testuser@hotmail.com”,
realm=“hotmail.com”, qop=“auth”, algorithm=“MD5”, uri=“/cgi-
bin/hmdata”,
nonce=“MTAwMTI2MTUxMTo4MjE5ZjdkZTE2MDVjMDQwODQ4MjExNjhkYjkzZTk5OA==”
, nc=00000001, cnonce=“76d83126c1af1a433789ab3c005dad9a”,
response=“1a004a172d955420b42f049c012b74ae”
Host: oe.hotmail.com
<?xml version=“1.0”?>
<D:propfind xmlns:D=“DAV:”
xmlns:h=“http://schemas.microsoft.com/hotmail/”
xmlns:hm=“urn:schemas:httpmail:”>
  <D:prop>
    <h:adbar/>
    <hm:contacts/>
    <hm:inbox/>
    <hm:outbox/>
    <hm:sendmsg/>
    <hm:sentitems/>
    <hm:deleteditems/>
    <hm:drafts/>
    <hm:msgfolderroot/>
    <h:maxpoll/>
    <h:sig/>
  </D:prop>
</D:propfind>
```

Once the client is successfully authenticated, the server sends a 302 Redirect) command to the client.

HTTP/1.1 302 Redirected
Server: Microsoft-IIS/5.0
Date: Sun, 23 Sep 2001 16:11:52 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/html
Location: http://law7.oe.hotmail.com/cgi-
bin/hmdata/testuser@hotmail.com
X-Dav-Error: 200 No error
HMServer: H: DAV47.law5.internal.hotmail.com
V: WIN2K 09.03.12.0005
i D: Sep 12 2001 13:39:51

Embodiments of the present invention can also detect this by checking for the X-Dav-Error as 200 No Error. If an error is found, a 401 (Authentication Required) or 503 (Service Unavailable) should be found.

The client should extract the “Location” directive from the “302” response. This is used in the next section Hotmail e-mail Server Authentication.

Authenticate Against Hotmail Email Server

Once the URL of the Hotmail e-mail server is obtained, it can connect and request authentication.

```
PROPFIND /cgi-bin/hmdata/testuser@hotmail.com? HTTP/1.1
Depth: 0
Content-Type: text/xml
Brief: t
Host: law7.oe.hotmail.com
Content-Length: 357
Connection: Keep-Alive
Cache-Control: no-cache
<?xml version=“1.0”?>
<D:propfind xmlns:D=“DAV:”
xmlns:h=“http://schemas.microsoft.com/hotmail/”
xmlns:hm=“urn:schemas:httpmail:”>
  <D:prop>
    <h:adbar/>
    <hm:contacts/>
    <hm:inbox/>
    <hm:outbox/>
    <hm:sendmsg/>
    <hm:sentitems/>
    <hm:deleteditems/>
    <hm:drafts/>
    <hm:msgfolderroot/>
    <h:maxpoll/>
    <h:sig/>
  </D:prop>
</D:propfind>
```

The server responds with 401 Authentication Required,

HTTP/1.1 401 Authorization Required
Server: Microsoft-IIS/5.0
Date: Sun, Sep 23, 2001 16:11:53 GMT
P3P:CP=“BUS CUR CONo FIN IVDo ONL OUR PHY SAMo TELo”
Connection: close
Content-Type: text/html
WWW-Authenticate: Digest realm=“hotmail.com”,
nonce=“MTAxNjc2OTM3NDoxYjI4MzBiYjhiZTQwMzA2NmJiMTU0ZDQ3MzcwZDg2Mw==”
, qop=“auth”
X-Dav-Error: 401 No email address
HMServer: H: DAV47.law5.internal.hotmail.com V: WIN2K 09.03.12.0005
i D: Sep 12, 2001 13:39:51

The client extracts the realm, nonce, opaque and qop from the response.

The client builds an digest MD5 response and send it back to the server, the algorithm is exactly the same as the MD5 routine in the Hotmail Authentication Server scheme.

PROPFIND /cgi-bin/hmdata/testuser@hotmail.com? HTTP/1.1
Depth: 0
Content-Type: text/xml
Brief: t
Host: law7.oe.hotmail.com
Content-Length: 357
Connection: Keep-Alive
Cache-Control: no-cache
Authorization: Digest username=“testuser@hotmail.com”,
realm=“hotmail.com”, qop=“auth”, algorithm=“MD5”, uri=”/cgi-
bin/hmdata“,
nonce=“MTAwMTI2MTUxMTo4MjE5ZjdkZTE2MDVjMDQwODQ4MjExNjhkYjkzZTk50A ==”
, nc=00000001, cnonce=“76d83126c1af1a433789ab3c005dad9a”,
response=“1a004a172d955420b42f049c012b74ae”
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

Once the client is successfully authenticated, the server sends a 302 (Redirect) command to the client.

HTTP/1.1 302 Redirected
Server: Microsoft-IIS/5.0
Date: Sun, 23 Sep 2001 16:11:54 GMT
P3P:CP=“BUS CUR CONo FIN IVDo ONL OUR PHY SAMo TELo ”
Connection: close
Expires: Mon, 01 Jan 1999 00:00:00 GMT
Pragma: no-cache
Cache-Control: no-cache
Content-Type: text/html
Location:
http://loginnet.passport.com/digest.srf?_lang=EN&lc=1033&fs=1&ct=101
6769374&tw=1296000&id=2&kv=0&ru=http%3a%2f%2flaw7%2eoe%
2ehotmail%2ecom%2fcgi%2dbin%2fhmdata%2ftestuser%40hotmail%
2ecom%3f&log=1 X-Dav-Error: 200 No error
HMServer: H: DAV47.law5.internal.hotmail.com V: WIN2K
09.03.12.0005 i D: Sep 12 2001 13:39:51

Embodiments of the present invention can also detect this by checking for the X-Dav-Error as 200 No Error. If an error is found, a 401 (Authentication Required) or 503 (Service Unavailable) should be found.

The client should extract the “Location” directive from the “302” response. This is used in the next section Microsoft Passport Server Authentication. Authenticate Against Microsoft Passport Server

Once the URL of the Microsoft Passport server is obtained, the system can connect and request authentication.

PROPFIND
/digest.srf?_lang=EN&lc=1033&fs=1&ct=1016769374&tw1296000&id=
2&kv=0&ru=http%3a%2f%2flaw7%2eoe%2ehotmail%2ecom%2fcgi%
2dbin%2fhmdata%2ftestuser%40hotmail%2ecom%3f&log=1 HTTP/1.1
Depth: 0
Content-Type: text/xml
Brief: t
Cookie: MSPDom=2
Content-Length: 357
Connection: Keep-Alive
Cache-Control: no-cache
Host: loginnet.passport.com
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The server responds with 401 Authentication Required,

HTTP/1.1 401 Authorization Required
Server: Microsoft-IIS/5.0
Date: Sun, 23 Sep 2001 16:11:56 GMT
Connection: close
Content-Type: text/html
WWW-Authenticate: Digest realm=“Microsoft Passport”, qop=“auth”,
algorithm=“MD5”,
nonce=“MTAxNjc2OTM3NDp4BYm3Hkn68kgsmNP!DFhI”,
opaque=“03a1475e092074b14b2586f10”

The client extracts the realm, nonce, opaque, and qop from the response.

The client builds an digest MD5 response and send it back to the server, the algorithm is exactly the same as the MD5 routine in the Hotmail Authentication Server scheme.

PROPFIND
/digest.srf_lang=EN&lc=1033&fs=1&ct=1016769374&tw=1296000&id=
2&kv=0&ru=http%3a%2f%2flaw7%2eoe%2ehotmail%2ecom%2fcgi%
2dbin%2fhmdata%2ftestuser%40hotmail%2ecom%3f&log=1 HTTP/1.1
Depth: 0
Content-Type: text/xml
Brief: t
Cookie: MSPDom=2
Content-Length: 357
Connection: Keep-Alive
Cache-Control: no-cache
Authorization: Digest username=“testuser@hotmail.com
realm=“Microsoft Passport”, qop=“auth”, algorithm“MD5”,
uri=“/digest.srf”,
nonce=“MTAxNjc2OTM3NDp4BYm3Hkn68kgsmNP!DFhI”,
nc=00000001, cnonce=“efac396129c673777a96acc1916644bd”,
opaque=“03a1475e092074b14b2586f10”,
response=“9785e877704b8ab37061663a9d445aae”
Host: loginnet.passport.com
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

Once the client is successfully authenticated, the server sends a 302 (Redirect) command to the client.

HTTP/1.1 302 Redirect to partner
Server: Microsoft-IIS/5.0
Date: Sun, 23 Sep 2001 16:11:55 GMT
Connection: close
Content-Length: 17
Content-Type: text/html
Location: http://law7.oe.hotmail.com/cgi-
bin/hmdata/testuser@hotmail.com?&p=2w8saHBXlCwJAYx!lBo20X*
PYHhP*tJM7X*cOVHAbrC8NNXhRyJZwBgHzm!QQ220Pqc79DIW
zfkndNCS5uFTIPobxk2BpQ4ziBPAgOvs4SM3pUvj5wieDl!czEVGRxj
7PWEYJVOo0VMuJv9j86Gg9OeAO7NtHdEfFdxxJiTveMk5Zw0Xd3No
60CrSw$$&t=2w8saHBXlDf0bu0587Y8PiJRLT!*a7SJbOpeWTnBgomkm
2017pCCzJpDEZoQrlK*ilHzLhUzwjpLELqQpHQkLmFg$$

Embodiments of the present invention can also detect this by checking for the X-Dav-Error as 200 No Error. If an error is found, a 401 (Authentication Required) or 503 (Service Unavailable) should be found.

The client extracts the “Location” directive from the “302” response. The client is actually being redirected back to the Hotmail e-mail Server. However, the URL is special and it comprises certain cookies to be used by the Hotmail e-mail Server.

Log Onto Hotmail E-Mail Server with Special URL

The special URL obtained in the previous step includes authentication information for the Hotmail e-mail Server. The client follows the special URL and connects to the Hotmail e-mail Server,

PROPFIND/cgi-
bin/hmdata/testuser@hotmail.com?&p=2w8saHBXlCwJAYx!lBo20X*PYHhP*JM7X
*cOVHAbrC8NNXhRyJZwBgHzm!QQ220Pqc79DIWzfkndNCS5uFTIPobxk2BpQ4ziBPAgO
vs4SM3pUvj5wieDl!czEVGRxj7PWEYJVOoOVMuJv9j86g9OeAO7NtHdEfFdxxJiTVeMk
5ZwOXd3No60CrSw$$&t=2w8saHBXlDf0bu0587Y8PiJRLT!*a7SJb0peWTnBgomkm201
7pCCzJpDEZoQrlK*ilHzLhUzwjpLELqQpHQkLmFg$$ HTTP/1.1
Depth: 0
Content-Type: text/xml
Brief: t
Authorization: Digest username=“testuser@hotmail.com”,
realm=“hotmail.com”, qop=“auth”, algorithm=“MD5”, uri=“/cgi-
bin/hmdata/testuser@hotmail.com”,
nonce=“MTAxNjc2OTM3NDoxYjI4MzBiYjhiZTQwMzA2NmJiMTU0ZDQ3MzcwZDg2Mw==”
, nc=00000002, cnonce=“3e51960a7f5915c92cb1b4fe37ea9b88”,
response=“90a7896e28aa0789bd6bf2af3292097”
Content-Length: 357
Connection: Keep-Alive
Cache-Control: no-cache
Host: law7.oe.hotmail.com
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The Hotmail e-mail server processes the special URL and send back a 207 Multi-status response (which indicates a success), and also set four cookies which will act as authentication credentials in future requests.

HTTP/1.1 207 Multi-Status
Server: Microsoft-IIS/5.0
Date: Sun, 23 Sep 2001 16:11:57 GMT
P3P:CP=“BUS CUR CONo FIN IVDo ONL OUR PHY SAMo TELo”
Connection: close
Set-Cookie:
MSPAuth=2w8saHBXlDf0bu0587Y8PiJRLT%21%2aa7SJb0peWTnBgomkm2017pCCzJpD
EZoQrlK%2ailHzLhUzwjpLELqQpHQkLmFg%24%24; domain=.hotmail.com;
path=/cgi-bin/hmdata/testuser@hotmail.com
Set-Cookie:
MSPProf=2w8saHBXlCwJAYx%211Bo20X%2aPYHhP%2aJM7X%2acOVHAbrC8NNXhRyJZw
BgHzm%21QQ220Pqc79DIWzfkndNCS5uFTIPobxk2BpQ4ziBPAgOvs4SM3pUVj5wieDl%
21czEVGRxj7PWEYJYOo0VMuJv9j86g9OeAO7NtHdEfFdxxJiTveMk5Zw0Xd3No60CrSw
%24%24; domain=.hotmail.com; path=/cgi-
bin/hmdata/testuser@hotmail.com
Set-Cookie: OE_Usertestuser_hotmail.com=1016855775;
domain=hotmail.com; path=/
Set-Cookie:
HMSC0899=221testuser%40hotmail%2ecomw1roc9SfNgqYiNquHSjnt1HGP5b%21gz
xZ0ym%21qkZgYUq4EpDBbURb1TxmUksT3p8864fTXz6eYxMb02S70GF1B3y4SDupmxEM
DIrfMDFim0D13%21ABR3s8djGZZPVbolroaJA2t6RIWHAiY%2aA0pwA8yb4zBHjacEhS
ulwA8mWYsn62TJfkEVmaammpHx18NoLcyKDIXFzUO4ZoLILH4PGUWzsgvZsk5%2aA%2a
OFG2G2Iyc3Hagxd%21jHcd6TPA%21yhnSr51vduVfwtr6eXIMM%21%2aiHp3h%2ay6Xa
rNdqW0eE6TgeLAc7VW3Y1wgd5i3ZXX06PnkhxKy8oZ%2aS0MXRJ7nmUwksANSkaR4jaY
ZhOyFRsBIW8JEhLlTfqWwRvDhw%24%24; domain=.hotmail.com; path=/cgi-
bin/hmdata/testuser@hotmail.com
Content-Length: 1569
Expires: Mon, 01 Jan 1999 00:00:00 GMT
Pragma: no-cache
Cache-Control: no-cache
Content-Type: text/xml
X-Timestamp: folders=1014781548, ACTIVE=1016768914
X-Dav-Error: 200 No error
HMServer: H: DAV47.law5.internal.hotmail.com V: WIN2K 09.03.12.0005
i D: Sep 12 2001 13:39:51
<?xml version=“1.0”encoding=“Windows-1252”?>
<D:multistatus xmlns:D=“DAV:”xmlns:m=“urn:schemas:mailheader:”
xmlns:hm=“urn:schemas:httpmail:”xmlns:c=“urn:schemas:contacts:”
xmlns:h=“http://schemas.microsoft.com/hotmail/”>
<D:response>
<D:href>http://law7.oe.hotmail.com/cgi-
bin/hmdata/testuser@hotmail.com/</D:href>
<D:wchref>http://law7.oe.hotmail.com/cgi-bin/wc_maint</D:wchref>
<D:sohref>http://law7.oe.hotmail.com/cgi-bin/somaintain</D:sohref>
<D:propstat>
<D:prop>
<h:adbar>AdPane=Off*AdSvr=H*Other=GetAd?PG=HOTOEB?SC=LG?TF=_BLANK?HM
=0450474d554b105153535146414671700a4f64511634520d5d525d58470c441f246
b</h:adbar>
<hm:contacts>http://law7.oe.hotmail.com/cgi-
bin/hmdata/testuser@hotmail.com/abdata/</hm:contacts>
>hm:inbox>http://law7.oe.hotmail.com/cgi-
bin/hmdata/testuser@hotmail.com/folders/ACTIVE/</hm:inbox>
<hm:sendmsg>http://law7.oe.hotmail.com/cgi-
bin/hmdata/testuser@hotmail.com/folders/sendmsg/</hm:sendmsg>
<hm:sentitems>http://law7.oe.hotmail.com/cgi
bin/hmdata/testuser@hotmail.com/folders/sAVeD/</hm:sentitems>
<hm:deleteditems>http://law7.oe.hotmail.com/cgi-
bin/hmdata/testuser@hotmail.com/folders/trAsH/</hm:deleteditems>
<hm:msgfolderroot>http://law7.oe.hotmail.com/cgi-
bin/hmdata/testuser@hotmail.com/folders/</hm:msgfolderroot>
<h:maxpoll>30</h:maxpoll>
<h:sig>&lt;br clear=all&gt;&lt;hr&gt;Get your FREE download of MSN
Explorer at &lt;a
href=&apos;http://g.msn.com/1HM305401/13&apos;&gt;http://explorer.ms
n.com&lt;/a&gt;.&lt;br&gt;
</h:sig>
</D:prop>
<D:status>HTTP/1.1 200 OK</D:status>
</D:propstat>
</D:response>
</D:multistatus>

The XML data returned will be discussed in the next Part.

There should be four cookies present, MSPAuth, MSPProf, OE_Usertestuser_hotmail.com, and HMSC0899. These four cookies store the following information of the user,

a. Encrypted user authentication information, verification data and other user data

b. Expiration date/time of the authentication information

c. Cross validation information between cookies

To speed up the login process, the cookies and the “Location” directive can be cached into a database, then used directly to start the second stage. If a 401 (Authentication Required) response is received, then the authentication process needs to be restarted. However, if a 2xx (Success) response is received, the system can proceed directly to the e-mail transactions. By caching the cookies, the process can speed up dramatically. The usable lifetime of the cookies seems to be around 24 hours.

In a second part of the process, e-mail transactions are processed through WebDAV. Pre-defined XML data schemas are used by embodiments of the present invention to access Hotmail. Such schemas are used in conjunction with the Request URI in PROPFIND method to do e-mail transactions on the e-mail server.

XML Data Schemas

FIND_BASE_FOLDERS is used with the initial connect with the Hotmail e-mail Server, and retrieve the base folders on the Hotmail e-mail system.

<?xml version=“1.0”?>
<D:propfind xmlns:D=37 DAV:”
xmlns:h=“http://schemas.microsoft.com/hotmail/”
xmlns:hm=“urn:schemas:httpmail:”>

<D:prop>

<hm:contacts/>
<hm:inbox/>
<hm:outbox/>
<hm:sendmsg/>
<hm:sentitems/>
<hm:deleteditems/>
<hm:drafts/>
<hm:msgfolderroot/>

</D:prop>

</D:propfind>

FIND_SUB_FOLDERS is used to find subfolders within a certain folder, with their properties returned. The request URI must contain the folder itself.

<?xml version=“1.0”?>
<D:propfind xmlns:D=“DAV:” xmlns:hm=“urn:schemas:httpmail:”>

<D:prop>

<D:isfolder/>
<D:displayname/>
<hm:special>
<D:hassubs/>
<D:nosubs/>
<hm:unreadcount/>
<D:visiblecount/>
<hm:special/>

</D:prop>

</D:propfind>

FIND_MSGS is used to find messages within a certain folder, with their properties returned. The request URI must contain the folder itself.

<?xml version=“1.0”?>
<D:propfind xmlns:D=“DAV:” xmlns:hm=“urn:schemas:httpmail:”
xmlns:m=“urn:schemas:mailheader:”>

<D:prop>

<D:isfolder/>
<hm:read/>
<m:hasattachment/>
<m:to/>
<m:from/>
<m:subject/>
<m:date/>
<D:getcontentlength/>

</D:prop>

</D:propfind>

MARK_AS_READ is used to mark a message as read. An e-mail message is marked as read automatically if the e-mail message has been retrieved through the GET command (see next section on the GET command). The request URI must contain the message ID of the e-mail to be marked as read.

<?xml version=“1.0”?>
<D:propertyupdate xmlns:D=“DAV:”
xmlns:hm=“urn:schemas:httpmail:”>

<D:set>

<D:prop>

<hm:read>1</hm:read>

</D:prop>

</D:set>

</D:propertyupdate>

MARK_AS_UNREAD is used to mark a message as unread. The request URI must contain the message ID of the e-mail to be marked as unread.

<?xml version=“1.0”?>
$PATCHMARKUNREAD.=“<D:propertyupdate xmlns:D=“DAV:”
xmlns:hm=“urn:schemas:httpmail:”>

<D:set>

<D:prop>

<hm:read>0</hm:read>

</D:prop>

</D:set>

</D:propertyupdate>

Logging Onto the Hotmail Email Server and Retrieve Base Folders

In logging onto the Hotmail e-mail server and retrieving base folders, the client sends a PROPFIND request to the new Hotmail e-mail Server, with the correct credentials in the form of cookies.

PROPFIND /cgi-bin/hmdata/testuser@hotmail.com HTTP/1.1
Depth: 0
Content-Type: text/xml
Brief: t
Cookie:
MSPAuth=2AAAAAAAADoK8YYizT6Y5vA5TeW7m7gT8h6NbIBec0ZGsADfx4pxY7Tw%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOow
SF0A1WgoGBlnS734BHh7o461EhZubg0vwa9PNxXI0odL;
Content-Length: 357
Connection: Keep-Alive
Cache-Control: no-cache
Host: law7.oe.hotmail.com
<?xml version=“1.0”?>
<D:propfind xmlns:D=“DAV:”
xmlns:h=“http://schemas.microsoft.com/hotmail/”
xmlns:hm=“urn:schemas:httpmail:“>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The corresponding XML data schema above is used to find the folders resided on the Hotmail e-mail system.

The server authenticates the user by inspecting the cookies. If an error is found, a 401 error (Authentication Required) will be sent to the client and the client has to start from the first stage to re-authenticate. If not, the server responds with the basic folder structures in the Hotmail account in the form of XML data. Embodiments of the present invention can detect the 207 Multi-status response or the X-Dav_Error 200 No Error response.

HTTP/1.1 207 Multi-Status
Server: Microsoft-IIS/5.0
Date: Sun, 23 Sep 2001 16:11:51 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
X-Timestamp: folders=989724657, ACTIVE=1001259853
X-Dav-Error: 200 No error
HMServer: H: OE70.law7.internal.hotmail.com V: WIN2K 09.03.12.0005
i D: Sep 12 2001 13:39:51
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://law7.oe.hotmail.com/cgi-
bin/hmdata/testuser@hotmail.com/</D:href>
<D:propstat>
<D:prop>
<h:adbar>AdPane=On*AdSvr=H*Other=GetAd?PG=HOTOEB?SC=LG?TF=_BLANK?HM=
0450474d554b105153535146414671700a4f64511634520d5d525d58470c441f246b
</h:adbar>
<hm:contacts>http://law7.oe.hotmail.com/cgi-
bin/hmdata/testuser@hotmail.com/abdata/</hm:contacts>
<hm:inbox>http://law7.oe.hotmail.com/cgi-
bin/hmdata/testuser@hotmail.com/folders/ACTIVE/</hm:inbox>
<hm:sendmsg>http://law7.oe.hotmail.com/cgi-
bin/hmdata/testuser@hotmail.com/folders/sendmsg/</hm:sendmsg>
<hm:sentitems>http://law7.oe.hotmail.com/cgi-
bin/hmdata/testuser@hotmail.com/folders/sAVeD/</hm:sentitems>
<hm:deleteditems>http://law7.oe.hotmail.com/cgi-
bin/hmdata/testuser@hotmail.com/folders/trAsH/</hm:deleteditems>
<hm:msgfolderroot>http://law7.oe.hotmail.com/cgi-
bin/hmdata/testuser@hotmail.com/folders/</hm:msgfolderroot>
<h:maxpoll>30</h:maxpoll>
<h:sig>&lt;br clear=all&gt;&lt;hr&gt;Get your FREE download of MSN
Explorer at &lt;a
href=&apos;http://go.msn.com/bql/hmtag_itl_EN.asp&apos; &gt;http://ex
plorer.msn.com&lt;/a&gt;&lt;br&gt;
</h:sig>
</D:prop>
<D:status>HTTP/1.1 200 OK</D:status>
</D:propstat>
</D:response>
</D:multistatus>

Fields in the Server Response

| Field | Explanation |
|---|---|
| D:href | This is the root URL for the Hotmail user |
| H:adbar | This is URL to the data to be used in the |
| | Advertising bar in Outlook and Outlook Express - |
| | ignored by embodiments of the present invention |
| hm:contacts | This is the URL to the user's Hotmail address |
| | book |
| hm:inbox | This is the URL to the user's Hotmail INBOX |
| hm:sendmsg | This is the URL to the user's Hotmail Outbox - |
| | messages posted in this folder are picked up |
| | immediately by Hotmail system and sent |
| | automatically |
| hm:sentitems | This is the URL to the user's Hotmail Sent Items |
| | folder |
| hm:deleteditems | This is the URL to the user's Hotmail Deleted |
| | Items folder - Embodiments of the present |
| | invention cannot delete messages completely from |
| | this folder. However, this folder is emptied |
| | automatically every night at midnight PST. |
| hm:msgfolderroot | This is the URL to the user's root folder, which |
| | comprises all the other folders |
| hm:maxpoll | Unknown - not used by embodiments of the present |
| | invention |
| h:sig | Signature used by Hotmail as a form of |
| | advertising - not used by embodiments of the |
| | present invention |

Get Stats on All Base Folders

In order to Get Stats on All Base Folders with the “hm:msgfolderroot” information retrieved above, the client sends another request to the server,

PROPFIND /cgi-bin/hmdata/testuser@hotmail.com/folders/ HTTP/1.1
Depth: 1, noroot
Content-Type: text/xml
Brief: t
Accept-CharSet: Windows-1252
Host: law7.oe.hotmail.com
Content-Length: 265
Connection: Keep-Alive
Cache-Control: no-cache
Cookie:
MSPAuth=2AAAAAAAADoK8YYizT6Y5vA5TeW7m7gT8h6NbIBec0ZGsADfx4pxY7Tw%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;
<?xml version=“1.0”?>
<D:propfind xmlns:D=“DAV:” xmlns:hm=“urn:schemas:httpmail:”>

<D:prop>

<D:isfolder/>
<D:displayname/>
<hm:special/>
<D:hassubs/>
<D:nosubs/>
<hm:unreadcount/>
<D:visiblecount/>
<hm:special/>

</D:prop>

</D:propfind>

The FIND_SUB_FOLDERS schema is used here.

The server authenticates the user by inspecting the cookies. If an error is found, a 401 error (Authentication Required) will be sent to the client and the client has to start from the first stage. If not, the server responds with the basic folder structures in the Hotmail account in the form of XML data. Embodiments of the present invention can detect the 207 Multi-status response or the X-Dav_Error 200 No Error response.

HTTP/1.1 207 Multi-Status
Server: Microsoft-IIS/5.0
Date: Sun, 23 Sep 2001 16:11:52 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
X-Timestamp: folders=989724657, ACTIVE=1001259853
X-Dav-Error: 200 No error
HMServer: H: OE36.law7.internal.hotmail.com V: WIN2K 09.03.12.0005
i D: Sep 12 2001 13:39:51
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://law7.oe.hotmail.com/cgi-
bin/hmdata/testuser@hotmail.com/folders/msnpromo/</D:href>
<D:propstat>
<D:prop>
<D:isfolder>1</D:isfolder>
<hm:special>msnpromo</hm:special>
<D:hassubs>0</D:hassubs>
<D:nosubs>1</D:nosubs>
<hm:unreadcount>2</hm:unreadcount>
<D:visiblecount>2</D:visiblecount>
<hm:special>msnpromo</hm:special>
</D:prop>
<D:status>HTTP/1.1 200 OK</D:status>
</D:propstat>
</D:response>
<D:response>
<D:href>http://law7.oe.hotmail.com/cgi-
bin/hmdata/testuser@hotmail.com/folders/ACTIVE/</D:href>
<D:propstat>
<D:prop>
<D:isfolder>1</D:isfolder>
<hm:special>inbox</hm:special>
<D:hassubs>0</D:hassubs>
<D:nosubs>1</D:nosubs>
<hm:unreadcount>0</hm:unreadcount>
<D:visiblecount>49</D:visiblecount>
<hm:special>inbox</hm:special>
</D:prop>
<D:Status>HTTP/1.1 200 OK</D:status>
</D:propstat>
</D:response>
<D:response>
<D:href>http://law7.oe.hotmail.com/cgi-
bin/hmdata/testuser@hotmail.com/folders/sAVeD/</D:href>
<D:propstat>
<D:prop>
<D:isfolder>1</D:isfolder>
<hm:special>sentitems</hm:special>
<D:hassubs>0</D:hassubs>
<D:nosubs>1</D:nosubs>
<hm:unreadcount>0</hm:unreadcount>
<D:visiblecount>2</D:visiblecount>
<hm:special>sentitems</hm:special>
</D:prop>
<D:status>HTTP/1.1 200 OK</D:status>
</D:propstat>
</D:response>
<D:response>
<D:href>http://law7.oe.hotmail.com/cgi-
bin/hmdata/testuser@hotmail.com/folders/trAsH/</D:href>
<D:propstat>
<D:prop>
<D:isfolder>1</D:isfolder>
<hm:special>deleteditems</hm:special>
<D:hassubs>0</D:hassubs>
<D:nosubs>1</D:nosubs>
<hm:unreadcount>0</hm:unreadcount>
<D:visiblecount>6</D:visiblecount>
<hm:special>deleteditems</hm:special>
</D:prop>
<D:status>HTTP/1.1 200 OK</D:status>
</D:propstat>
</D:response>
<D:response>
<D:href>http://law7.oe.hotmail.com/cgi-
bin/hmdata/testuser@hotmail.com/folders/HM_BuLkMail_/</D:href>
<D:propstat>
<D:prop>
<D:isfolder>1</D:isfolder>
<D:displayname>Junk Mail</D:displayname>
<hm:special>bulkmail</hm:special>
<D:hassubs>0</D:hassubs>
<D:nosubs>1</D:nosubs>
<hm:unreadcount>0</hm:unreadcount>
<D:visiblecount>0</D:visiblecount>
<hm:special>bulkmail</hm:special>
</D:prop>
<D:status>HTTP/1.1 200 OK</D:status>
</D:propstat>
</D:response>
</D:multistatus>
<D:hassubs>0</D:hassubs>
<D:nosubs>1</D:nosubs>
<hm:unreadcount>2</hm:unreadcount>
<D:visiblecount>2</D:visiblecount>
<hm:special>msnpromo</hm:special>
</D:prop>
<D:status>HTTP/1.1 200 OK</D:status>

Fields in the Server Response

| Field | Explanation |
|---|---|
| D:href | This is the root URL for the folder |
| D:isfolder | Is this a folder? 1 for yes, 0 for no |
| hm:special | This is the internal folder name of Standard |
| | Hotmail Folders. If a folder does not have this |
| | set, then it must be a user-created folder. |
| D:hassubs | Does this folder have sub folders? 1 for yes, 0 |
| | for no |
| hm:unreadcount | Number of unread messages in the folder |
| hm:visiblecount | Total number of messages in the folder |
| D:displayname | This is the folder display name. If a folder |
| | does not have this set, then it must be a |
| | Standard Hotmail Folder and the hm:special should |
| | be used as the display name |
| D:status | Status indicator, always HTTP/1.1 200 OK |

Standard Hotmail Folders—these cannot be renamed or deleted

| | Internal Folder | |
|---|---|---|
| Display Name | Name | Usage |
| Inbox | inbox | All incoming messages go |
| | | here |
| Bulk Mail | bulkmail | To store potential junk |
| | | mail intercepted by |
| | | Hotmail |
| MSN Announcements | msnpromo | To store Hotmail system |
| | | messages, messages in |
| | | this folder cannot be |
| | | moved, modified or |
| | | deleted |
| Sernt Items | sentitems | To store copies of sent |
| | | messages |
| Deleleted Items | deleteditems | Trash folder, |
| | | automatically emptied |
| | | every night |

Get Message Listing in a Folder

To Get Message Listing in a Folder, the client takes the “D:href” attribute from above and send a new request to the server, the example here looks at the “sentitems” folder.

PROPFIND /cgi-bin/hmdata/testuser@hotmail.com/folders/sAVeD/
HTTP/1.1
Depth:1,noroot
Content-Type: text/xml
Brief: t
Accept-CharSet: Windows-1252
Host: law7.oe.hotmail.com
Content-Length: 286
Connection: Keep-Alive
Cache-Control: no-cache
Cookie:
MSPAuth=2AAAAAAAADoK8YYizT6Y5vA5TeW7m7gT8h6NbIBec0ZGsADfx4pxY7Tw%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;
<?xml version=“1.0”?>
<D:propfind xmlns:D=“DAV:” xmlns:hm=“urn:schemas:httpmail:”
xmlns:m=“urn:schemas:mailheader:”>

<D:prop>

<D:isfolder/>
<hm:read/>
<m:hasattachment/>
<m:to/>
<m:from/>
<m:subject/>
<m:date/>
<D:getcontentlength/>

</D:prop>

</D:propfind>

The server responds with XML data that comprises attributes of ALL messages in the folder. There is no known way to retrieve the attributes of certain range of number of messages.

HTTP/1.1 207 Multi-Status
Server: Microsoft-IIS/5.0
Date: Sun, 23 Sep 2001 16:11:59 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
X-Dav-Error: 200 No error
HMServer: H: OE38.law7.internal.hotmail.com V: WIN2K 09.03.12.0005
i D: Sep 12 2001 13:39:51
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://law7.oe.hotmail.com/cgi-
bin/hmdata/testuser@hotmail.com/folders/sAVeD/
MSG1000169514.96</D:hr
ef>
<D:propstat>
<D:prop>
<hm:read>1</hm:read>
<m:to>&lt;tom@greyzone.com&gt;</m:to>
<m:from></m:from>
<m:subject>Onedayfree —The servers that embodiments of the present
invention need to take out tomorrow</m:subject>
<m:date>2001-09-11T00:51:08</m:date>
<D:getcontentlength>1050</D:getcontentlength>
</D:prop>
<D:status>HTTP/1.1 200 OK</D:status>
</D:propstat>
</D:response>
<D:response>
<D:href>http://law7.oe.hotmail.com/cgi-
bin/hmdata/testuser@hotmail.com/folders/sAVeD/
MSG1000331376.42</D:hr
ef>
<D:propstat>
<D:prop>
<hm:read>1</hm:read>
<m:to>&lt;tom@zone.com&gt;</m:to>
<m:from></m:from>
<m:subject>DI Tomorrow</m:subject>
<m:date>2001-09-12T21:48:58</m:date>
<D:getcontentlength>900</D:getcontentlength>
</D:prop>
<D:status>HTTP/1.1 200 OK</D:status>
</D:propstat>
</D:response>
</D:multistatus>

Fields in the Server Response

| Field | Explanation |
|---|---|
| D:href | This is the URL to the message, including the |
| | unique Message ID (MSGxxxxxxx.xx) |
| hm:read | Has the message been read? 1 for yes, 0 for no |
| m:to | The e-mail address of the recipient |
| m:from | The e-mail and/or name of the sender |
| m:subject | Subject of the e-mail |
| m:date | Date of the e-mail, GMT time defined in YYYY- |
| | MM-DDTHH:MM:SS format |
| D:getcontentlength | Size of the e-mail in bytes |
| D:status | Status indicator, always HTTP/1.1 200 OK |

The unique Message ID and “ID:href” are used to do manipulations on the individual e-mail message.

Retrieve an Email Message

Retrieving an e-mail message is not done with PROPFIND, instead, it is done through regular GET method using the “D:href” attribute obtained as above.

GET /cgi-
bin/hmdata/testuser@hotmail.com/folders/sAVeD/MSG1000331376.42
HTTP/1.1
Accept: message/rfc822, */*
Translate: f
Host: law7.oe.hotmail.com
Connection: Keep-Alive
Cache-Control: no-cache
Cookie:
MSPAuth=2AAAAAAAADoK8YYizT6Y5vA5TeW7m7gT8h6NbIBec0ZGsADfx4pxY7Tw%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;

The client must indicates the ability to accept e-mail message by using “Accept: message/rfc822”.

The server, in response, sends the raw RFC822 e-mail data back to the client. The client must parse the raw data and extract necessary information (attachments, pictures) from it.

HTTP/1.1 200 OK
Server: Microsoft-IIS/5.0
Date: Sun, 23 Sep 2001 16:12:02 GMT
P3P:CP=“BUS CUR CONo FIN IVDo ONL OUR PHY SAMo TELo”
Connection: close
Content-Length: 898
Expires: Mon, 01 Jan 1999 00:00:00 GMT
Pragma: no-cache
Cache-Control: no-cache
Content-Type: message/rfc822
X-Dav-Error: 200 No error
HMServer: H: OE33.law7.internal.hotmail.com V: WIN2K 09.03.12.0005
i D: Sep 12 2001 13:39:51
X-Originating-IP: [192.168.1.100]
From: “Test User ” <testuser@hotmail.com>
To: <tom@gzone.com>
Cc: <sean@zone.com>
Subject: DI Tomorrow
Date: Wed, 12 Sep 2001 14:48:58 −0700
MIME-Version: 1.0
Content-Type: text/plain;
charset=“iso-8859-1”
Content-Transfer-Encoding: 7bit
X-Priority: 3
X-MSMail-Priority: Normal
Tom, I got a call this morning from Sean that they will remove the
three servers for us tomorrow, I would like to know
when, and where should I meet him? Thanks.
Test User
Hotmail, Inc.

Sometimes the reported data length by Hotmail is different from the actual data length obtained by the client, this is due to the end of line character difference on different platforms. On Unix, it's “\n”; on Windows, it's “\r\n”; on Macintosh, it's “\r”.

Move/Delete an E-Mail Message

There is no specific command to delete an e-mail message in Hotmail e-mail system, instead, embodiments of the present invention can delete a message by moving it into the “deleteditems” (Trash) folder. This folder is emptied every night at midnight PST by Hotmail system.

In order to move a message, the client must specify The “D:href” attribute full URL obtained above of the original message, and specify The destination folder full URL, And use the MOVE method. In the following example, embodiments of the present invention are moving such message from “sentitems” folder into “deleteditems”.

MOVE /cgi-bin/hmdata/testuser@hotmail.com/folders/sAVeD/
MSG1000331376.42 HTTP/1.1
Destination: http://law7.oe.hotmail.com/cgi-
bin/hmdata/testuser@hotmail.com/folders/trAsH/ MSG1000331376.42
Allow-Rename: t
Host: law7.oe.hotmail.com
Content-Length: 0
Connection: Keep-Alive
Cache-Control: no-cache
Cookie:
MSPAuth=2AAAAAAAADizY3u3uyjx0FopTeW7m7gT8hrtcGcI4fCiIHa7FNAJ3FIg%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;

The client must indicate “Allow-Rename: t” as true.

The server responds with,

HTTP/1.1 201 Created
Server: Microsoft-IIS/5.0
Date: Sun, 23 Sep 2001 16:12:05 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/html
Location: http://law7.oe.hotmail.com/cgi-
bin/hmdata/testuser@hotmail.com/folders/trAsH/MSG1009526838.90
X-Dav-Error: 200 No error
HMServer: H: OE33.law7.internal.hotmail.com V: WIN2K 09.03.12.0005
i D: Sep 12 2001 13:39:55
The message has been moved successfully into “deleteditems” folder.

To move messages into other folders, the “Destination” directive in the MOVE request needs to be changed.

Mark an Email Message as Unread/Read

An e-mail message can be marked as read/unread using the PROPATCH method. For example, to mark the message above as Unread, the client sends MARK_AS_UNREAD schema with PROPATCH,

PROPPATCH /cgi-bin/hmdata/testuser@hotmail.com/folders/sAVeD/
MSG1000331376.42 HTTP/1.1
Content-Type: text/xml
Brief: t
Host: law7.oe.hotmail.com
Content-Length: 181
Connection: Keep-Alive
Cache-Control: no-cache
Cookie:
MSPAuth=2AAAAAAAADizY3u3uyjx0FopTeW7m7gT8hrtcGcI4fCiIHa7FNAJ3FIg%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;
<?xml version=“1.0”?>
<D:propertyupdate xmlns:D=“DAV:” xmlns:hm=“urn:schemas:httpmail:”>

<D:set>

<D:prop>

<hm:read >0</hm:read>

</D:prop>

</D:set>

</D:propertyupdate>

The server responds,

HTTP/1.1 200 OK
Server: Microsoft-IIS/5.0
Date: Sun, 23 Sep 2001 16:12:05 GMT
P3P:CP=“BUS CUR CONo FIN IVDo ONL OUR PHY SAMo TELo”
Connection: close
Content-Length: 241
Expires: Mon, 01 Jan 1999 00:00:00 GMT
Pragma: no-cache
Cache-Control: no-cache
Content-Type: text/xml
X-Dav-Error: 200 No error
HMServer: H: OE33.law7.internal.hotmail.com V: WIN2K 09.03.12.0005
i D: Sep 12 2001 13:39:55

To mark a message as Read, the client sends MARK_AS_READ schema with PROPATCH.

An e-mail message to be sent must be pre-processed to be in compliant with RFC821 standard.

POST /cgi-bin/hmdata/testuser@hotmail.com/folders/sendmsg/ HTTP/1.1
Translate: t
Content-Type: message/rfc821
SAVEINSENT: t
Host: law7.oe.hotmail.com
Content-Length: 486
Connection: Keep-Alive
Cache-Control: no-cache
Cookie:
MSPAuth=2AAAAAAAADizY3u3uyjx0FopTeW7m7gT8hrtcGcI4fCiIHa7FNAJ3FIg%24%
24;
MSPProf=2AAAAAAAACm%21dIxkDif1LURTmiCSinLaxvRfcSgYBFP1UOcTZUOr%21DK1
%21OMNqnpkwIy4oRWUOycmEFNG1%2acIqJeruM%21CdMe7BsnQYsDX7qxPAuAS1jpOoW
SF0A1WgoGBlnS734BHh7o461EhZubg0vwa9PNxXI0odL;
MAIL FROM:<testuser@hotmail.com>
RCPT TO:<testuser2@hotmail.com>
RCPT TO:<friends@hotmail.com>
From: “Test User” <testuser@hotmail.com>
To: “Test User 2” <testuser2@hotmail.com>
Cc: friends@hotmail.com
Subject: test send
Date: Wed, 20 Sep 2001 18:08:26 −0800
MIME-Version: 1.0
Content-Type: text/plain;

charset=“iso-8859-1”

Content-Transfer-Encoding: 7bit
X-Priority: 3
X-MSMail-Priority: Normal
test message begin
test message middle
test message done

Fields to Set in Send E-Mail Request

| Field | Explanation |
|---|---|
| Translate | Whether to translate character set if not |
| | compatible, should be set to “t” (true) |
| Content-Type | Constant, “Message/rfc821” |
| SAVEINSENT | Whether to save a copy in Sent Items folder or not? |
| | “t” for yes, and “f” for no |

The data portion of the request must contain the following,

One line of empty text
One line of “MAIL FROM” to indicate which account the e-mail is
coming from, this must match the From field in the e-mail message
One or more lines of “RCPT TO” to indicate the recipients, one line
per recipient. The e-mail client must process all To, Cc and Bcc
fields, and list each recipient on each line.
One line of empty text
RFC821 compliant complete e-mail with attachments/pictures properly
encoded

The server responds with,

HTTP/1.1 201 Created
Server: Microsoft-IIS/5.0
Date: Thu, 21 Sep 2001 02:04:29 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
Location: http://law7.oe.hotmail.com/cgi-
bin/hmdata/testuser@hotmail.com/folders/sAVeD/MSG1016676269.96
X-Dav-Error: 200 No error
HMServer: H: OE33.law7.internal.hotmail.com V: WIN2K 09.03.12.0005
i D: Sep 12 2001 13:39:55

The requirements for a Hotmail-compliant e-mail client include handling Cookies, the unique Hotmail Login process, WebDAV commands, Hotmail-extension of WebDAV commands, XML data schema, and RAW RFC821 e-mail data.

Other Directives in Client Requests

| Directive | Optional | Explanation | Default Value |
|---|---|---|---|
| Accept- | Y | This is used to | ISO-8859-1 |
| CharSet | | indicate the character | |
| | | set accepted by the e- | |
| | | mail client | |
| Brief | N | This is used to | T |
| | | indicate that the | |
| | | response from the | |
| | | server should be short | |
| Cache-Control | N | This is used to | no-cache |
| | | control client cache | |
| Connection | Y | This is used to | Keep-Alive |
| | | control client | |
| | | connection type | |
| Depth | N | This is used to | 0 |
| | | indicate the level of | |
| | | folders to reach | |
| Host | Y | This is used to | Default Hotmail |
| | | control client to host | e-mail server |
| | | connection | |

Detailed information on the HOTMAIL access system 1100 useful in embodiments of the present invention is disclosed in the U.S. Provisional Patent Application of the present inventor, Baohua HUANG, serial No. 60/367,249, filed Mar. 26, 2002, and titled HOTMAIL SYSTEM ACCESS METHOD. Such is incorporated herein by reference.

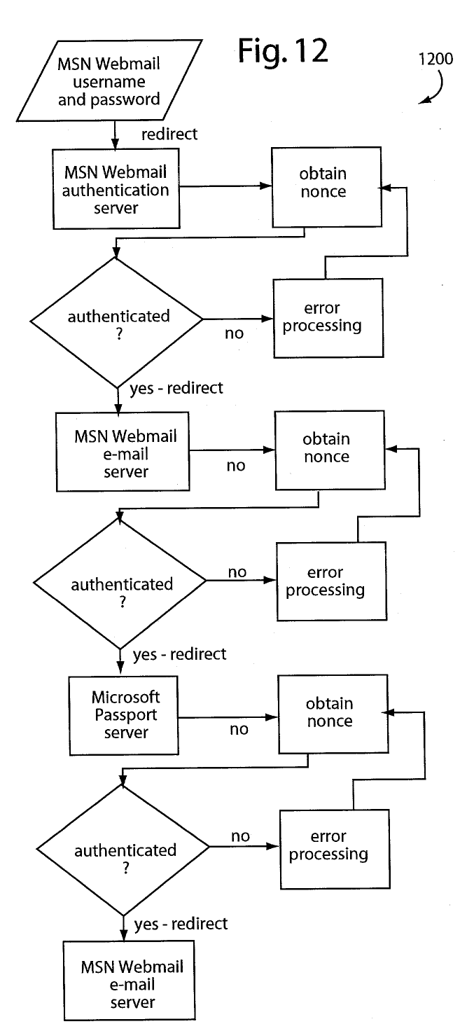

FIG. 12 represents an MSN Webmail system access method embodiment of the present invention, and is referred to herein by the general reference numeral 1200.

Embodiments of the present invention access the MSN Webmail e-mail website with something similar to the Hotmail e-mail system 1100. Such MSN website uses a unique MSN Webmail Login Process and a new industry-standard protocol called WebDAV. A first part of the MSN Webmail system access method 1200 is the MSN Webmail Login process. The second part is an MSN Webmail implementation of the WebDAV protocol.

MSN Webmail was designed for web-only access with a browser. So all transactions are required to be through http (port 80) and/or https protocols (port 443). In order to do this, MSN Webmail extended the WebDAV protocol to handle e-mail message commands like GET, POST, MOVE, PROPFIND and PROPPATCH. XML schema and data are used as the core of the WebDAV protocol. The e-mail client must be able to parse and extract necessary data from XML.

The MSN Webmail Login process depends on cookie support, it assumes that the e-mail client can handle cookies and is able to send standard WebDAV commands. Currently, only e-mail clients made by Microsoft, Microsoft Outlook (97 and newer) and Microsoft Outlook Express (5.0 and newer), can do this. No other e-mail clients appear able to handle this Login process and WebDAV component.

Traditional http and https request methods include GET, POST, PUT, etc. These methods are enough to handle regular web site transactions, but not enough to handle a user authentication process or e-mail capabilities. PROPFIND as part of the WebDAV implementation is able to handle these requirements.

The construction of the PROPFIND method is very similar to the POST method; for example, this is sample request to the server:

PROPFIND /cgi-bin/hmdata/ HTTP/1.1
Depth: 0
Content-Type: text/xml
Brief: t
Host: oe.msn.msnmail.hotmail.com
Content-Length: 357
Connection: Keep-Alive
Cache-Control: no-cache
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The data portion of the PROPFIND command is an XML schema for FIND_BASE_FOLDERS,.

Authenticate Against MSN Webmail Authentication Server

An MSN Webmail Authentication Server is used. Unlike the Hotmail e-mail system, MSN Webmail does not use a login redirector server. Instead, the client must authenticate against the MSN Webmail Authentication Server directly. Currently the URL of this server is http://oe.msn.msnmail.hotmail.com/cgi-bin/hmdata/. This is very unlikely to change, as it would require millions of MSN users to change this setting in their e-mail clients.

The client sends the authentication request to MSN Webmail Authentication Server, e.g.:

PROPFIND /cgi-bin/hmdata/ HTTP/1.1
Depth: 0
Content-Type: text/xml
Brief: t
Host: oe.msn.msnmail.hotmail.com
Content-Length: 357
Connection: Keep-Alive
Cache-Control: no-cache
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The server responds with a “401 Authorization Required” as no authentication data was sent in the previous request:

HTTP/1.1 401 Authorization Required
Server: Microsoft-IIS/5.0
Date: Fri, 22 Mar 2002 23:01:59 GMT
P3P:CP=“BUS CUR CONo FIN IVDo ONL OUR PHY SAMo TELo”
Connection: close
Content-Type: text/html
WWW-Authenticate: Digest realm=“msn.com”,
nonce=“MTAxNjgzODExOTo0NDNmOGI5OWM5NjcyOGYyMzNkZjE1MzljMmQwZTA1OQ==”
, qop=“auth”
X-Dav-Error: 401 Wrong email address..
HMServer: H: OE50.pav0.internal.hotmail.com V: WIN2K 09.04.15.0017
i D: Mar 13 2002 12:50:49

The client extracts the realm, nonce, and qop from the response, then builds a digest MD5 response and sends it back to the server to authenticate:

PROPFIND /cgi-bin/hmdata/ HTTP/1.1
Depth: 0
Content-Type: text/xml
Brief: t
Host: oe.msn.msnmail.hotmail.com
Content-Length: 357
Connection: Keep-Alive
Cache-Control: no-cache
Authorization: Digest username=“testuser@msn.com”, realm=“msn.com”,
qop=“auth”, algorithm=“MD5”, uri=“/cgi-bin/hmdata/”,
nonce=“MTAxNjgzODExOTo0NDNmOGI5OWM5NjcyOGYyMzNkZjE1MzljMmQwZTA1OQ==”
, nc=00000001, cnonce=“f5e255b6cdb38768689edb1f6ee073ef”,
response=“e7aff17913f7576734e8674b70e9310b”
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

Such example tries to authenticate a MSN Webmail user with e-mail address testuser@msn.com. The authentication scheme used is digest MD5.

Field Used in Digest MD5 Authentication

| Field | Details |
|---|---|
| Username | The full MSN Webmail e-mail address, including @ and |
| | domain name - Case insensitive |
| Realm | Constant, always msn.com |
| Qop | Constant, always auth |
| Algorithm | Constant, always MD5 - Case insensitive |
| Uri | The URI to the authentication script, without host name |
| Nonce | Nonce sent by the server to challenge the client |
| Nc | Counter, must be incremented by 1 each time a response |
| | is sent to the server |
| Cnonce | Client Nonce, generated randomly by the client to make |
| | the MD5 routine more random |
| Response | The digest MD5 response, see the following topic for |
| | details |

An important field is the “response” filed, which is calculated using the following MD5 scheme:

response=MD5 (MD5 (“username:realm:password”).
“:nonce:nc:cnonce:qop:”.
MD5(“{request_method }: {request_uri}”));
password is the user's MSN Webmail password
request_method is the request method of this request - PROPFIND,
case sensitive
MD5 stands for regular MD5 routine, which is irreversible

This is done to avoid sending the password in clear text and thus avoid any possible breach of security. The data sent after the PROPFIND header is an XML scheme requesting the basic folder structure of the MSN Webmail account.

Once the client is successfully authenticated, the server sends a 302 (Redirect) command to the client:

HTTP/1.1 302 Redirected
Server: Microsoft-IIS/5.0
Date: Fri, 22 Mar 2002 23:01:59 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/html
Location: http://oe.pav0.msnmai1.hotmail.com/cgi-
bin/hmdata/testuser@msn.com?
X-Dav-Error: 200 No error
HMServer: H: OE31.pav0.internal.hotmail.com V: WIN2K 09.04.15.0017
i D: Mar 13 2002 12:50:49

One can further detect this by checking for the X-Dav-Error as 200 No Error. If an error is found, a 401 (Authentication Required) or 503 (Service Unavailable) should be detected.

The client extracts the “Location” directive from the “302” response.

Authenticate Against MSN Webmail E-Mail Server:

Once the URL of the MSN Webmail e-mail server is obtained, such can connect and request authentication:

PROPFIND /cgi-bin/hmdata/testuser@msn.com? HTTP/1.1
Depth: 0
Content-Type: text/xml
Brief: t
Host: oe.pav0.msnmail.hotmail.com
Content-Length: 357
Connection: Keep-Alive
Cache-Control: no-cache
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The server responds with 401 Authentication Required:

HTTP/1.1 401 Authorization Required
Server: Microsoft-IIS/5.0
Date: Fri, 22 Mar 2002 23:01:59 GMT
P3P:CP=“BUS CUR CONo FIN IVDo ONL OUR PHY SANo TELo”
Connection: close
Content-Type: text/html
WWW-Authenticate: Digest realm=“hotmail.com”,
nonce=“MTAxNjgzODEyMDo0ZDE5YWRiOWM4Y2Y2YzA2ZWMwZjdkMTFkMWM1NTM5OQ==”
, qop=“auth”
X-Dav-Error: 401 No email address
HMServer: H: OE57.pav0.internal.hotmail.com V: WIN2K 09.04.15.0017
i D: Mar 13 2002 12:50:49

The client extracts the realm, nonce, and qop from the response, then builds a digest MD5 response and sends it back to the server. The algorithm is exactly the same as the MD5 routine in the MSN Webmail Authentication Server scheme:

PROPFIND /cgi-bin/hmdata/testuser@msn.com? HTTP/1.1
Depth: 0
Content-Type: text/xml
Brief: t
Host: oe.pav0.msnmail.hotmail.com
Connection: Keep-Alive
Cache-Control: no-cache
Authorization: Digest username=“testuser@msn.com”,
realm=“hotmail.com”, qop=“auth”, algorithm=“MD5”, uri=“/cgi-
bin/hmdata/testuser@msn.com”,
nonce=“MTAxNjgzODEyMDo0ZDE5YWRiOWM4Y2Y2YzA2ZWMwZjdkMTFkMWM1NTM5OQ==”
, nc=00000001, cnonce=“6c4874ce90ff92b1d17f532e568313bf”,
response=“8aa2d664c2c97467b7c7d4d33168a546”
Content-Length: 357
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

Once the client is successfully authenticated, the server sends a 302 (Redirect) command to the client:

HTTP/1.1 302 Redirected
Server: Microsoft-IIS/5.0
Date: Fri, 22 Mar 2002 23:02:00 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/html
Location:
http://login.msnia.passport.com/bin/logindigest.dll?login=testuser&d
omain=msn.com&ru=http%3a%2f%2foe%2epav0%2emsnmail%2ehotmail%2ecom%2f
cgi%2dbin%2fhmdata%2ftestuser%40msn%2ecom%3f&ct=1016838120&id=1406&k
pp=1&log=1
X-Dav-Error: 200 No error
HMServer: H: OE68.pav0.internal.hotmail.com V: WIN2K 09.04.15.0017
i D: Mar 13 2002 12:50:49

It can also be detected by checking for the X-Dav-Error as 200 No Error. If an error is found, a 401 (Authentication Required) or 503 (Service Unavailable) should be detected.

The client would then extracts the “Location” directive from the “302” response. This is used in the next step.

Authenticate Against Microsoft Passport Server

Once the URL of the Microsoft Passport server is located, connection and a request for authentication may be established:

PROPFIND
/bin/logindigest.dll?login=testuser&domain=msn.com&ru=http%3a%2fo
e%2epav0%2emsnmail%2ehotmail%2ecom%2fcgi%2dbin%2fhmdata%
2ftestuser%40msn%2ecom%3f&ct=1016838120&id=1406&kpp=1&
log=1 HTTP/1.1
Depth: 0
Content-Type: text/xml
Brief: t
Host: login.msnia.passport.com
Cookie: MSPDom=2
Connection: Keep-Alive
Cache-Control: no-cache
Content-Length: 357
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

The server responds with 401 Authentication Required:

HTTP/1.1 401 Unauthorized
Server: Microsoft-IIS/5.0
Date: Fri, 22 Mar 2002 23:01:59 GMT
Connection: close
Content-Length: 0
Content-Type: text/html
WWW-Authenticate: Digest realm=“Microsoft Passport”, qop=“auth”,
algorithm=“MD5”, nonce=“MTAxNjgzODEyMDqDEDSjD6hoIuKN9
vhJX9Yz”, opaque=“03a1475e092074b14b2586f10”

The client extracts the realm, nonce, opaque, and qop from the response. The client then builds a digest MD5 response and sends it back to the server. The algorithm is the same as the MD5 routine in the MSN Webmail Authentication Server scheme:

PROPFIND
/bin/logindigest.dll?login=testuser&domain=msn.com&ru=http%3a%
2f%2foe%2epav0%2emsnmail%2ehotmail%2ecom%2fcgi%2dbin%
2fhmdata%2ftestuser%40msn%2ecom%3f&ct=1016838120&
id=1406&kpp=1&log=1 HTTP/1.1
Depth: 0
Content-Type: text/xml
Brief: t
Host: login.msnia.passport.com
Authorization: Digest username=“testuser@msn.com”,
realm=“Microsoft Passport”, qop=“auth”, algorithm=“MD5”,
uri=“/bin/logindigest.dll”,
nonce=“MTAxNjgzODEyMDqDEDSjD6hoIuKN9vhJX9Yz”,
nc=00000001, cnonce=“1c1e5b589f5afb22ce75d82ccb5597eb”,
opaque=“03a1475e092074b14b2586f10”,
response=“0380babe2d9cc681b4ffdee0a7692677”
Connection: Keep-Alive
Cache-Control: no-cache
Content-Length: 357
Cookie: MSPDom=2
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

</D:prop>

</D:propfind>

Once the client is successfully authenticated, the server sends a 302 (Redirect) command to the client:

HTTP/1.1 302 Redirect to partner
Server: Microsoft-IIS/5.0
Date: Fri, 22 Mar 2002 23:02:00 GMT
Connection: close
Content-Length: 17
Content-Type: text/html
Location: http://oe.pav0.msnmail.hotmail.com/cgi-
bin/hmdata/testuser@msn.com?&p=1LpVOXOHPCeS76PCGosWe63i
MrKYdK!L4qoX*a9KwPnJQodMvMW6A63wXn7WRJCD5VFCVE6
kC7ZNON5K1s72WR*yJEq92oJRgnZbVO!Q2HxiN2ZlN1ByJ6rTs9
jHGTm*lp423mnAvgehkfzVrrnUGksQ$$&t=1LpVOXOHPDY*bi*k
RnEGjSPdFabHhxfOlGjlOHHzh2SSKFc!2P567ZgGLG7x307H5g9
cN2T9tm9dhwzYIQDoaf9A$$

Detection can also be made by checking for the X-Dav-Error as 200 No Error. If an error is found, a 401 (Authentication Required) or 503 (Service Unavailable) should be found.

The client extracts the “Location” directive from the “302” response and be redirected back to the MSN Webmail e-mail Server. However, the URL is special and comprises certain cookies to be used by the MSN Webmail e-mail Server.

Log Onto MSN Webmail E-Mail Server with Special URL

The special URL obtained in the previous step includes authentication information for the MSN Webmail e-mail Server. The client follows the special URL and connects to the MSN Webmail e-mail Server:

PROPFIND /cgi-
bin/hmdata/testuser@msn.com?&p=1LpVOXOHPCeS76PCGosWe63
iMrKYdK!L4qoX*a9KwPnJQodMvMW6A63wXn7WRJCD5VFCVE6
kC7ZNON5K1S72WR*yJEq92oJRgnZbVO!Q2HxiN2ZlNlByJ6rT
s9jHGTm*lp423mnAvgehkfzVrrnUGksQ$$&t=1LpVOXOHPDY*bi*k
RnEGjSPdFabHhxfOlGjl0HHzh2SSKFc!2P567ZgGLG7x307H5g9cN
2T9tm9dhwzYIQDoaf9A$$ HTTP/1.1
Depth: 0
Content-Type: text/xml
Brief: t
Host: oe.pav0.msnmail.hotmail.com
Connection: Keep-Alive
Cache-Control: no-cache
Content-Length: 357
Authorization: Digest username=“testuser@msn.com”,
realm=“hotmail.com”, qop=“auth”, algorithm=“MD5”, uri=“/cgi-
bin/hmdata/testuser@msn.com”,
nonce=“MTAxNjgzODEyMDo0ZDE5YWRiOWM4Y2Y2YzA2ZW
MwZjdkMTFkMWM1NTM5OQ==”,
nc=00000002, cnonce=“2afd303f549130521c519e71f3c66b54”,
response=“bc06a5847f6107c421499ef61586444b”
<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<h:adbar/>
<hm:contacts/>
<hm:inbox/>
<hm:outbox/>
<hm:sendmsg/>
<hm:sentitems/>
<hm:deleteditems/>
<hm:drafts/>
<hm:msgfolderroot/>
<h:maxpoll/>
<h:sig/>

<D:prop>

</D:propfind>

The MSN Webmail e-mail server processes the special URL and sends back a 207 Multi-status response which indicates a success. Included, is a set of four cookies, which will act as authentication credentials in future requests:

HTTP/1.1 207 Multi-Status
Server: Microsoft-IIS/5.0
Date: Fri, 22 Mar 2002 23:02:00 GMT
P3P:CP=“BUS CUR CONo FIN IVDo ONL OUR PHY SAMo TELo”
Connection: close
Set-Cookie:
MSPAuth=1LpVOXOHPDY%2abi%2akRnEGjSPdFabHhxfOlGj10HHzh2SSKFc%212P567Z
gGLG7x307H5g9cN2T9tm9dhwzYIQDoaf9A%24%24;
domain=msnmail.hotmail.com; path=/cgi-bin/hmdata/testuser@msn.com
Set-Cookie:
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
domain=msnmail.hotmail.com; path=/cgi-bin/hmdata/testuser@msn.com
Set-Cookie: OE_Usertestuser_msn.com=1016924521;
domain=msnmail.hotmail.com; path=/
Set-Cookie:
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24;
domain=msnmail.hotmail.com; path=/cgi-bin/hmdata/testuser@msn.com
Content-Length: 1588
Expires: Mon, 01 Jan 1999 00:00:00 GMT
Pragma: no-cache
Cache-Control: no-cache
Content-Type: text/xml
X-Timestamp: folders=1016794567, ACTIVE=1016836435
X-Dav-Error: 200 No error
HMServer: H: OE12.pav0.internal.hotmail.com V: WIN2K 09.04.15.0017
i D: Mar 13 2002 12:50:49
<?xml version=“1.0” encoding=“Windows-1252”?>
<D:multistatus xmlns:D=“DAV:” xmlns:c=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://oe.pav0.msnmail.hotmail.com/cgi-
bin/hmdata/testuser@msn.com/</D:href>
<D:wchref>http://oe.pav0.msnmail.hotmail.com/cgi-
bin/wc_maint</D:wchref>
<D:sohref>http://oe.pav0.msnmail.hotmail.com/cgi-
bin/somaintain</D:sohref>
<D:propstat>
<D:prop>
<h:adbar>Adpane=Off*AdSvr=H*Other=GetAd?PG=HOTOEB?SC=LG?TF=_BLANK?
HM=0455520e5f595358544607263205431a0a497c510e544a4d554b0029470a213d</h
:adbar>
<hm:contacts>http://oe.pav0.msnmail.hotmail.com/cgi-
bin/hmdata/testuser@msn.com/abdata/</hm: contacts>
<hm:inbox>http://oe.pav0.msnmail.hotmail.com/cgi-
bin/hmdata/testuser@msn.com/folders/ACTIVE/</hm:inbox>
<hm:sendmsg>http://oe.pav0.msnmail.hotmail.com/cgi-
bin/hmdata/testuser@msn.com/folders/sendmsg/</hm:sendmsg>
<hm:sentitems>http://oe.pav0.msnmail.hotmail.com/cgi-
bin/hmdata/testuser@msn.com/folders/sAVeD/</hm:sentitems>
<hm:deleteditems>http://oe.pav0.msnmail.hotmail.com/cgi-
bin/hmdata/testuser@msn.com/folders/trAsH/</hm:deleteditems>
<hm:msgfolderroot>http://oe.pav0.msnmail.hotmail.com/cgi-
bin/hmdata/testuser@msn.com/folders/</hm:msgfolderroot>
<h:maxpollL>30</h:maxpoll>
<h:sig>&amp;lt;br clear-all&amp;gt;&amp;lt;hr&amp;gt;Get your FREE download of MSN
Explorer at &amp;lt;a
href=&amp;apos;http://g.msn.com/1HM305401/13&amp;apos;&amp;gt;http://explorer.
msn.com&amp;lt;/a&amp;gt;.&amp;lt;br&amp;gt;
</h: Sig>
</D:prop>
<D:status>HTTP/1.1 200 OK</D:status>
</D:propstat>
</D:response>
</D:multistatus>

There should be four cookies present: MSPAuth, MSPProf, OE_Usertestuser_msn.com, and HMSC0899. Four cookies are used to store user information including encrypted user authentication information, verification data, and other user data, expiration date/time of the authentication information, and cross validation information between cookies

In order to further facilitate the login process, the cookies and the “Location” directive can be cached into a database, then used directly to start the second stage. If a 401 (Authentication Required) response is received, restart the authentication process. However, if a 2xx (Success) response is received, proceed directly to e-mail transactions. By caching the cookies, the process can increase dramatically. The usable lifetime of the cookies is approximately 24 hours.

The e-mail Transactions Through WebDAV is the second part. Pre-defined XML data schemas are used to access MSN Webmail. Such are used in conjunction with a Request URI in PROPFIND method to do e-mail transactions on the e-mail server. These schemas are the same aseehe Hotmail XML data schemas.

XML Data Schemas

FIND_BASE_FOLDERS is used with the initial connect with the Hotmail e-mail Server, and retrieve the base folders on the Hotmail e-mail system.

<?xml version=“1.0”?>
<D:propfind xmlns:D=“DAV:”
xmlns:h=“http://schemas.microsoft.com/hotmail/”
xmlns:hm=“urn:schemas:httpmail:”>

<D:prop>

<hm:contacts/>
<hm:inbox/>
<hm:outbox/>
<hm:sendmsg/>
<hm:sentitems/>
<hm:deleteditems/>
<hm:drafts/>
<hm:msgfolderroot/>

</D:prop>

</D:propfind>

FIND_SUB_FOLDERS is used to find subfolders within a certain folder, with their properties returned. The request URI must contain the folder itself.

<?xml version=“1.0”?>
<D:propfind xmlns:D=“DAV:” xmlns:hm=“urn:schemas:httpmail:”>

<D:prop>

<D:isfolder/>
<D:displayname/>
<hm:special/>
<D:hassubs/>
<D:nosubs />
<hm:unreadcount/>
<D:visiblecount/>
<hm:special/>

</D:prop>

</D:propfind>

FIND_MSGS is used to find messages within a certain folder, with their properties returned. The request URI must contain the folder itself.

<?xml version=“1.0”?>
<D:propfind xmlns:D=“DAV:” xmlns:hm=“urn:schemas:httpmail:”
xmlns:m=“urn:schemas:mailheader:”>

<D:prop>

<D:isfolder/>
<hm:read/>
<m:hasattachment/>
<m:to/>
<m:from/>
<m:subject/>
<m:date/>
<D:getcontentlength/>

</D:prop>

</D:propfind>

MARK_AS_READ is used to mark a message as read. An e-mail message is marked as read automatically if the e-mail message has been retrieved through the GET command (see next section on the GET command). The request URI must contain the message ID of the e-mail to be marked as read.

<?xml version=“1.0”?>
<D:propertyupdate xmlns:D=“DAV:” xmlns:hm=
“urn:schemas:httpmail:”>

<D:Set>

<D:prop>

<hm:read>1</hm:read>

<D:prop>

</D:set>

</D:propertyupdate>

MARK_AS_UNREAD is used to mark a message as unread. The request URI must contain the message ID of the e-mail to be marked as unread.

```
<?xml version=“1.0”?>
$PATCHMARKUNREAD.=“<D:propertyupdate xmlns:D=“DAV:”
xmlns:hm=“urn:schemas:httpmail:”>
    <D:set>
        <D:prop>
            <hm:read>0</hm:read>
        </D:prop>
    </D:set>
</D:propertyupdate>
```

Logging Onto the MSN Webmail E-Mail Server and Retrieve Base Folders

The client sends a PROPFIND request to the new MSN Webmail e-mail Server, with the correct credentials in the form of cookies.

```
PROPFIND /cgi-bin/hmdata/testuser@msn.com/folders/ HTTP/1.1
Depth: 0
Content-Type: text/xml
Brief: t
X-Timestamp: folders=, ACTIVE=
Accept-CharSet: Windows-1252
Host: oe.pav0.msnmail.hotmail.com
Content-Length: 265
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24
<?xml version=“1.0”?>
<D:propfind xmlns:D=“DAV:”
xmlns:h=“http://schemas.microsoft.com/hotmail/”
xmlns:hm=“urn:schemas:httpmail:”>
    <D:prop>
        <h:adbar/>
        <hm:contacts/>
        <hm:inbox/>
        <hm:outbox/>
        <hm:sendmsg/>
        <hm:sentitems/>
        <hm:deleteditems/>
        <hm:drafts/>
        <hm:msgfolderroot/>
        <h:maxpoll/>
        <h:sig/>
    </D:prop>
</D:propfind>
```

The corresponding XML data schema is used to find the folders resided on the MSN Webmail e-mail system.

The server authenticates the user by inspecting the cookies.

If an error is found, a 401 error (Authentication Required) will be sent to the client and the client begins the first stage to re-authenticate. If not, the server responds with the basic folder structures in the MSN Webmail account in the form of XML data. One can detect the 207 Multi-status response or the X-Dav_Error 200 No Error response.

HTTP/1.1 207 Multi-Status
Server: Microsoft-IIS/5.0
Date: Fri, 22 Mar 2002 23:02:02 GMT
P3P:CP=“BUS CUR CONo FIN IVDo ONL OUR PHY SAMo TELo”
Connection: close
Content-Length: 1588
Expires: Mon, 01 Jan 1999 00:00:00 GMT
Pragma: no-cache
Cache-Control: no-cache
Content-Type: text/xml
X-Timestamp: folders=1016794569, ACTIVE=1016836437
X-Dav-Error: 200 No error
HMServer: H: OE12.pav0.internal.hotmail.com V: WIN2K 09.04.15.0017
i D: Mar 13 2002 12:50:49
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://oe.pav0.msnmail.hotmail.com/cgi-
bin/hmdata/testuser@msn.com/</D:href>
<D:wchref>http://oe.pav0.msnmail.hotmail.com/cgi-
bin/wc_maint</D:wchref>
<D:sohref>http://oe.pav0.msnmail.hotmail.com/cgi-
bin/somaintain</D:sohref>
<D:propstat>
<D:prop>
<h:adbar>AdPane=Off*AdSvr=H*Other=GetAd?PG=HOTOEB?SC=LG?TF=_BLANK?HM
=0455520e5f595358544607263205431a0a497c510e544a4d554b0029470a213d</h:
adbar>
<hm:contacts>http://oe.pav0.msnmail.hotmail.com/cgi-
bin/hmdata/testuser@msn.com/abdata/</hm:contacts>
<hm:inbox>http://oe.pav0.msnmail.hotmail.com/cgi-
bin/hmdata/testuser@msn.com/folders/ACTIVE/</hm:inbox>
<hm:sendmsg>http://oe.pav0.msnmail.hotmail.com/cgi-
bin/hmdata/testuser@msn.com/folders/sendmsg/</hm:sendmsg>
<hm:sentitems>http://oe.pav0.msnmail.hotmail.com/cgi-
bin/hmdata/testuser@msn.com/folders/sAveD/</hm:sentitems>
<hm:deleteditems>http://oe.pav0.msnmail.hotmail.com/cgi-
bin/hmdata/testuser@msn.com/folders/trAsH/</hm:deleteditems>
<hm:msgfolderroot>http://oe.pav0.msnmail.hotmail.com/cgi-
bin/hmdata/testuser@msn.com/folders/</hm:msgfolderroot>
<h:maxpoll>30</h:maxpoll>
<h:sig>&lt;br clear=all&gt;&lt;hr&gt;Get your FREE download of MSN
Explorer at &lt;a
href=&apos;http://g.msn.com/1HM305401/13&apos;&gt;http://explorer.msn.com
&lt;/a&gt;.&lt;br&gt;
</h:sig>
</D:prop>
<D:status>HTTP/1.1 200 OK</D:status>
</D:propstat>
</D:response>
</D:multistatus>

Fields in the Server Response

| Field | Explanation |
|---|---|
| D:href | The root URL for the MSN Webmail user |
| H:adbar | URL to the data to be used in the Advertising |
| | bar in Outlook and Outlook Express - ignored |
| | by Embodiments of the present invention |
| hm:contacts | URL to the user's MSN Webmail address book |
| hm:inbox | URL to the user's MSN Webmail INBOX |
| hm:sendmsg | URL to the user's MSN Webmail Outbox - messages |
| | posted in this folder are picked up immediately |
| | by MSN Webmail system and sent automatically |
| hm:sentitems | URL to the user's MSN Webmail Sent Items folder |
| hm:deleteditems | URL to the user's MSN Webmail Deleted Items |
| | folder - One cannot delete messages completely |
| | from this folder. However, this folder is |
| | emptied automatically every night at midnight |
| | PST. |
| hm:msgfolderroot | URL to the user's root folder, which comprises |
| | all the other folders |
| hm:maxpoll | Unknown - not used by Embodiments of the present |
| | invention |
| h:sig | Signature used by MSN Webmail as a form of |
| | advertising - not used by Embodiments of the |
| | present invention |

Get Stats on All Base Folders

With the “hm:msgfolderroot” information retrieved, the client sends another request to the server:

```
PROPFIND /cgi-bin/hmdata/testuser@msn.com/folders/ HTTP/1.1
Depth: 1,noroot
Content-Type: text/xml
Brief: t
X-Timestamp: folders=,ACTIVE=
Accept-CharSet: Windows-1252
User-Agent: Outlook-Express/5.5 (MSIE 5.5; Windows 98; T312461;
TmstmpExt)
Host: oe.pav0.msnmail.hotmail.com
Content-Length: 265
Connection: Keep-Alive
Cache-Control: no-cache
Cookie:
MSPAuth=1LpVOXOHPDY%2abi%2akRnEGjSPdFabHhxfOlGjloHHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIazVEcWwEaFuG8ddf
xRthttWkiKnps51iDxim%21P073Vr5nbUuN%2aAJoVXRuN8H2u7wFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24
<?xml version=“1.0”?>
<D:propfind xmlns:D=“DAV:” xmlns:hm=“urn:schemas:httpmail:”>
    <D:prop>
        <D:isfolder/>
        <D:displayname/>
        <hm:special/>
        <D:hassubs/>
        <D:nosubs/>
        <hm:unreadcount/>
        <D:visiblecount/>
        <hm:special/>
    </D:prop>
</D:propfind>
    The FIND_SUB_FOLDERS schema is used here.
    The server authenticates the user by inspecting the cookies.
If an error is found, a 401 error (Authentication Required) will be
sent to the client and the client begins from the first stage. If
not, the server responds with the basic folder structures in the MSN
Webmail account in the form of XML data. One can detect the 207
Multi-status response or the X-Dav_Error 200 No Error response:
HTTP/1.1 207 Multi-Status
Server: Microsoft-IIS/5.0
Date: Fri, 22 Mar 2002 23:02:00 GMT
P3P:CP=“BUS CUR CONo FIN IVDo ONL OUR PHY SAMo TELo”
Connection: close
Content-Length: 2400
Expires: Mon, 01 Jan 1999 00:00:00 GMT
Pragma: no-cache
Cache-Control: no-cache
Content-Type: text/xml
X-Timestamp: folders=1016794567, ACTIVE=1016836435
X-Dav-Error: 200 No error
HMServer: H: OE72.pav0.internal.hotmail.com V: WIN2K 09.04.15.0017
i D: Mar 13 2002 12:50:49
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://oe.pav0.msnmail.hotmail.com/cgi-
bin/hmdata/testuser@msn.com/folders/msnpromo/</D:href>
<D:propstat>
<D:prop>
<D:isfolder>1</D:isfolder>
<hm:special>msnpromo</hm:special>
<D:hassubs>0</D:hassubs>
<D:nosubs>1</D:nosubs>
<hm:unreadcount>2</hm:unreadcount>
<D:visiblecount>2</D:visiblecount>
<hm:special>msnpromo</hm:special>
</D:prop>
<D:status>HTTP/1.1 200 OK</D:status>
</D:propstat>
</D:response>
<D:response>
<D:href>http://oe.pav0.msnmail.hotmail.com/cgi-
bin/hmdata/testuser@msn.com/folders/ACTIVE/</D:href>
<D:propstat>
<D:prop>
<D:isfolder>1</D:isfolder>
<hm:special>inbox</hm:special>
<D:hassubs>0</D:hassubs>
<D:nosubs>1</D:nosubs>
<hm:unreadcount>0</hm:unreadcount>
<D:visiblecount>8</D:visiblecount>
<hm:special>inbox</hm:special>
</D:prop>
<D:status>HTTP/1.1 200 OK</D:status>
</D:propstat>
</D:response>
<D:response>
<D:href>http://oe.pav0.msnmail.hotmail.com/cgi-
bin/hmdata/testuser@msn.com/folders/sAVeD/</D:href>
<D:propstat>
<D:prop>
<D:isfolder>1</D:isfolder>
<hm:special>sentitems</hm:special>
<D:hassubs>0</D:hassubs>
<D:nosubs>1</D:nosubs>
<hm:unreadcount>0</hm:unreadcount>
<D:visiblecount>35</D:visiblecount>
<hm:special>sentitems</hm:special>
</D:prop>
<D:status>HTTP/1.1 200 OK</D:status>
</D:propstat>
</D:response>
<D:response>
<D:href>http://oe.pav0.msnmail.hotmail.com/cgi-
bin/hmdata/testuser@msn.com/folders/trAsH/</D:href>
<D:propstat>
<prop>
<D:isfolder>1</D:isfolder>
<hm:special>deleteditems</hm:special>
<D:hassubs>0</D:hassubs>
<D:nosubs>1</D:nosubs>
<hm:unreadcount>13</hm:unreadcount>
<D:visiblecount>14</D:visiblecount>
<hm:special>deleteditems</hm:special>
</D:prop>
<D:status>HTTP/1.1 200 OK</D:status>
</D:propstat>
</D:response>
<D:response>
<D:href>http://oe.pav0.msnmail.hotmail.com/cgi-
bin/hmdata/testuser@msn.com/folders/HM_BuLkMail_/</D:href>
<D:propstat>
<D:prop>
<D:isfolder>1</D:isfolder>
<D:displayname>Junk Mail</D:displayname>
<hm:special>bulkmail</hm:special>
<D:hassubs>0</D:hassubs>
<D:nosubs>1</D:nosubs>
<hm:unreadcount>0</hm:unreadcount>
<D:visiblecount>0</D:visiblecount>
<hm:special>bulkmail</hm:special>
</D:prop>
<D:status>HTTP/1.1 200 OK</D:status>
</D:propstat>
</D:response>
</D:multistatus>
```

Fields in the Server Response

| Field | Explanation |
|---|---|
| D:href | The root URL for the folder |
| D:isfolder | Is this a folder? 1 for yes, 0 for no |
| hm:special | Internal folder name of Standard MSN Webmail |
| | Folders. If a folder does not have this set, |
| | then it must be a user-created folder. |
| D:hassubs | Does this folder have sub folders? 1 for yes, 0 |
| | for no |
| hm:unreadcount | Number of unread messages in the folder |
| hm:visiblecount | Total number of messages in the folder |
| D:displayname | Display name. If a folder does not have this |
| | set, then it must be a Standard MSN Webmail |
| | Folder and the hm:special should be used as the |
| | display name |
| D:status | Status indicator, always HTTP/1.1 200 OK |

Standard MSN Webmail Folders—cannot be renamed or deleted

| | Internal Folder | |
|---|---|---|
| Display Name | Name | Usage |
| Inbox | inbox | All incoming messages go |
| | | here |
| Bulk Mail | bulkmail | To store potential junk |
| | | mail intercepted by MSN |
| | | Webmail |
| MSN Announcements | msnpromo | To store MSN Webmail |
| | | system messages, |
| | | messages in this folder |
| | | cannot be moved, |
| | | modified or deleted |
| Sent Items | sentitems | To store copies of sent |
| | | messages |
| Deleted Items | deleteditems | Trash folder, |
| | | automatically emptied |
| | | every night |

Get Message Listing in a Folder

The client takes the “D:href” attribute from above and sends a new request to the server. The following is an example of a “sentitems” folder:

```
PROPFIND /cgi-bin/hmdata/testuser@msn.com/folders/sAVeD/ HTTP/1.1
Depth: 1,noroot
Content-Type: text/xml
Brief: t
Accept-CharSet: Windows-1252
Host: oe.pav0.msnmail.hotmail.com
Content-Length: 286
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qox%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24
<?xml version=“1.0”?>
<D:propfind xmlns:D=“DAV:” xmlns:hm=“urn:schemas:httpmail:”
xmlns:m=“urn:schemas:mailheader:”>
    <D:prop>
        <D:isfolder/>
        <hm:read/>
        <m:hasattachment/>
        <m:to/>
        <m:from/>
        <m:subject/>
        <m:date/>
        <D:getcontentlength/>
    </D:prop>
</D:propfind>
```

The server responds with XML data which comprises attributes of ALL messages in the folder. There is no known way to retrieve the attributes of a certain range or number of messages.

HTTP/1.1 207 Multi-Status
Server: Microsoft-IIS/5.0
Date: Fri, 22 Mar 2002 23:02:00 GMT
P3P:CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
X-Dav-Error: 200 No error
HMServer: H: OE72.pav0.internal.hotmail.com V: WIN2K 09.04.15.0017
i D: Mar 13 2002 12:50:49
<?xml version=“1.0” encoding=“Windows-1252”?>
<D:multistatus xmlns:D=“DAV:” xmlns:m=“urn:schemas:mailheader:”
xmlns:hm=“urn:schemas:httpmail:” xmlns:c=“urn:schemas:contacts:”
xmlns:h=“http://schemas.microsoft.com/hotmail/”>
<D:response>
<D:href>http://oe.pav0.msnmail.hotmail.com/cgi-
bin/hmdata/testuser@msn.com/folders/sAVeD/
MSG1000169514.96</D:href>
<D:propstat>
<D:prop>
<hm:read>1</hm:read>
<m:to>&lt;tom@msn.com&gt;</m:to>
<m:from></m:from>
<m:subject>Onedayfree - The servers that embodiments of the present
invention need to take out tomorrow</m:subject>
<m:date>2001-09-11T00:51:08</m:date>
<D:getcontentlength>1050</D:getcontentlength>
</D:prop>
<D:status>HTTP/1.1 200 OK</D:status>
</D:propstat>
</D:response>
<D:response>
<D:href>http://oe.pav0.msnmail.hotmail.com/cgi-
bin/hmdata/testuser@msn.com/folders/sAVeD/
MSG1000331376.42</D:href>
<D:propstat>
<D:prop>
<hm:read>1</hm:read>
<m:to>&lt;tom@msn.com &gt;</m:to>
<m:from></m:from>
<m:subject>DI Tomorrow</m:subject>
<m:date>2001-09-12T21:48:58</m:date>
<D:getcontentlength>900</D:getcontentlength>
</D:prop>
<D:status>HTTP/1.1 200 OK</D:status>
</D:propstat>
</D:response>
</D:multistatus>

Fields in the Server Response

| Field | Explanation |
|---|---|
| D:href | This is the URL to the message, including the |
| | unique Message ID (MSGxxxxxxx.xx) |
| hm:read | Has the message been read? 1 for yes, 0 for no |
| m:to | The e-mail address of the recipient |
| m:from | The e-mail and/or name of the sender |
| m:subject | Subject of the e-mail |
| m:date | Date of the e-mail, GMT time defined in YYYY- |
| | MM-DDTHH:MM:SS format |
| D:getcontentlength | Size of the e-mail in bytes |
| D:status | Status indicator, always HTTP/1.1 200 OK |

The unique Message ID and “D:href” are used to do manipulations on the individual e-mail message.

Retrieve an E-Mail Message

Getting an e-mail message is not done with PROPFIND. Instead, it is done through a regular GET method using the “D:href” attribute obtained.

GET /cgi-bin/hmdata/testuser@msn.com/folders/sAVeD/MSG1000331376.42
HTTP/1.1
Accept: message/rfc822, */*
Translate: f
Host: oe.pav0.msnmail.hotmail.com
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24

The client must indicate the ability to accept e-mail message by using “Accept: message/rfc822”.

The server, in response, sends the raw RFC822 e-mail data back to the client. The client must parse the raw data and extract necessary information, e.g., attachments, pictures.

HTTP/1.1 200 OK
Server: Microsoft-IIS/5.0
Date: Fri, 22 Mar 2002 23:02:00 GMT
P3P:CP=“BUS CUR CONo FIN IVDo ONL OUR PHY SAMo TELo”
Connection: close
Content-Length: 115
Expires: Mon, 01 Jan 1999 00:00:00 GMT
Pragma: no-cache
Cache-Control: no-cache
Content-Type: message/rfc822
X-Day-Error: 200 No error
HMServer: H: OE72.pav0.internal.hotmail.com V: WIN2K 09.04.15.0017
i D: Mar 13 2002 12:50:49
X-Originating-IP: [192.168.1.100]
From: “Test User” <testuser@msn.com>
To: <tom@msn.com>
Cc: <sean@msn.com>
Subject: DI Tomorrow
Date: Wed, 12 Sep 2001 14:48:58 −0700
MIME-Version: 1.0
Content-Type: text/plain;
charset=“iso-8859-1”
Content-Transfer-Encoding: 7bit
X-Priority: 3
X-MSMail-Priority: Normal
This is the body of a test message sent via the MSN Webmail system.
This is the end of the test message.

On occasion, the reported data length by MSN Webmail will be different from the actual data length obtained by the client. This is a result of the end of line character difference on different platforms. On Unix, it's “\n”; on Windows, it's “\r\n”; on Macintosh, it's “\r”.

Move/Delete an E-Mail Message

There is no specific command to delete an e-mail message in MSN Webmail e-mail system. A message may be deleted by moving it into the “deleteditems” (Trash) folder. This folder is emptied each night at midnight PST by MSN Webmail system.

In order to move a message, the client must specify the “D:href” attribute full URL obtained above of the original message, define the destination folder full URL, and use the MOVE method.

In the following example, embodiments of the present invention are moving such message from “sentitems” folder into “deleteditems”:

MOVE /cgi-bin/hmdata/testuser@msn.com/folders/sAVeD/
MSG1000331376.42 HTTP/1.1
Destination: http://oe.pav0.msnmail.hotmail.com/cgi-
bin/hmdata/testuser@msn.com/folders/trAsH/ MSG1000331376.42
Allow-Rename: t
Host: oe.pav0.msnmail.hotmail.com
Content-Length: 0
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24

The client must indicate “Allow-Rename: t” as true.

The server responds with,

HTTP/1.1 201 Created
Server: Microsoft-IIS/5.0
Date: Fri, 22 Mar 2002 23:02:10 GMT
P3P: CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/html
Location: http://oe.pav0.msnmail.hotmail.com/cgi-
bin/hmdata/testuser@msn.com/folders/trAsH/MSG1009526838.90
X-Dav-Error: 200 No error
HMServer: H: OE72.pav0.internal.hotmail.com V: WIN2K 09.04.15.0017
i D: Mar 13 2002 12:50:49

The message has been moved successfully into “deleteditems” folder.

To move messages into other folders, the “Destination” directive in the MOVE request needs to be changed.

Mark an E-Mail Message as Unread/Read

An e-mail message can be marked as read/unread using the PROPATCH method. For example, to mark the message above as Unread, the client sends MARK_AS_UNREAD schema with PROPATCH:

```
PROPPATCH /cgi-bin/hmdata/testuser@msn.com/folders/sAVeD/
MSG1000331376.42 HTTP/1.1
Content-Type: text/xml
Brief: t
Host: oe.pav0.msnmail.hotmail.com
Content-Length: 181
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24
<?xml version=“1.0”?>
<D:propertyupdate xmlns:D=“DAV:” xmlns:hm=“urn:schemas:httpmail:”>
    <D:set>
        <D:prop>
            <hm:read>0</hm:read>
        </D:prop>
    </D:set>
</D:propertyupdate>
```

The server responds,

HTTP/1.1 200 OK
Server: Microsoft-IIS/5.0
Date: Fri, 22 Mar 2002 23:02:15 GMT
P3P: CP=“BUS CUR CONo FIN IVDo ONL OUR PHY SAMo TELo”
Connection: close
Content-Length: 241
Expires: Mon, 01 Jan 1999 00:00:00 GMT
Pragma: no-cache
Cache-Control: no-cache
Content-Type: text/xml
X-Dav-Error: 200 No error
HMServer: H: OE72.pav0.internal.hotmail.com V: WIN2K 09.04.15.0017
i D: Mar 13, 2002 12:50:49

To mark the message above as Read, the client sends MARK_AS_READ schema with PROPATCH.

Send a Message

The e-mail message must be pre-processed in compliance with RFC821 standard to be sent.

POST /cgi-bin/hmdata/testuser@msn.com/folders/sendmsg/ HTTP/1.1
Translate: t
Content-Type: message/rfc821
SAVEINSENT: t
Host: oe.pav0.msnmail.hotmail.com
Content-Length: 486
Connection: Keep-Alive
Cache-Control: no-cache
Cookie:
MSPAuth=1LpVOXOHPDY%2abi%2akRnEGjSPdFabHhxfOlGjl0HHzh2SSKFc%212P567Z
gGLG7x307H5g9cN2T9tm9dhwzYIQDoaf9A%24%24;
MSPProf=1LpVOXOHPCeS76PCGosWe63iMrKYdK%21L4qoX%2aa9KwPnJQodMvMW6A63w
Xn7WRJCD5VFCVE6kC7ZNON5K1s72WR%2ayJEq92oJRgnZbVO%21Q2HxiN2ZlN1ByJ6rT
s9jHGTm%2alp423mnAvgehkfzVrrnUGksQ%24%24;
OE_Usertestuser_msn.com=1016924521;
HMSC0899=214testuser%40msn%2ecompQDGHXLyACXE0yuYqCXbLzYvYtBkjS9s7AN0
fUOxY10rnyKrfJTncvHMSQAKG63m3MdbmzJYhoAqdXYwNWRQ0MtIaZVEcWwEaFuG8ddf
xRthttWkiKnps51iDxim%21P073Vr5nbUuN%2aAJoVXRuN8H2u7WFeKCgcEmmw3idQrz
SsVKpEaHa41VjQhtxVFceCrK7azlFxdWZ9eZiCSWjuO0SpTAJElzUW4c7w%2adkL2M1Z
tuvsM%21tpgP%2apuBIMh0RMB4yEfdu6RnC%2adI5TOe6MhZbOTTseJzzj4eFUFoK28j
T1Tc%2aw%2agPJryXEAKzR7YFnEZCG8yVce3a4G1r2SiLDMB7g%24%24
MAIL FROM: <testuser@msn.com>
RCPT TO: <testuser2@msn.com>
RCPT TO: <friends@msn.com>
From: “Test User” <testuser@msn.com>
To: “Test User 2” <testuser2@msn.com>
Cc: friends@msn.com
Subject: test send
Date: Fri, 22 Mar 2002 18:08:26 −0800
MIME-Version: 1.0
Content-Type: text/plain;
charset=“iso-8859-1”
Content-Transfer-Encoding: 7bit
X-Priority: 3
X-MSMail-Priority: Normal
test message begin
test message middle
test message done

Fields to Set in Send E-Mail Request

| Field | Explanation |
|---|---|
| Translate | Whether to translate character set if not |
| | compatible, should be set to “t” (true) |
| Content-Type | Constant, “Message/rfc821” |
| SAVEINSENT | Whether to save a copy in Sent Items folder or not? |
| | “t” for yes, and “f” for no |

The data portion of the request must contain:

One line of empty text
One line of “MAIL FROM” to indicate which account the e-mail is
coming from. This must match the From field in the e-mail message.
One or more lines of “RCPT TO” to indicate the recipients, one line
per recipient. The e-mail client must process all To, Cc and Bcc
fields, and list each recipient on each line.
One line of empty text
RFC821 compliant complete e-mail with attachments/pictures properly
encoded

The server responds with:

HTTP/1.1 201 Created
Server: Microsoft-IIS/5.0
Date: Fri, 22 Mar 2002 23:08:27 GMT
P3P: CP=“BUS CUR CONo FIN IVDo ONL OUR PHY SAMo TELo”
Connection: close
Expires: Mon, 01 Jan 1999 00:00:00 GMT
Pragma: no-cache
Cache-Control: no-cache
Content-Type: text/xml
Location: http://oe.pav0.msnmail.hotmail.com/cgi-
bin/hmdata/testuser@msn.com/folders/sAVeD/MSG1016676269.96
X-Dav-Error: 200 No error
HMServer: H: 0E72.pav0.internal.hotmail.com V: WIN2K 09.04.15.0017
i D: Mar 13 2002 12:50:49

In summary, an MSN Webmail-compliant e-mail client handles Cookies, the unique MSN Webmail Login process, WebDAV commands, MSN Webmail-extension of WebDAV commands, XML data schema, and RAW RFC821 e-mail data

Detailed information on the MSN Webmail system access method 1200 useful in embodiments of the present invention is disclosed in the U.S. Provisional Patent Application of the present inventor, Baohua HUANG, serial No. 60/371,247, filed Apr. 10, 2002, and titled MSN WEBMAIL SYSTEM ACCESS METHOD. Such is incorporated herein by reference.

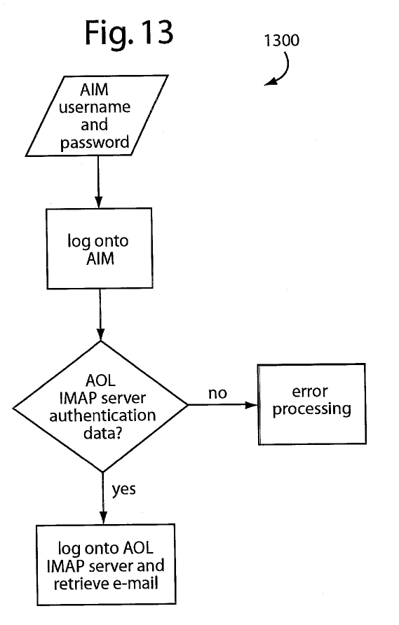

FIG. 13 represents an America On-Line (AOL) system access method embodiment of the present invention, and is referred to herein by the general reference numeral 1300. The AOL e-mail system access method 1300 includes the use of two discrete protocols, (part 1) AOL Instant Messenger (AIM), and (part 2) IMAP.

Since AOL was the one who introduced the AIM protocol, all terms used herein are based on AOL's own terminology, as in the following Table.

AOL Instant Messanger Terminology
(From http://www.aim.aol.com/javadev/terminology.html)

| | |
|---|---|
| BOS | Basic OSCAR Service. This term refers to the services |
| | that form the core of the Instant Messenger service. |
| | These services include Login/Logoff, Locate, Instant |
| | Message, and Buddy List. |
| Buddy | The buddy list tool allows a user to see in near |
| List | realtime when his friends (buddies) are using the |
| | Instant Messenger service. A user may set a |
| | preference to block others from seeing him when they |
| | is on. The user may also set a permit or deny list to |
| | selectively show his presence. See: Symmetric Blocking |
| FLAP | FLAP is a low-level communications protocol that |
| | facilitates the development of higher-level, record- |
| | oriented, communications layers. It is used on the |
| | TCP connection between all clients and servers. |
| JAR | A common format for distributing Java ARchives. All |
| | recent JDK distributions come with a utility called |
| | “jar”, that allows one to create a JAR file. All |
| | tools and uipacks will be distributed in JAR files. |
| ICBM | ICBM—Inter Client Basic Message. ICBM is a |
| | channelized client-to-client mechanism. Currently the |
| | most user visible channel is used for Instant |
| | Messages. |
| Instant | The instant message tool allows a user to send a short |
| Message | message to another Instant Messenger nickname that is |
| (IM) | delivered directly to the users screen in near |
| | realtime. This is unlike e-mail which may contain |
| | larger amounts of data and may be delivered at a later |
| | time. The receiver may easily respond with an instant |
| | message back to the sender creating a semi-realtime |
| | conversation. |
| Locate | The locate tool allows a user to determine some |
| | information about another Instant Messenger nickname. |
| | The information revealed depends on the privacy |
| | settings of the remote user. It may be as complete or |
| | as sparse as they desire. If the remote user is not |
| | logged into Instant Messenger, no information will be |
| | provided. Instant Messenger will NOT display AOL |
| | profiles and currently there are no plans to add this |
| | ability. |
| Login/Log | The Login/Logoff tool is an internal service of the |
| off | Instant Messenger client. The tool is responsible for |
| | keeping the client connected to the Instant Messenger |
| | servers. This includes the initial login, any |
| | migrations that occur during a users session, and the |
| | final logoff. |
| Migration | The process of moving a user automatically from one |
| | server to another. A migration may happen at anytime |
| | during a users session, and is completely transparent. |
| | Although the client may appear sluggish, no data will |
| | be lost during the migration. |
| Module | The basic building block of the Instant Messenger |
| | software, they provide the services of Instant |
| | Messenger. New modules are added just by downloading |
| | a new JAR file and placing it in your modules |
| | directory. One can change the look and feel of a |
| | module (but not the functionality) by creating a new |
| | UIPack for the Module. |
| OSCAR | Open System for Communication in Realtime - the |
| | internal project name (as opposed to the external |
| | marketing name) used to identify Instant Messenger. |
| Proxy | A proxy connectors purpose is to provided the Java |
| Connector | Instant Messenger client with a TCP/IP connection to |
| | the Instant Messenger service using a proxy server. |
| | Depending on the proxy server it should negotiate |
| | with, this may be a complex process. It is possible |
| | for third-parties to add support for any proxy, by |
| | writing their own proxy connector. |
| SNAC | A SNAC is the basic communication unit that is |
| | exchanged between clients and servers. The SNAC |
| | communication layers sits on top of the FLAP layer. |
| Symmetric | Blocking members is symmetric. When one block a |
| Blocking | member, that member can not see one online nor |
| | communicate with one. Likewise, one will not be able |
| | to see the blocked member online nor communicate with |
| | the member one have blocked. |
| Tool | Tools supply the underlying support for talking |
| | between Modules and the core software. There will be |
| | one tool for each of the services that the Instant |
| | Messenger offers. Each tool can support many |
| | modules. Current tools are: Admin, Buddy List, IM, |
| | Info, and Login. Future tools may include: File |
| | Transfer and Chat. |
| TLV | TLV - Type Length Value. A tuple allowing typed |
| | opaque information to be passed through the protocol. |
| | Typically TLV's are intended for interpretation at the |
| | core layer. Being typed, new elements can be added |
| | w/o modifying the lower layers. |
| UIPack | A collection of files that will change the look and |
| | feel of a Tool or Module. This collection of files |
| | can contain: images, sounds, layout information, and |
| | string. Usually UIPacks are distributed in a single |
| | jar files, but can also be split into individual |
| | files. |
| Warnings | A warning is a form of electronic vilification. It |
| | allows a user who has been affected by the online |
| | behavior of another user to express an opinion about |
| | that behavior. |

AOL Warnings
(From http://www.aim.aol.com/faq/warnfaq.html)

| | |
|---|---|
| What is a | Warnings are a feedback mechanism. It's simple - |
| warning? | nobody knows better than you do what's out of bounds. |
| | AOL Instant Messenger gives you the tools to set your |
| | own standards. |
| | A warning is a form of electronic vilification. It |
| | allows a user who has been affected by the online |
| | behavior of another user to express an opinion about |
| | that behavior. |
| | Warnings are a way of saying “I didn't like what you |
| | just did.” |
| What | Warning another user increases that user's warning |
| happens | level, which can range from 0% to 100%. The new |
| when | warning level is recorded in the AOL Instant Messenger |
| someone | server system. Even if warned users sign off of AOL |
| gets | Instant Messenger, and then sign back on, the warning |
| warned? | level stays with them. |
| | Warning someone has two effects, which are both very |
| | important. |
| | First, warning levels are public information. |
| | Everyone's warning level is visible to everyone else. |
| | This means that when a warned user interacts with |
| | another user, his or her warning level is visible. |
| | It's a good indication of how well a user behaves |
| | online. |
| | Second, as a user's warning level increases, the AOL |
| | Instant Messenger server system will limit his or her |
| | activities. This means that a warned user may not be |
| | able to send Instant Messages for a period of time. |
| | If a user has a high warning level, they or she may be |
| | disconnected from AOL Instant Messenger. In extreme |
| | cases, the user may not be allowed to sign back on to |
| | AOL Instant Messenger for a “cooling off”period. |
| What does | When you press the warn button, you bring up a dialog |
| the “Warn” | box which asks you to confirm the warning. At that |
| button do ? | time, you can also choose to send an anonymous |
| | warning. |
| | Anonymous warnings are not as effective as non- |
| | anonymous warnings. In other words, if you're willing |
| | to put your name behind a warning, it counts for more. |
| When can I | Currently, you can warn another user when they or she |
| warn | sends you an Instant Message. |
| someone? | |
| | This rule is derived from the general principle that |
| | you can only warn someone when they or she has |
| | affected you in some way. This is only fair; you |
| | can't get a speeding ticket when you aren't driving a |
| | car. :-) |
| | The rules that determine when a warning can be issued |
| | are likely to change as the should of our users |
| | change. In refining the rules, AOL Instant Messenger |
| | will give you the most appropriate tools to create an |
| | online environment in which you are comfortable. |
| Are | Generally not. A warning level of 100% will slowly |
| Warnings | diminish back to 0% over the course of about two days. |
| permanent | |
| | However, in the future, users who have consistently |
| | high warning levels may find that their warnings |
| | persist longer. It is also possible for users who |
| | repeatedly misbehave online, earning extremely high |
| | warning levels, to have some percentage of their |
| | warning level become permanent. |
| What's the | Warning a user says “I didn't like what you just did.” |
| difference | |
| between | |
| warn and | |
| block | |
| | On the other hand, a user who you have blocked can |
| | never see you on his or her Buddy List or send you an |
| | Instant Message. In fairness, you will never be able |
| | to see that user on your Buddy List or send the user |
| | an Instant Message. |
| | Blocking a user is more drastic than giving a warning. |
| | In practice, you may find that warnings can be used to |
| | persuade miscreant users to behave appropriately, |
| | while blocking might be reserved for those whose |
| | behavior does not improve. |
| Can | No. Since a warning is the expression of your opinion |
| warnings | about another user's online behavior, there is no |
| be | appeal. |
| appealed | |

FLAP is the basic structure of the AIM commands, and it is sent between the AIM server and AIM client. FLAP is a low-level communications protocol that facilitates the development of higher-level, record-oriented, communications layers. It is used on the TCP connection between all clients and servers.

FLAP Structure
Command Start (byte: 0x2a)
Channel ID (byte)
Sequence Number (word)
Data Field Length (word)
Data Field
Usually SNAC Data (variable)

FLAP always starts with byte “0'2a,” followed by a channel ID, the sequence number, data field length and the real data.

Channel ID—Channels are the method used to multiplex separate paths of communication across the same TCP socket. These are analogous to TCP/UDP port numbers. Five channels are currently used by AIM.

0x01 - New Connection Negotiation
0x02 - SNAC data (non connection-oriented data)
0x03 - FLAP-level Error
0x04 - Close Connection Negotiation
0x05 - Outside Requests are used in the AOL e-mail access.

A Sequence Number is used to verify the validity of the client/server. The sequence number on the client and server has no relationship. However, each time the client/server sends a FLAP to the other side, it increments the sequence number by 1. If the sequence number is not incremented accordingly, the client/server will be deemed untrustworthy and disconnected. The starting sequence number can be picked randomly, however, it must maintain the “increment by 1” integrity during the session.

FLAP does not have an “EOF” or end of packet indicator, thus the length of the data field must be specified BEFORE the actual data field. The data field itself is usually SNAC data. A SNAC is the basic communication unit that is exchanged between clients and servers. The SNAC communication layers sits on top of the FLAP layer. The SNAC comprises the actual data, for example, username, password, cookie, server name, etc.

After a new connection (socket) is set up using channel 0×01, data should only be carried on channel 0×02, until a low-level FLAP error occurs (channel 0×03) or there is planned termination, which gets “negotiated” (on channel 0×04). Most live events processed during the lifespan of the client are done over channel 0×02. SNACs are never transmitted on any channel other than 0×02. Data sent across other channels are not considered complete SNACs. There can be only one SNAC per FLAP command.

SNACs are generalized into the following format,

| Position | Size | Purpose |
|---|---|---|
| 1 | word | Family ID |
| 3 | word | SubType ID |
| 5 | byte | Flags[0] |
| 6 | byte | Flags[1] |
| 7 | dword | Request ID |
| 11 | variable | SNAC Data |

There is no formal declaration of the length of the SNAC data portion. Such information must be assumed from the FLAP headers.

Families, identified by the “Family ID”, constitute a group of services. These are usually quite large groups. Subtypes are a subdivision of the Families. Each subtype ID is different depending on the specific service or information provided in the data section. Flags are completely optional. They're very rarely used, if at all.

Request IDs are 32-bit values used to identify non-atomic information. The client can generate completely random request IDs as long as it remembers what the request was for. Often, though, the results of the SNAC are irrelevant, and the request IDs can be forgotten. But, in information-requisition SNACs, it is imperative one remember the request ID one sent because that's the only way to link it to the response! If this is not done, it will be impossible to have more than one pending request of the same SNAC subtype (which is unlikely at best). For server-initiated SNACs, the request ID is with the fixed value −2147483648, and count up to zero.

TLVs are a very convenient and efficient method of putting data into an organized format, especially variable length strings, etc. TLV literally stands for “Type, Length, Value”. And that's exactly what it is: a 16 bit Type code, a 16 bit value for the length of the Value field, and then the actual data in the Value field (variable length).

TLVs can be in SNACs, but that's not required. TLVs often are used directly in the FLAP Data Field, but normally are inside of SNACs. No more than one TLV of each Type code may exist in a single FLAP command (SNAC or not). TLVs must follow the strict triple-rule above, or they're really not TLVs, they're raw data.

TLVs are a big win. They make sending a variable length string like, e.g., “anything@iname” as simple as defining a TLV with values {0×0011, 0×000c, “anything@iname.com”}. (The type 0×0011 is used throughout the authorization process as the “email address type”.) A side note about strings: strings in AIM protocol are never NULL-terminated. If they look like they are, that's probably a word-length value behind it.

Before connections are made to any of the BOS or special-purpose servers, e.g., an e-mail server, one must first be authorized by the Authorization Server (login.oscar.aol.com). This will return a cookie that automatically authorizes one to connect to any of the BOS or special-purpose (e.g., Advertisement, Chat, etc) servers.

The usual steps taken to create an average AIM session are:

Connect to Authorization Server and retrieve Cookie.
Connect to the Authorizer-recommended BOS server and initiate BOS
service
(Optional) Connect to Advertisements server and retrieve first block
of ads (repeat at regular interval)
(Optional) Connect to any other non-BOS services that may be
available (AFAIK, none at this point)

The last three steps may actually be done in any order (and for the third and fourth step, probably not at all). But, authorization must always come first.

The normal steps taken to create an e-mail-only AIM session are:

Connect to Authorization Server and retrieve Cookie.
Connect to the Authorizer-recommended BOS server and initiate BOS
Services
Request redirect service to e-mail server

In order to connect to Authorization Server and retrieve cookie for BOS, the first step of the process is connecting to the Authorization Server. This is currently at DNS address, login.oscar.aol.com, a server farm. It also appears that one may connect to any port and get the same response, although Port 5190 is the official port.

Right after the client connection, the server sends a “New Connection Negotiation” handshake to the client:

| Raw Data | Explanation |
|---|---|
| 2a | Command Start |
| 01 | Channel ID: 0x01 |
| 6f d8 | Sequence Number: 28632 |
| 00 04 | Data Field Length: 4 |
| 00 00 00 | Raw data, indicates “Connection Acknowledge.” |
| 01 | |

The client sends a “Connection Acknowledge” to the server, no reply is expected from the server.

| Raw Data | Explanation |
|---|---|
| 2a | Command Start |
| 01 | Channel ID: 0x01 |
| 2d a2 | Sequence Number: 11682 |
| 00 04 | Data Field Length: 4 |
| 00 00 00 | Raw data, indicates “Connection Acknowledge.” |
| 01 | |

The client then sends “e-mail Sign-on Request”, includes username only, to the server,

| Raw Data | Explanation |
|---|---|
| 2a | Command Start |
| 02 | Channel ID: 0x02 |
| 2d a3 | Sequence Number: 11683 |
| 00 20 | Data Field Length: 32 |
| 00 17 | SNAC Family ID 0x17 |
| 00 06 | SNAC Sub Type ID 0x06 |
| 00 | Flag [0]: None |
| 00 | Flag [1]: None |
| 00 00 00 | Request ID: None |
| 00 | |
| 00 01 00 | TLV: username |
| 0e | |
| XX XX XX | |
| XX [symbol] | |
| 00 4b 00 | Raw data, indicates “Connection Acknowledge.” |
| 00 | |

The server processes the request, if the username does not exist, server will return a FLAP Ox04, which indicates the username does not exist; if the username exists, server sends a challenge phrase,

| Raw Data | Explanation |
|---|---|
| 2a | Command Start |
| 02 | Channel ID: 0x02 |
| 6f d9 | Sequence Number: 28633 |
| 00 17 | Data Field Length: 28 |
| 00 17 | SNAC Family ID 0x17 |
| 00 07 | SNAC Sub Type ID 0x07 |
| 00 | Flag [0]: None |
| 00 | Flag [1]: None |
| 00 00 00 | Request ID: None |
| 00 | |
| 00 00 00 | TLV: Challenge from server - it must be a 9 to 10 |
| 0a | digit random number - this is used to encrypt the |
| XX XX XX | password in the next step |
| XX [symbol] | |
| 00 02 00 | Raw data, indicates “Connection Acknowledge.” |
| 00 | |

Then the client must send a response including the encrypted password to the server,

| Raw Data | Explanation |
|---|---|
| 2a | Command Start |
| 02 | Channel ID: 0x02 |
| 2d a4 | Sequence Number: 11684 |
| 00 a2 | Data Field Length: 162 |
| 00 17 | SNAC Family ID 0x17 |
| 00 02 | SNAC Sub Type ID 0x02 |
| 00 | Flag [0]: None |
| 00 | Flag [1]: None |
| 00 00 00 | Request ID: None |
| 00 | |
| 00 01 00 | TLV: Username |
| 0e | |
| XX XX XX | |
| XX XX [symbol] | |
| 00 25 00 | TLV: Encrypted password derived from user's password |
| 10 XX XX | and the challenge received from the server in the |
| XX XX [symbol] | previous step |
| 00 03 00 | TLV: Client Profile |
| 3C XX XX | |
| XX XX [symbol] | |
| 00 16 00 | TLV: Client Type |
| 02 01 0d | |
| 00 17 00 | TLV: Client Version Major |
| 02 00 05 | |
| 00 18 00 | TLV: Client Version Minor |
| 02 00 00 | |
| 00 19 00 | TLV: Client Major Build |
| 02 00 01 | |
| 00 1a 00 | TLV: Client Version Build |
| 02 00 01 | |
| 00 14 00 | TLV: Unknown FixValue |
| 04 00 00 | |
| 00 58 | |
| 00 0f 00 | TLV: Language code |
| 02 65 6e | |
| 00 0e 00 | TLV: Country code |
| 02 75 73 | |

The server process the request, if the password is wrong, server will return a FLAP 0×04, which indicates the password is wrong; if the password is correct, server sends a “Authorization Response”,

| Raw Data | Explanation |
|---|---|
| 2a | Command Start |
| 02 | Channel ID: 0x02 |
| 6f da | Sequence Number: 28634 |
| 01 36 | Data Field Length: 310 |
| 00 17 | SNAC Family ID 0x17 |
| 00 03 | SNAC Sub Type ID 0x03 |
| 00 | Flag [0]: None |
| 00 | Flag [1]: None |
| 00 00 00 | Request ID: None |
| 00 | |
| 00 01 00 | TLV: username |
| 0e | |
| XX XX XX | |
| XX [symbol] | |
| 00 05 00 | TLV: BOS Server IP and Port - separated by “:” |
| 12 XX XX | |
| XX XX [symbol] | |
| 00 06 01 | TLV: Authorization Cookie for BOS Server - always 256 |
| 00 XX XX | bytes long |
| XX.. | |

Immediately after sending the BOS server IP and port and authorization cookie, the server will send the disconnect request,

| Raw Data | Explanation |
|---|---|
| 2a | Command Start |
| 04 | Channel ID: 0x04 |
| 6f db | Sequence Number: 28635 |
| 00 00 | Raw Data: indicates “Connection Disconnect” |

And the client will reply with disconnect request, and the connection will be terminated.

| Raw Data | Explanation |
|---|---|
| 2a | Command Start |
| 04 | Channel ID: 0x04 |
| 2d a5 | Sequence Number: 11685 |
| 00 00 | Raw Data: indicates “Connection Disconnect” |

Possible Authorization Errors

| Container | Data | TLV Type |
|---|---|---|
| RAW | FLAP Header (channel | |
| | 0x04) | |
| TLV | Screen Name | 0x0001 |
| TLV | Error Message URL | 0x0004 |
| TLV | Error Code | 0x0008 |

Currently Known Error Codes for TLV Type 0×008:

| Error Code | Error Msg URL | Meaning |
|---|---|---|
| 0x0001 | http://www.aim.aol.com/errors/UN | Invalid username |
| | REGISTERED_SCREENNAME.html | |
| 0x0005 | http://www.aim.aol.com/errors/MI | Invalid password |
| | SMATCH_PASSWD.html | |

The next step is to connect to and initiate service with the BOS. The address of the BOS one should connect to should be listed in the Authorization Response from the previous step. The first step for this connection is to send the BOS Sign on command to the server. But, for the purposes of dispatching, it may be best to wait to send this command until the Connection Acknowledge command is received from the server immediately after the connection opens, although this is optional and can be processed afterwards.

The first step of the process is connecting to the BOS Server IP address on the specified port (ranges from 5190 to 5199). Right after the client connection, the server sends a “New Connection Negotiation” handshake to the client,

| Raw Data | Explanation |
|---|---|
| 2a | Command Start |
| 01 | Channel ID: 0x01 |
| 8f 75 | Sequence Number: 36725 |
| 00 04 | Data Field Length: 4 |
| 00 00 00 | Raw data, indicates “Connection Acknowledge.” |
| 01 | |

The client sends a “New Connection Request” to the server,

| Raw Data | Explanation |
|---|---|
| 2a | Command Start |
| 01 | Channel ID: 0x01 |
| 22 f0 | Sequence Number: 8944 |
| 01 08 | Data Field Length: 264 |
| 00 06 01 | TLV: Authorization Cookie (length 256) obtained from |
| 00 XX XX | previous steps |
| XX XX | |

Server responds with “Server is ready for normal operations.”

| Raw Data | Explanation |
|---|---|
| 2a | Command Start |
| 02 | Channel ID: 0x02 |
| 8f 76 | Sequence Number: 36726 |
| 00 22 | Data Field Length: 34 |
| 00 01 | SNAC Family ID 0x01 |
| 00 03 | SNAC Sub Type ID 0x03 |
| 00 | Flag [0]: None |
| 00 | Flag [1]: None |
| A8 47 2c | Request ID |
| d5 | |
| 00 01 00 | Raw Data: Unknown Fixed data |
| 02 00 03 | |
| 00 04 00 | |
| 06 00 08 | |
| 00 09 00 | |
| 0a 00 0b | |
| 00 0c 00 | |
| 13 00 15 | |

Client sends “e-mail request”,

| Raw Data | Explanation |
|---|---|
| 2a | Command Start |
| 02 | Channel ID: 0x02 |
| 22 fl | Sequence Number: 8945 |
| 00 2a | Data Field Length: 42 |
| 00 01 | SNAC Family ID 0x01 |
| 00 17 | SNAC Sub Type ID 0x17 |
| 00 | Flag [0]: None |
| 00 | Flag [1]: None |
| 00 00 00 | Request ID: Same as SNAC Sub Type ID |
| 17 | |
| 00 01 00 | Raw Data: Unknown Fixed data |
| 03 00 02 | |
| 00 01 00 | |
| 03 00 01 | |
| 00 04 00 | |
| 01 00 06 | |
| 00 01 00 | |
| 09 00 01 | |
| 00 0a 00 | |
| 01 00 0b | |
| 00 01 | |

Server responds with “e-mail request granted”,

| Raw Data | Explanation |
|---|---|
| 2a | Command Start |
| 02 | Channel ID: 0x02 |
| 8f 77 | Sequence Number: 36727 |
| 00 3a | Data Field Length: 58 |
| 00 01 | SNAC Family ID 0x01 |
| 00 18 | SNAC Sub Type ID 0x18 |
| 00 | Flag [0]: None |
| 00 | Flag [1]: None |
| a8 47 2c | Request ID |
| e2 | |
| 00 01 00 | Raw Data: Unknown Fixed data |
| 03 00 02 | |
| 00 01 00 | |
| 03 00 01 | |
| 00 04 00 | |
| 01 00 06 | |
| 00 01 00 | |
| 08 00 01 | |
| 00 09 00 | |
| 01 00 0a | |
| 00 01 00 | |
| 0b 00 01 | |
| 00 0c 00 | |
| 01 00 13 | |
| 00 02 00 | |
| 15 00 01 | |

Client sends “Rate information request,” although the data through this request is useless for our purpose, this step has to be performed for proper function.

| Raw Data | Explanation |
|---|---|
| 2a | Command Start |
| 02 | Channel ID: 0x02 |
| 22 f2 | Sequence Number: 8946 |
| 00 0a | Data Field Length: 10 |
| 00 01 | SNAC Family ID 0x01 |
| 00 06 | SNAC Sub Type ID 0x06 |
| 00 | Flag [0]: None |
| 00 | Flag [1]: None |
| 00 00 00 | Request ID: None |
| 00 | |

Server sends “Rate information response,”

| Raw Data | Explanation |
|---|---|
| 2a | Command Start |
| 02 | Channel ID: 0x02 |
| 8f 78 | Sequence Number: 36728 |
| 07 03 | Data Field Length: 1795 |
| 00 01 | SNAC Family ID 0x01 |
| 00 07 | SNAC Sub Type ID 0x07 |
| 00 | Flag [0]: None |
| 00 | Flag [1]: None |
| 00 00 00 | Request ID: Same as Same as SNAC Sub Type ID in |
| 06 | Original Request in Step 7 |
| XX XX XX | Raw Data: possibly SNAC information of the user |
| XX [symbol] | |

Client sends “Rate information response acknowledgement,” no reply is expected from the server.

| Raw Data | Explanation |
|---|---|
| 2a | Command Start |
| 02 | Channel ID: 0x02 |
| 22 f3 | Sequence Number: 8947 |
| 00 14 | Data Field Length: 20 |
| 00 01 | SNAC Family ID 0x01 |
| 00 08 | SNAC Sub Type ID 0x08 |
| 00 | Flag [0]: None |
| 00 | Flag [1]: None |
| 00 00 00 | Request ID: Same as Same as SNAC Sub Type ID |
| 08 | |
| 00 01 00 | Raw Data: Unknown Fixed Data |
| 02 00 03 | |
| 00 04 00 | |
| 05 | |

Client sends a series of “Set default values requests,” these used to set various default values in the AIM system (exact ails unknown).

Request 1

| Raw Data | Explanation |
|---|---|
| 2a | Command Start |
| 02 | Channel ID: 0x02 |
| 22 f4 | Sequence Number: 8948 |
| 00 0a | Data Field Length: 10 |
| 00 01 | SNAC Family ID 0x01 |
| 00 0e | SNAC Sub Type ID 0x0e |
| 00 | Flag [0]: None |
| 00 | Flag [1]: None |
| 00 00 00 | Request ID: Same as Same as SNAC Sub Type ID |
| 0e | |

Request 2

| Raw Data | Explanation |
|---|---|
| 2a | Command Start |
| 02 | Channel ID: 0x02 |
| 22 f5 | Sequence Number: 8949 |
| 00 0a | Data Field Length: 10 |
| 00 02 | SNAC Family ID 0x02 |
| 00 02 | SNAC Sub Type ID 0x02 |
| 00 | Flag [0]: None |
| 00 | Flag [1]: None |
| 00 00 00 | Request ID: Same as Same as SNAC Sub Type ID |
| 02 | |

Request 3

| Raw Data | Explanation |
|---|---|
| 2a | Command Start |
| 02 | Channel ID: 0x02 |
| 22 f6 | Sequence Number: 8950 |
| 00 0a | Data Field Length: 10 |
| 00 03 | SNAC Family ID 0x03 |
| 00 02 | SNAC Sub Type ID 0x02 |
| 00 | Flag [0]: None |
| 00 | Flag [1]: None |
| 00 00 00 | Request ID: Same as Same as SNAC Sub Type ID |
| 02 | |

Request 4

| Raw Data | Explanation |
|---|---|
| 2a | Command Start |
| 02 | Channel ID: 0x02 |
| 22 f7 | Sequence Number: 8951 |
| 00 0a | Data Field Length: 10 |
| 00 04 | SNAC Family ID 0x04 |
| 00 04 | SNAC Sub Type ID 0x04 |
| 00 | Flag [0]: None |
| 00 | Flag [1]: None |
| 00 00 00 | Request ID: Same as Same as SNAC Sub Type ID |
| 04 | |

Request 5

| Raw Data | Explanation |
|---|---|
| 2a | Command Start |
| 02 | Channel ID: 0x02 |
| 22 f8 | Sequence Number: 8952 |
| 00 0a | Data Field Length: 10 |
| 00 09 | SNAC Family ID 0x09 |
| 00 02 | SNAC Sub Type ID 0x02 |
| 00 | Flag [0]: None |
| 00 | Flag [1]: None |
| 00 00 00 | Request ID: Same as Same as SNAC Sub Type ID |
| 02 | |

Server responds with five corresponding “Default values set responses,”

Response 1

| Raw Data | Explanation |
|---|---|
| 2a | Command Start |
| 02 | Channel ID: 0x02 |
| 8f 79 | Sequence Number: 36729 |
| 00 41 | Data Field Length: 65 |
| 00 01 | SNAC Family ID 0x01 |
| 00 0f | SNAC Sub Type ID 0x0f |
| 00 | Flag [0]: None |
| 00 | Flag [1]: None |
| 00 00 00 | Request ID: Same as Same as SNAC Sub Type ID in |
| 0e | Original Request |
| XX XX XX | Raw Data: Unknown Fixed Data - seems to be response to |
| XX [symbol] | Request 1 in Step 10. |

Response 2

| Raw Data | Explanation |
|---|---|
| 2a | Command Start |
| 02 | Channel ID: 0x02 |
| 8f 7a | Sequence Number: 36730 |
| 00 1c | Data Field Length: 28 |
| 00 02 | SNAC Family ID 0x02 |
| 00 03 | SNAC Sub Type ID 0x03 |
| 00 | Flag [0]: None |
| 00 | Flag [1]: None |
| 00 00 00 | Request ID: Same as Same as SNAC Sub Type ID in |
| 02 | Original Request |
| XX XX XX | Raw Data: Unknown Fixed Data - seems to be response to |
| XX [symbol] | Request 2 in Step 10. |

Response 3

| Raw Data | Explanation |
|---|---|
| 2a | Command Start |
| 02 | Channel ID: 0x02 |
| 8f 7b | Sequence Number: 36731 |
| 00 16 | Data Field Length: 22 |
| 00 03 | SNAC Family ID 0x03 |
| 00 03 | SNAC Sub Type ID 0x03 |
| 00 | Flag [0]: None |
| 00 | Flag [1]: None |
| 00 00 00 | Request ID: Same as Same as SNAC Sub Type ID in |
| 02 | Original Request |
| XX XX XX | Raw Data: Unknown Fixed Data - seems to be response to |
| XX [symbol] | Request 3 in Step 10. |

Response 4

| Raw Data | Explanation |
|---|---|
| 2a | Command Start |
| 02 | Channel ID: 0x02 |
| 8f 7c | Sequence Number: 36732 |
| 00 1a | Data Field Length: 26 |
| 00 04 | SNAC Family ID 0x04 |
| 00 05 | SNAC Sub Type ID 0x05 |
| 00 | Flag [0]: None |
| 00 | Flag [1]: None |
| 00 00 00 | Request ID: Same as Same as SNAC Sub Type ID in |
| 04 | Original Request |
| XX XX XX | Raw Data: Unknown Fixed Data - seems to be response to |
| XX [symbol] | Request 4 in Step 10. |

Response 5

| Raw Data | Explanation |
|---|---|
| 2a | Command Start |
| 02 | Channel ID: 0x02 |
| 8f 7d | Sequence Number: 36733 |
| 00 16 | Data Field Length: 22 |
| 00 09 | SNAC Family ID 0x09 |
| 00 03 | SNAC Sub Type ID 0x03 |
| 00 | Flag [0]: None |
| 00 | Flag [1]: None |
| 00 00 00 | Request ID: Same as Same as SNAC Sub Type ID in |
| 02 | Original Request |
| XX XX XX | Raw Data: Unknown Fixed Data - seems to be response to |
| XX [symbol] | Request 5 in Step 10. |

Clients sends “e-mail server redirect request,”

| Raw Data | Explanation |
|---|---|
| 2a | Command Start |
| 02 | Channel ID: 0x02 |
| 22 f9 | Sequence Number: 8953 |
| 00 0e | Data Field Length: 14 |
| 00 09 | SNAC Family ID 0x09 |
| 00 04 | SNAC Sub Type ID 0x04 |
| 00 | Flag [0]: None |
| 00 | Flag [1]: None |
| 00 00 00 | Request ID: Same as Same as SNAC Sub Type ID |
| 04 | |
| 00 00 00 | Raw: Unknown Fixed Data |
| 00 | |

Response 1

| Raw Data | | | Explanation |
|---|---|---|---|
| 2a | | | Command Start |
| 02 | | | Channel ID: 0x02 |
| 8f | 7e | | Sequence Number: 36734 |
| 00 | 0c | | Data Field Length: 12 |
| 00 | 0b | | SNAC Family ID 0x0b |
| 00 | 02 | | SNAC Sub Type ID 0x02 |
| 00 | | | Flag [0]: None |
| 00 | | | Flag [1]: None |
| a8 | 47 | 2d | Request ID |
| dc | | | |
| 04 | b0 | | Raw Data: Unknown Fixed Data |

Response 2

| Raw Data | | | Explanation |
|---|---|---|---|
| 2a | | | Command Start |
| 02 | | | Channel ID: 0x02 |
| 8f | 7f | | Sequence Number: 36735 |
| 00 | 22 | | Data Field Length: 34 |
| 00 | 01 | | SNAC Family ID 0x0l |
| 00 | 13 | | SNAC Sub Type ID 0x13 |
| 00 | | | Flag [0]: None |
| 00 | | | Flag [1]: None |
| a8 | 47 | 2d | Request ID |
| dd | | | |
| 00 | 04 | 00 | TLV: Data http://www.aol.com |
| 0b | 00 | 12 | |
| 68 | 74 | 74 | |
| 70 | 3a | 2f | |
| 2f | 77 | 77 | |
| 77 | 2e | 61 | |
| 6f | 6c | 2e | |
| 63 | 6f | 6d | |

Immediately after the above response, server sends “e-mail redirect response,”

| Raw Data | | | Explanation |
|---|---|---|---|
| 2a | | | Command Start |
| 02 | | | Channel ID: 0x02 |
| 8f | 80 | | Sequence Number: 36736 |
| 00 | 3f | | Data Field Length: 63 |
| 00 | 01 | | SNAC Family ID 0x01 |
| 00 | 05 | | SNAC Sub Type ID 0x05 |
| 00 | | | Flag [0]: None |
| 00 | | | Flag [1]: None |
| 00 | 01 | 00 | Request ID: Same as Same as SNAC Sub Type ID |
| 04 | | | as in Original Request |
| 00 | 0d | 00 | TLV: Unknown Fixed Data |
| 02 | 00 | 01 | |
| 00 | 05 | 00 | TLV: AOL IMAP server IP Address and Port - |
| 13 | XX | XX | Separated by “: ” |
| XX [symbol] | | | |
| 00 | 06 | 00 | TLV: Password to use with IMAP server - 19 to 20 |
| 14 | XX | XX | Uppercase characters |
| XX [symbol] | | | |

And the client will reply with disconnect request, and the connection will be terminated.

| Raw Data | | Explanation |
|---|---|---|
| 2a | | Command Start |
| 04 | | Channel ID: 0x02 |
| 22 | fa | Sequence Number: 8954 |
| 00 | 00 | Raw Data: indicates “Connection Disconnect” |

The Resulting Parameters

AOL IMAP server IP address: 205.188.156.xxx, 205.188.157.xxx,
205.188.158.xxx (reverse DNS shows imap-xxx.mx.aol.com)
AOL IMAP Server Port: Ranges from 5000 to 5009
AOL IMAP Server Password: This is the server to be used for such
server and port.

Such parameters must be used within 30 seconds or the AOL IMAP Server will not authenticate.

The same AIM username is used as the IMAP Server Username.

The second part of method 1300 is the IMAP Protocol. The AOL IMAP server IP address, AOL IMAP Server Port, and AOL IMAP Server Password are all required parameters and are obtained in part-1. Embodiments use the same AIM username as the IMAP Server Username.

Connecting to AOL IMAP server is almost the same as connecting to a regular IMAP server, except for the port and password used.

Example Session Script Sample,
Server: 205.188.157.80
Port: 5002
Password: YGVFYGVLUGPCIECOUKSJ
Username: testuser
Session Script
Connected to 205.188.157.80 port 5002
* OK imap-d21 v21_r5.2 server ready
1 capability
* CAPABILITY IMAP4rev1 LITERAL+ XAOL-ENVELOPE XAOL-NETMAIL XAOL-
OPTION XAOL-NOFLAGS XAOL-NOFOLDER
1 OK CAPABILITY completed
2 login “testuser” “YGVFYGVLUGPCIECOUKSJ”
2 OK LOGIN completed
3 XAOL-OPTION +READMBOX
* XAOL-OPTION −RID +ALERT +READMBOX +EMBEDDED −NONEW −NETMAIL −
XAOLHEADERS −IMMDELETE −BROKENRESP −NETMAILATT −AOLTIME −NETMAILUID
+OPERMSG −SECURID −CLIENTADDR −SORT −QUOTA −NOJAPAN −NOWRAP −
FILETYPE −PREFUTF8 −PREFJIS −TEXTPLAIN −TEXTHTML −EMBEDDEDIDS
3 OK XAOL-OPTION completed
4 lsub “” “*”
* LSUB () “/” INBOX
* LSUB () “/” “Sent Items”
* LSUB () “/” READ
* LSUB () “/” RECYCLE
* LSUB () “/” RECYCLE_OUT
4 OK LSUB completed

The AOL IMAP Server is IMAP 4 compliant, with a few AOL extensions (under XAOL options). One can ignore the XAOL extensions and use standard IMAP 4 functions with the following exceptions. AOL IMAP Server does not support imap_append command, thus one cannot add new messages to folders and mailboxes. AOL IMAP Server sometimes reports the total number of messages and new messages wrong.

Part-3 is “you got mail”. In addition to the “e-mail-only” AIM login process used by Gopher King. Regular AIM also offers a SNAC which allows one to quickly check if one have new e-mails or not, this function has not been implemented in the Gopher King service in any way.

Initially, the AIM client requests a new service of type 0×0005, advertisements. This is pseudo-required; as the service redirect for advertisements is the way embodiments currently know when embodiments're “online”. However, there are a few other services.

AOL users with @aol.com mail accounts can make use of service type 0×0018, which is how the newer AIM clients notify one of new mail. This is *not* POP-3, but an actual service extension. All other accounts added to the AIM client use POP-3.

Before anything happens, the normal service handshake must occur, e.g., wait for the connection acknowledge, send the cookie, wait for “host ready”, send a rate request, receive a rate response, ack the response, and, send a “client ready” command.

SNAC Information:
Family 0x0001
SubType 0x0002
Flags {0x00, 0x00}

| Container | Data |
|---|---|
| RAW | SNAC Header |
| RAW | 0x0018 |
| RAW | 0x0001 |
| RAW | 0x0004 |
| RAW | 0x0001 |
| RAW | 0x0001 |
| RAW | 0x0003 |
| RAW | 0x0004 |
| RAW | 0x076c |

Client/server version information is also swapped, but it doesn't appear to be necessary. These are swapped before sending the initial rate request, and seem to always be swapped when establishing connections with services other than the BOS. It's probably a good idea to send this data. SNAC type 0×0001/0×0017 is the client version, and 0×0001/0×0018 is the server's response. These packets look like,

| Container | Data |
|---|---|
| RAW | SNAC Header |
| RAW | SNAC Family (word: 0x0001, 0x0002, etc.) |
| RAW | Version supported (word) |

Example: {1, 3}, {2, 1}, {3, 1}, {4, 1}, {6, 1}, {8, 1}, {9, 1}, {a, 1}, {b, 2}, {c, 1}, {15, 1}. This is all in the same packet (continuous)!

Check for mail. This is sent to check for mail.

SNAC Information:
Family 0x0018
SubType 0x0006
Flags {0x00, 0x00}

| Container | Data |
|---|---|
| RAW | SNAC Header |
| RAW | 0x0001 |
| RAW | 0x5d5e |
| RAW | 0x1708 |
| RAW | 0x55aa |
| RAW | 0x11d3 |
| RAW | 0xb143 |
| RAW | 0x0060 |
| RAW | 0xb0fb |
| RAW | 0x1ecb |

“You got Mail!” is sent by the AIM server in response to a mail request.

SNAC Information:
Family 0x0018
SubType 0x0007
Flags {0x00, 0x00}

| | | TLV |
|---|---|---|
| Container | Data | Type |
| RAW | SNAC Header | |
| RAW | 8 bytes of zeros | |
| RAW | “Mail cookie” returned (16 bytes) | |
| RAW | 0x0003 | |
| TLV | HTTP redirect (usually | 0x0007 |
| | http://aim.aol.com/redirects/inclient/aolmail.html) | |
| TLV | “aol.com” (??) | 0x0082 |
| TLV | One byte TLV -- value of 0x01 indicates | 0x0081 |
| | embodiments have new (unread) mail, and 0x00 | |
| | indicates otherwise. | |

Identified SNACs

| | | |
|---|---|---|
| Subtype | Source | Function |

Family 0x0001: Generic Service Controls

| | | |
|---|---|---|
| 0x0001 | Client | Error |
| | or | |
| | Server | |
| 0x0002 | Client | Client is now online and ready for normal function |
| 0x0003 | Server | Server is now ready for normal functions |
| 0x0004 | Client | Request for new service (the server will redirect |
| | | the client to a new host where the service is |
| | | available) |
| 0x0005 | Server | Redirect (response to subtype 0x0004 from client) |
| 0x0006 | Client | Request Rate Information (request rate at which |
| | | client can send SNACs) |
| 0x0007 | Server | Rate information response (response to subtype |
| | | 0x0006) |
| 0x0008 | Client | Rate Information Response Ack |
| 0x000A | Server | Rate information change |
| 0x000B | Server | Pause |
| 0x000D | Server | Resume |
| 0x000E | Client | Request information on the screen name one've been |
| | | authenticated under. |
| 0x000F | Server | Information the screen name one've been |
| | | authenticated under. |
| 0x0010 | Server | Evil notification |
| 0x0012 | Server | Migration notice/request |
| 0x0013 | Server | Message of the day |
| 0x0014 | Client | Set Privacy flags |
| 0x0015 | Server | Well known urls |
| 0x0016 | Server | No op |

Family 0x0002: Location Services

| | | |
|---|---|---|
| 0x0001 | Client | Error |
| | or Error | |
| | Server | |
| 0x0002 | Client | Request rights information |
| 0x0003 | Server | Rights information |
| 0x0004 | Client | Set user information |
| 0x0005 | Client | Request user information |
| 0x0006 | Server | User information |
| 0x0007 | Client | Watcher sub request |
| 0x0008 | Server | Watcher notification |

Family 0x0003: Buddy List Management

| | | |
|---|---|---|
| 0x0001 | Client | Error |
| | or | |
| | Server | |
| 0x0002 | Client | Request rights information |
| 0x0003 | Server | Rights information |
| 0x0004 | Client | Add buddy to buddy list |
| 0x0005 | Client | Remove buddy from buddy list |
| 0x0006 | Client | Watcher list query |
| 0x0007 | Server | Watcher list response |
| 0x0008 | Client | Watcher sub request |
| 0x0009 | Server | Watcher notification |
| 0x000A | Server | Reject notification |
| 0x000B | Server | Oncoming buddy |
| 0x000C | Server | Offgoing buddy |

Family 0x0004: Messaging

| | | |
|---|---|---|
| 0x0001 | Client | Error |
| | or | |
| | Server | |
| 0x0002 | Client | Add ICBM parameter |
| 0x0003 | Client | Remove ICBM parameter |
| 0x0004 | Client | Request parameter information |
| 0x0005 | Server | Parameter information |
| 0x0006 | Client | Message from the client |
| 0x0007 | Server | Message to the client |
| 0x0008 | Client | Evil request |
| 0x0009 | Server | Evil reply |
| 0x000A | Server | Missed calls |
| 0x000B | Client | Client error |
| | or | |
| | Server | |
| 0x000C | Server | Host ack |

Family 0x0005: Advertisements

| | | |
|---|---|---|
| 0x0001 | Client | Error |
| | or | |
| | Server | |
| 0x0002 | Client | Request advertisements |
| 0x0003 | Server | Advertisement data (GIFs) |

Family 0x0006: Invitation and Client-to-Client

| | | |
|---|---|---|
| 0x0002 | Client | Invite a friend to join AIM |
| 0x0003 | Server | Invite a friend to join AIM ack |

Family 0x0007: Administrative

| | | |
|---|---|---|
| 0x0001 | Server | Admin error |
| 0x0002 | Client | Information request |
| 0x0003 | Server | Information reply |
| 0x0004 | Client | Information change request |
| 0x0005 | Server | Information change reply |
| 0x0006 | Client | Account confirm request |
| 0x0007 | Server | Account confirm reply |
| 0x0008 | Client | Account delete request |
| 0x0009 | Server | Account delete reply |

Family 0x0008: Popup Notices

| | | |
|---|---|---|
| 0x0001 | Client | Error |
| | or | |
| | Server | |
| 0x0002 | Server | Display popup |

Family 0x0009: BOS-specific

| | | |
|---|---|---|
| 0x0001 | Client | Error |
| | or | |
| | Server | |
| 0x0002 | Client | Request BOS Rights |
| 0x0003 | Server | BOS Rights |
| 0x0004 | Client | Set group permission mask |
| 0x0005 | Client | Add permission list entries |
| 0x0006 | Client | Delete permission list entries |
| 0x0007 | Client | Add deny list entries |
| 0x0008 | Client | Delete deny list entries |
| 0x0009 | Server | BOS error |

Family 0x000A: User Lookup

| | | |
|---|---|---|
| 0x0001 | Client | Error (often Search Failed) |
| | or | |
| | Server | |
| 0x0002 | Client | Search for screen name by email address |
| 0x0003 | Server | Search Response |

Family 0x000B: Stats

| | | |
|---|---|---|
| 0x0001 | Client | Error |
| | or | |
| | Server | |
| 0x0002 | Server | Set minimum report interval |
| 0x0003 | Client | Report events |
| 0x0004 | Server | Report ack |

Family 0x000C: Translate

| | | |
|---|---|---|
| 0x0001 | Client | Error |
| | or | |
| | Server | |
| 0x0002 | Client | Translate request |
| 0x0003 | Server | Translate reply |

Family 0x000D: Chat Navigation

| | | |
|---|---|---|
| 0x0001 | Client | Error |
| | or | |
| | Server | |
| 0x0002 | Client | Request chat rights |
| 0x0003 | Client | Request exchange information |
| 0x0004 | Client | Request room information |
| 0x0005 | Client | Request more room information |
| 0x0006 | Client | Request occupant list |
| 0x0007 | Client | Search for room |
| 0x0008 | Client | Create room |
| 0x0009 | Server | Navigation information |

Family 0x000E: Chat

| | | |
|---|---|---|
| 0x0001 | Client | Error |
| | or | |
| | Server | |
| 0x0002 | Server | Room information update |
| 0x0003 | Server | Users joined |
| 0x0004 | Server | Users left |
| 0x0005 | Client | Channel message from client |
| 0x0006 | Server | Channel message to client |
| 0x0007 | Server | Evil request |
| 0x0008 | Server | Evil reply |
| 0x0009 | Client | Client error |
| | or | |
| | Server | |

Family 0x0045: Client Action

| | | |
|---|---|---|
| 0x0002 | Client | Add to notify list |

Regular AIM Login

In the Regular AIM Login Process, Every protocol begins with a single step. It is different from the login processes described above for e-mail retrieval.

Before connections are made to any of the BOS or special-purpose servers, one must first be authorized by the Authorization Server (login.oscar.aol.com also known as OSCAR). This will return a cookie that automatically authorizes one to connect to any of the BOS or special-purpose (e.g., Advertisement, Chat, etc) servers. This streamlines the login process quite a bit.

The normal steps taken to create an average AIM session are:

| | |
|---|---|
| 1. | Connect to Authorizer and retrieve Cookie. |
| 2. | Connect to the Authorizer-recommended BOS server and initiate |
| | BOS service |
| 3. | (Optional) Connect to Advertisements server and retrieve first |
| | block of ads (repeat at regular interval) |
| 4. | (Optional) Connect to any other non-BOS services that may be |
| | available (AFAIK, none at this point) |

The last three steps may actually be done in any order (and for the third and fourth step, probably not at all). But, authorization must always come first.

In OSCAR Authorization, OSCAR has a sense of the “single-login” concept. One login once and get a “cookie” that automatically authorizes one to use any of the OSCAR-associated services, just by sending them your cookie. The first step of the process is connecting to the Authorizer. This currently resides at the DNS address login.oscar.aol.com. It also appears that one may connect to any port and get the same response. The AIM clients use 5190, one uses 443, another used 21 (telnet).

After the connection, the client must send the “Authorization Request” command. The server also sends a 4b+FLAP command to the client after each new connection, called the “Connection Acknowledge” command. This may be accepted and processed before or after the initial command from the client, e.g., for use it dispatch routines, this can be used as a sign that the initial login should be sent. The response to this (“Authorization Response”) comprises the cookie to be used for the BOS and other connections. But, if the Authorization Request fails, one'll get back any one of the several “Authorization Errors”. After one've gotten your cookie, it's safe to disconnect yourself from the Authorizer.

The BOS Sign on step is used to connect to and initiate service with the BOS. The address of the BOS one should connect to is listed in the Authorization Response. The first step for this connection is to send the BOS-Signon command to the server. But, for the purposes of dispatching, it may be best to wait to send this command until the Connection Acknowledge command is received from the server immediately after the connection opens, although this is optional and can be processed afterwards.

Normal BOS sign on looks something like this . . .

1. Server Sends Connection Acknowledge

[Source: Server]

This is sent by the server after a new connection has been opened and is ready for duplex operation.

| | | |
|---|---|---|
| Container | Data | TLV Type |

| | |
|---|---|
| RAW | FLAP Header (channel 0x01) |
| DWORD | FLAP version (0x00000001) |

2. Client Sends BOS Sign On Command.

[Source: Client]

Send as the first command to the BOS connection. The Cookie comes from the Authorization Response.

| | | |
|---|---|---|
| Container | Data | TLV Type |

| | | |
|---|---|---|
| RAW | FLAP Header (channel 0x01) | |
| RAW | 0x0000 | |
| RAW | 0x0001 | |
| TLV | Authorization Cookie | 0x0006 |

3. Server Sends BOS Host-Ready.

[Source: Server]

Sent by the server to notify the client that it's ready to begin service.

SNAC Information:
Family 0x0001
SubType 0x0003
Flags {0x00, 0x00}

| | | |
|---|---|---|
| Container | Data | TLV Type |

| | |
|---|---|
| RAW | SNAC Header |
| RAW | 0x0001 |
| RAW | 0x0002 |
| RAW | 0x0003 |
| RAW | 0x0004 |
| RAW | 0x0006 |
| RAW | 0x0008 |
| RAW | 0x0009 |
| RAW | 0x000a |
| RAW | 0x000b |
| RAW | 0x000c |

4. Client Sends Rate Information Request.

[Source: Client]

Sent by the client so it can know how fast it can send SNACs. If this rate is disobeyed, one'll be (at worst) disconnected.

SNAC Information:
Family 0x0001
SubType 0x0006
Flags {0x00, 0x00}

| | | |
|---|---|---|
| Container | Data | TLV Type |

| | |
|---|---|
| RAW | SNAC Header |

5 Server Sends Rate Information Response.

[Source: BOS]

Sent by the BOS to the client. Unknown.

| | SNAC Information: | |
|---|---|---|
| | Family 0x0001 | |
| | SubType 0x0007 | |
| | Flags {0x00, 0x00} | |
| Container | Data | TLV Type |

| | |
|---|---|
| RAW | SNAC Header |
| RAW | UNKNOWN DATA |

6. Client Sends Rate Information Acknowledge.

[Source: Client]

Sent by the client to acknowledge the BOS Rate Response.

SNAC Information:
Family 0x0001
SubType 0x0008
Flags {0x00, 0x00}

| | | |
|---|---|---|
| Container | Data | TLV Type |

| | |
|---|---|
| RAW | SNAC Header |
| RAW | 0x0001 |
| RAW | 0x0002 |
| RAW | 0x0003 |
| RAW | 0x0004 |

7. Client Requests (In No Particular Order):

Set Privacy Flags

[Source: Client]

Sets privacy flags. Not fully explored. Currently the only documented flag value is 0×0003 (no protection).

SNAC Information:
Family 0x0001
SubType 0x0014
Flags {0x00, 0x00}

| | | |
|---|---|---|
| Container | Data | TLV Type |

| | |
|---|---|
| RAW | SNAC Header |
| RAW | 0x0000 |
| RAW | Privacy Flags |

Request Our User Information

[Source: Client]

Requests personal information.

SNAC Information:
Family 0x0001
SubType 0x000e
Flags {0x00, 0x00}

| | | |
|---|---|---|
| Container | Data | TLV Type |

| | |
|---|---|
| RAW | SNAC Header |

Request New Service

[Source: Client]

Requests a new service. Normally used for starting up the mechanism to get advertisements and to set up chat.

SNAC Information:
Family 0x0001
SubType 0x0004
Flags {0x00, 0x00}

| | | |
|---|---|---|
| Container | Data | TLV Type |

| | |
|---|---|
| RAW | SNAC Header |
| RAW | Service Type |

Services Available:

| Service | Service ID |
|---|---|
| Advertisements | 0x0005 |
| Administrative | 0x0007 |
| Chat Navigation | 0x000d |
| Chat | 0x000e |
| Authorizer (AIM 3.5 (SNAC-based login) only) | 0x0017 |

Often, the service ID is the same as the SNAC family that serves it. However, this is only applicable to non-core services such as Chat and Ads.

Optional: Request BOS Rights

[Source: Client]

Requests rights for general BOS services.

SNAC Information:
Family 0x0009
SubType 0x0002
Flags {0x00, 0x00}

| | | |
|---|---|---|
| Container | Data | TLV Type |

| | |
|---|---|
| RAW | SNAC Header |

Optional: Request Buddy List Rights

[Source: Client]

Requests rights for buddy list operations.

SNAC Information:
Family 0x0003
SubType 0x0002
Flags {0x00, 0x00}

| | | |
|---|---|---|
| Container | Data | TLV Type |

| | |
|---|---|
| RAW | SNAC Header |

Optional: Request Locate Rights

[Source: Client]

Requests rights for user location operations.

SNAC Information:
Family 0x0002
SubType 0x0002
Flags {0x00, 0x00}

| | | |
|---|---|---|
| Container | Data | TLV Type |

| | |
|---|---|
| RAW | SNAC Header |

Optional: Request ICBM Parameter Information

[Source: Client]

Requests rights for ICBM (Instant Message) operations.

SNAC Information:
Family 0x0004
SubType 0x0004
Flags {0x00, 0x00}

| | | |
|---|---|---|
| Container | Data | TLV Type |

| | |
|---|---|
| RAW | SNAC Header |

8. Server Sends All the Information Requested (Again, In No Particular Order):

Our User Information Response

[Source: BOS]

Comprises user information about the user one're currently logged in as.

SNAC Information:
Family 0x0001
SubType 0x000f
Flags {0x00, 0x00}

| Container | Data | TLV Type |
|---|---|---|
| RAW | SNAC Header | |
| RAW | Screen Name Length (byte) | |
| RAW | Screen Name (unterminated string) | |
| RAW | Warning level (word) | |
| RAW | TLV count (word -- number of TLVs to | |
| | follow) | |
| TLV | User Class (?) (word) | 1 |
| TLV (if | Signup Date (time_t format) | 2 |
| tlvcnt>=2) | | |
| TLV (if | Sign on Date (time_t format) | 3 |
| tlvcnt>=3) | | |
| TLV (if | Idle time (in minutes) | 4 |
| tlvcnt>=4) | | |

BOS Rights Response

[Source: BOS]

Comprises rights information for the general BOS services. Mostly unknown information.

SNAC Information:
Family 0x0009
SubType 0x0003
Flags {0x00, 0x00}

| | | |
|---|---|---|
| Container | Data | TLV Type |

| | |
|---|---|
| RAW | SNAC Header |
| RAW | UNKNOWN DATA |

Buddy List Rights Response

[Source: BOS]

Comprises rights information for the Buddy List services. Mostly unknown information.

SNAC Information:
Family 0x0003
Subtype 0x0003
Flags {0x00, 0x00}

| | | |
|---|---|---|
| Container | Data | TLV Type |

| | |
|---|---|
| RAW | SNAC Header |
| RAW | UNKNOWN DATA |

Locate Rights Response

[Source: BOS]

Comprises rights information for the user location services. Mostly unknown information.

SNAC Information:
Family 0x0002
SubType 0x0003
Flags {0x00, 0x00}

| | | |
|---|---|---|
| Container | Data | TLV Type |

| | |
|---|---|
| RAW | SNAC Header |
| RAW | UNKNOWN DATA |

ICBM Parameter Information Response

[Source: BOS]

Comprises ICBM parameters. Mostly unknown information.

SNAC Information:
Family 0x0004
SubType 0x0005
Flags {0x00, 0x00}

| | | |
|---|---|---|
| Container | Data | TLV Type |

| | |
|---|---|
| RAW | SNAC Header |
| RAW | UNKNOWN DATA |

New Service Redirect

[Source: BOS]

Comprises information on the service requested through the Service Request.

SNAC Information:
Family 0x0001
SubType 0x0005
Flags {0x00, 0x00}

| Container | Data | TLV Type |
|---|---|---|
| RAW | SNAC Header | |
| TLV | Service Type (word) | 0x000d |
| TLV | Service Host (unterminated string | 0x000f |
| | containing IP in dotted-decimal) | |
| TLV | Auth Cookie? (1: 0x0100) | 0x0006 |

9. (Apparently Optional) Client Sends a SNAC of Family 0×0009, Subtype 0×0004, Data {0×0000, 0×001f}.

10. (Apparently Optional) Client Sends a SNAC of Family 0×0009, Subtype 0×0007, No Data.

11. Client Sends up Buddy List Using the Add Buddy to Buddy List Command.

[Source: Client]

Adds a number of buddies to your buddy list, causing AIM to send us on/off events for the given users. Len/buddy combinations can be repeated as many times as one have buddies to add.

SNAC Information:
Family 0x0003
SubType 0x0004
Flags {0x00, 0x00}

| | | |
|---|---|---|
| Container | Data | TLV Type |

| | |
|---|---|
| RAW | SNAC Header |
| RAW | Buddy name length (byte) |
| RAW | Buddy name |

12. Client Sends up User's Profile Using the Set User Information Command.

[Source: Client]

This sends up the initial profile and capability set. It's also used while online to set yourself away and back. Capabilities are represented by blocks of data, 16 bytes long.

The final portion of this packet is the capability set. It's technically a TLV, but it's easier in code to refer to it otherwise, since the value of the TLV differs based on capabilities.

SNAC Information:
Family 0x0002
SubType 0x0004
Flags {0x00, 0x00}

| Container | Data | TLV Type |
|---|---|---|
| RAW | SNAG Header | |
| TLV | TLV containing string: text/x-aolrtf; | 0x0001 |
| | charset = “us-ASCII” | |
| TLV | Profile string | 0x0002 |
| TLV | TLV containing string: text/x-aolrtf; | 0x0003 |
| | charset = “us-ASCII” | |
| TLV | Away message. TLV value is NULL (and | 0x0004 |
| | Len is 0) if one're not away. | |
| TLV | Capability block | 0x0005 |

The following table illustrates the capability sets; one could easily send up this entire thing and forget about it, but if one want to be specific, send only those that your client supports. This way, other clients will be notified of your capabilities, and be stopped/warned when sending one requests that one're not capable of dealing with. Hence the word “capability”.

| Container | Data |
|---|---|
| Buddy icon | 0x09, 0x46, 0x13, 0x46, 0x4c, 0x7f, 0x11, 0xd1, 0x82, |
| | 0x22, 0x44, 0x45, 0x53, 0x54, 0x00, 0x00 |
| Voice | 0x09, 0x46, 0x13, 0x41, 0x4c, 0x7f, 0x11, 0xd1, 0x82, |
| | 0x22, 0x44, 0x45, 0x53, 0x54, 0x00, 0x00 |
| IM image | 0x09, 0x46, 0x13, 0x45, 0x4c, 0x7f, 0x11, 0xd1, 0x82, |
| | 0x22, 0x44, 0x45, 0x53, 0x54, 0x00, 0x00 |
| Chat | 0x74, 0x8f, 0x24, 0x20, 0x62, 0x87, 0x11, 0xd1, 0x82, |
| | 0x22, 0x44, 0x45, 0x53, 0x54, 0x00, 0x00 |
| Get file | 0x09, 0x46, 0x13, 0x48, 0x4c, 0x7f, 0x11, 0xd1, 0x82, |
| | 0x22, 0x44, 0x45, 0x53, 0x54, 0x00, 0x00 |
| Send file | 0x09, 0x46, 0x13, 0x43, 0x4c, 0x7f, 0x11, 0xd1, 0x82, |
| | 0x22, 0x44, 0x45, 0x53, 0x54, 0x00, 0x00 |

13. Client Sends the Set Initial ICBM Parameter command.

[Source: Client]

SNAC Information:
Family 0x0004
SubType 0x0002
Flags {0x00, 0x00}

| | | |
|---|---|---|
| Container | Data | TLV Type |

| | |
|---|---|
| RAW | SNAC Header |
| RAW | 0x0000 |
| RAW | 0x00000003 |
| RAW | 0x1f40 |
| RAW | 0x03e7 |
| RAW | 0x03e7 |
| RAW | 0x0000 |
| RAW | 0x0000 |

14. Client Sends the Client Ready command.

[Source: Client]

Notifies the server that embodiments're on-line and ready to receive messages. Details unknown.

SNAC Information:
Family 0x0001
SubType 0x0002
Flags {0x00, 0x00}

| | | |
|---|---|---|
| Container | Data | TLV Type |

| | |
|---|---|
| RAW | SNAC Header |
| RAW | 0x0001 |
| RAW | 0x0003 |
| RAW | 0x0004 |
| RAW | 0x0686 |
| RAW | 0x0002 |
| RAW | 0x0001 |
| RAW | 0x0004 |
| RAW | 0x0001 |
| RAW | 0x0003 |
| RAW | 0x0001 |
| RAW | 0x0004 |
| RAW | 0x0001 |
| RAW | 0x0004 |
| RAW | 0x0001 |
| RAW | 0x0004 |
| RAW | 0x0001 |
| RAW | 0x0009 |
| RAW | 0x0001 |
| RAW | 0x0004 |
| RAW | 0x0001 |
| RAW | 0x000a |
| RAW | 0x0001 |
| RAW | 0x0004 |
| RAW | 0x0001 |
| RAW | 0x000b |
| RAW | 0x0001 |
| RAW | 0x0004 |
| RAW | 0x0001 |

At that point, one can either quit and begin processing live events, or one may use the information provided in the New Service Redirect command to connect to the Advertisements or other server.

Logging off of AIM is about the simplest thing one can do. The abrupt way to do it is just closing the connection to the main message server. That will normally do it. Sometimes the AIM client sends a small command to the server before it closes, but expects no response. The best way is just to close it forget about it. This “logout command” is just a FLAP without a Data Field, and the Data Field Length set to 0×0000.

Detailed information on the AOL system access method 1300 useful in embodiments of the present invention is disclosed in the U.S. Provisional Patent Application of the present inventor, Baohua HUANG, serial No. 60/366,942, filed Mar. 25, 2002, and titled AOL SYSTEM ACCESS METHOD. Such is incorporated herein by reference.

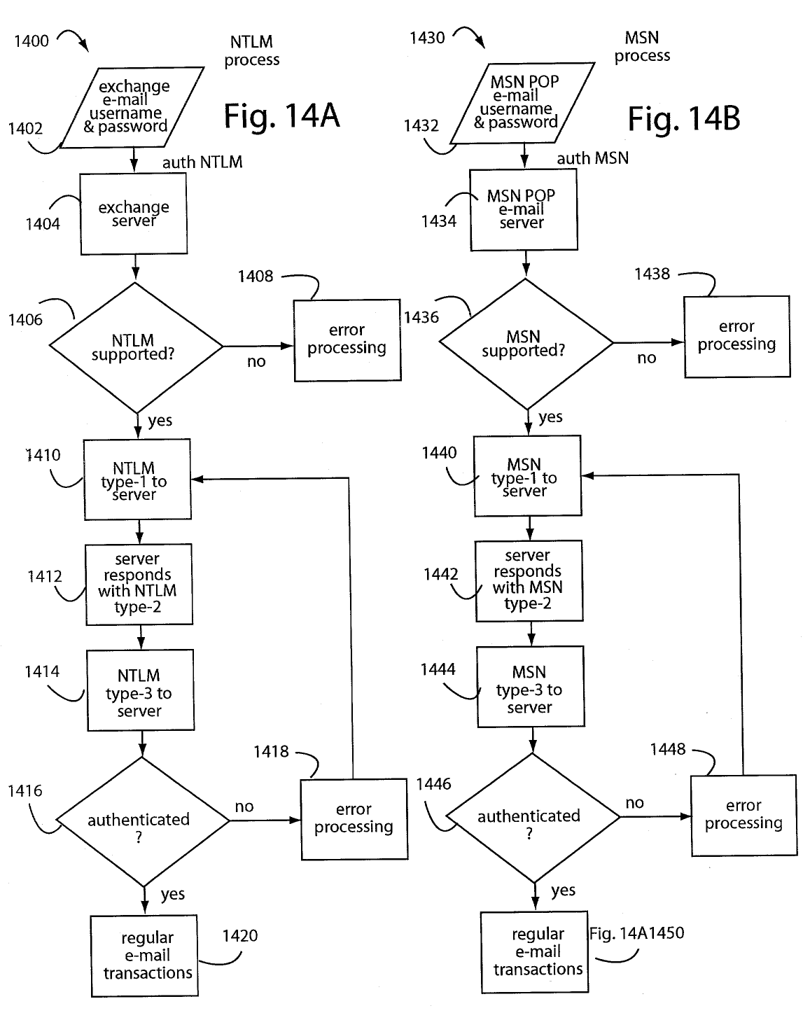

FIGS. 14A and 14B represents an NTLM Authentication method 1400 and an MSN Authentication method 1430 used in MSN POP method embodiments of the present invention. Such provide MSN POP e-mail System Access and POP/IMAP Access to Microsoft Exchange Servers through NTLM Authentication.

Being able access the MSN POP e-mail system depends on correctly using both the unique MSN Login Process and industry-standard POP3 protocol. NTLM Authentication is the basis of MSN Authentication and it has been widely used in Microsoft products. NTLM Authentication is a proprietary challenge/response authentication mechanism developed by Microsoft, and it is used in many applications from web servers/clients, e.g., Microsoft Internet Information Server, to e-mail server/clients, e.g., Microsoft Exchange Server. NTLM Authentication is used in POP3 and IMAP e-mail protocols.

Industry-standards references RFC 1939 (POP3) and RFC 2060 (IMAP) require the authentication mechanisms used by clients in POP3/IMAP must follow a particular format. The exception is clear password authentication in POP3 which uses LOGIN and PASS. The required format is outlined in FIG. 14A and can be described as,

AUTH XXXX

XXX is the pseudo-name of the authentication scheme.

Since NTLM Authentication is not one of the standard login mechanisms, it sends its unique authentication command:

AUTH NTLM

NTLM Handshake

When an e-mail client authenticates itself to a server using the NTLM mechanism, the following four-way handshake takes place (illustrated with “C” being the client, “S” the server):

| | | |
|---|---|---|
| 1: | C −−> S | AUTH NTLM |
| | | Client request NTLM authentication |
| 2: | C −−> S | + |
| | | NTLM Authentication supported, client should continue |
| 3: | C −−> S | Authorization: NTLM <base64-encoded type-1-message> |
| 4: | C <−− S | + |
| | | Client need to authentication: NTLM <base64-encoded |
| | | type-2-message> |
| 5: | C −−> S | Authorization: NTLM <base64-encoded type-3-message> |
| 6: | C <−− S | +OK |
| | | Authorization succeeded. Client may continue with |
| | | e-mail transactions. |

The process indicated above is for POP3 protocol. AUTH NTLM for IMAP protocol is nearly the same with the exception of the CAPABILITIES command. The e-mail client would return the

[symbol]

AUTH=NTLM

[symbol]

response if the e-mail server supports NTLM. This could be used to verify NTLM support on IMAP servers.

Messages Used in the NTLM Authentication Process

The three messages sent in the handshake are binary structures. Each one is described below as a pseudo-C struct and in a memory layout diagram.

Definition: byte is an 8-bit field; short is a 16-bit field. All fields are unsigned. Numbers are stored in little-endian order. Struct fields named zero contain all zeroes. An array length of “*” indicates a variable length field. Hexadecimal numbers and quoted characters in the comments of the struct indicate fixed values for the given field. The field flags are presumed to contain flags, but their significance is unknown; the values given are just those found in the packet traces.

The Type-1 message comprises the NTLM Authentication request.

| | |
|---|---|
| struct { | |
| byte | protocol[8]; // ‘N’, ‘T’, ‘L’, ‘M’, ‘S’, ‘S’, ‘P’, |
| ‘\0’ | |
| byte | type; // 0x01 |
| byte | zero[3]; |
| short | flags; // Flags (always 0x8206) |
| byte | zero[22]; |
| byte | extended_flag; // Extended Flag (always |
| 0x30) | |
| byte | zero[7]; |
| byte | extended_flag; // Extended Flag (always |
| 0x30) | |
| byte | zero[3]; |

} type-1-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 1 | 0 | 0 | 0 |
| 12: | 0x06 | 0x82 | 0 | 0 |
| 16: | 0 | 0 | 0 | 0 |
| 20: | 0 | 0 | 0 | 0 |
| 24: | 0 | 0 | 0 | 0 |
| 28: | 0 | 0 | 0 | 0 |
| 32: | 0 | 0 | 0 | 0 |
| 36: | 0x30 | 0 | 0 | 0 |
| 40: | 0 | 0 | 0 | 0 |
| 44: | 0x30 | 0 | 0 | 0 |

The Type-2 Message comprises the server's NTLM challenge.

| struct { | | |
|---|---|---|
| byte | protocol[8]; | // ‘N’, ‘T’, ‘L’, ‘M’, ‘S’, ‘S’, ‘P’, |
| ‘\0’ | | |
| byte | type; | // 0x02 |
| byte | zero[3]; | |
| short | domain_len; | // domain length |
| short | domain_len; | // domain length |
| short | domain_off; | // domain offset |
| byte | zero[2]; | |
| short | flags; | // 0x8206 |
| short | extended_flags; | // 0x0001 |
| byte | nonce[8]; | // nonce |
| byte | zero[12]; | |
| short | msg_len; | // message length |
| byte | zero[2]; | |
| byte | domain[*]; | // domain string (ASCII or ISO- |
| 8859-1) | | |

} type-2-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 2 | 0 | 0 | 0 |

| | | |
|---|---|---|
| 12: | domain_len | domain_len |

| | | | |
|---|---|---|---|
| 16: | domain off | 0 | 0 |

| | | | | |
|---|---|---|---|---|
| 20: | 0x06 | 0x82 | 0x01 | 0x00 |

| | |
|---|---|
| 24: | server nonce |
| 28: | |

| | | | | |
|---|---|---|---|---|
| 32: | 0 | 0 | 0 | 0 |
| 36: | 0 | 0 | 0 | 0 |
| 40: | 0 | 0 | 0 | 0 |

| | | | |
|---|---|---|---|
| 44: | message len | 0 | 0 |

| | |
|---|---|
| 48: | domain string |

The nonce is used by the client to create the LanManager response (see Password Hash section). It is an array of 8 arbitrary bytes. The message length field comprises the length of the complete message.

Type-3 Message

The Type-3 message comprises the username, local host name, NT domain name, and the Lan Manager response.

| | | |
|---|---|---|
| struct { | | |
| byte | protocol[8]; | // ‘N’, ‘T’, ‘L’, ‘M’, ‘S’, ‘S’, ‘P’, |
| ‘\0’ | | |
| byte | type; | // 0x03 |
| byte | zero[3]; | |
| short | lm_resp_len; | // LanManager response length |
| | | (always |
| 0x18) | | |
| short | lm_resp_len; | // LanManager response length |
| | | (always |
| 0x18) | | |
| short | lm_resp_off; | // LanManager response offset |
| byte | zero[6]; | |
| 0x18) | | |
| short | message_len; | // Message Length |
| byte | zero[2]; | |
| short | dom_len; | // domain string length |
| short | dom_len; | // domain string length |
| short | dom_off; | // domain string offset (always 0x40) |
| byte | zero[2]; | |
| short | user_len; | // username string length |
| short | user_len; | // username string length |
| short | user_off; | // username string offset |
| byte | zero[2]; | |
| short | host_len; | // host string length |
| short | host_len; | // host string length |
| short | host_off; | // host string offset |
| byte | zero[6]; | |
| byte | dom[*]; | // domain string |
| | | (ASCII or ISO-8859- |
| 1) | | |
| byte | user[*]; | // username string (ASCII or ISO- |
| 8859-1) | | |
| byte | host[*]; | // host string (ASCII or ISO-8859-1) |
| byte | lm_resp[*]; | // LanManager response |

} type-3-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 3 | 0 | 0 | 0 |

| | | |
|---|---|---|
| 12: | LM-resp len | LM-Resp len |

| | | | |
|---|---|---|---|
| 16: | LM-resp off | 0 | 0 |

| | | | | |
|---|---|---|---|---|
| 20: | 0 | 0 | 0 | 0 |

| | | | |
|---|---|---|---|
| 24: | message len | 0 | 0 |

| | | |
|---|---|---|
| 28: | domain length | domain length |

| | | | |
|---|---|---|---|
| 32: | domain offset | 0 | 0 |

| | | |
|---|---|---|
| 36: | user length | user length |

| | | | |
|---|---|---|---|
| 40: | user offset | 0 | 0 |

| | | |
|---|---|---|
| 44: | host length | host length |

| | | | |
|---|---|---|---|
| 48: | host offset | 0 | 0 |

| | |
|---|---|
| 52: | domain string |

user string

host string

LanManager-response

The host, domain, and username strings are in ASCII or ISO-8859-1 and are not nul-terminated; the host and domain names are case-insensitive. The length of the response string is always 24.

Password Hash

To calculate the response string, a LanManager password hash is created. Herein, the almost-C code calculates the response. Inputs are passw and nonce, the result is in lm_resp:

```
    /* setup LanManager password */
    char lm_pw[14];
    int len = strlen(passw);
    if (len > 14) len = 14;
    for (idx=0; idx<len; idx++)
        lm_pw[idx] = toupper (passw[idx]);
    for (; idx<14; idx++)
        lm_pw[idx] = 0;
    /* create LanManager hashed password */
    unsigned char magic[] = {0x4B, 0x47, 0x53, 0x21, 0x40, 0x23,
0x24, 0x25 };
    unsigned char lm_hpw[21];
    des_key_schedule ks;
    setup_des_key(lm_pw, ks);
    des_ecb_encrypt(magic, lm_hpw, ks);
    setup_des_key(lm_pw+7, ks);
    des_ecb_encrypt(magic, lm_hpw+8, ks);
    memset(lm_hpw+16, 0, 5);
    /* create responses */
    unsigned char lm_resp[24];
    calc_resp(lm_hpw, nonce, lm_resp);
```

Helpers:

```
    /*
    * takes a 21 byte array and treats it as 3 56-bit DES keys. The
    * 8 byte plaintext is encrypted with each key and the resulting
24
    * bytes are stored in the results array.
    */
    void calc_resp(unsigned char *keys, unsigned char *plaintext,
unsigned char *results)
    {
        des_key_schedule ks;
        setup_des_key(keys, ks);
        des_ecb_encrypt((des_cblock*) plaintext, (des_cblock*)
results, ks, DES_ENCRYPT);
        setup_des_key(keys+7, ks);
        des_ecb_encrypt((des_cblock*) plaintext, (des_cblock*)
(results+8), ks, DES_ENCRYPT);
        setup_des_key(keys+14, ks);
        des_ecb_encrypt((des_cblock*) plaintext, (des_cblock*)
(results+16), ks, DES_ENCRYPT);
    }
    /*
    * turns a 56 bit key into the 64 bit, odd parity key and sets the
key.
    * The key schedule ks is also set.
    */
    void setup_des_key(unsigned char key_56[], des_{—}
    key_schedule ks)
    {
        des_cblock key;
        key[0] = key_56[0];
        key[1] = ((key_56[0] << 7) & 0xFF) (key_56[1] >> 1);
        key[2] = ((key_56[1] << 6) & 0xFF) (key_56[2] >> 2);
        key[3] = ((key_56[2] << 5) & 0xFF) (key_56[3] >> 3);
        key[4] = ((key_56[3] << 4) & 0xFF) (key_56[4] >> 4);
        key[5] = ((key_56[4] << 3) & 0xFF) (key_56[5] >> 5);
        key[6] = ((key_56[5] << 2) & 0xFF) (key_56[6] >> 6);
        key[7] = (key_56[6] << 1) & 0xFF;
        des_set_odd_parity(&key);
        des_set_key(&key, ks);
    }
```

Such authenticates connections, not requests. The network connection must be kept alive during the second part of the handshake, or the process must be restarted.

### EXAMPLE

### POP3 Session

Sample Session performed on MS Exchange Server 5.5 SP2 with NTLM enabled, Port 110 POP3:

```
1: C --> S AUTH NTLM
2: C <-- S +
              Client request NTLM authentication
3: C --> S
TlRMTVNTUAABAAAABoIAAAAAAAAAAAAAAAAAAAAAAAAAAAAAMAAAAAAAAAAwAAAA
              Authorization: NTLM <base64-encoded type-1-message>
4: C <-- S +
TlRMTVNTUAACAAAABgAGADAAAAAGggEAGCJooSWBRdYAAAAAAAAAAAAAAAA2AAAAR1VOTE
FX
              Client need to authentication: NTLM <base64-encoded
type-2-message>
5: C -- >S
TlRMTVNTUAADAAAAGAAYAEYAAAAAAAAAXgAAAAYABgA0AAAACAAIADoAAAAEAAQAQgAAAG
d1bmRlcnRlc3R1c2VyQk9CMQNitmuVYR5Lkc6zSFU6HAGYwbUs4E2t+A==
              Authorization: NTLM <base64-encoded type-3-message>
6: C <-- S +OK
              Authorization succeeded. Client may continue with e-mail
transactions.
```

Once the e-mail client is successfully authenticated, the client may continue on with further e-mail transactions using standard POP3/IMAP commands. Currently e-mail servers that support NTLM Authentication include all Microsoft Exchange Servers, and Microsoft Simple SMTP Server.

Referring now to FIG. 14B, it can be seen that MSN Authentication 1430 is very similar to NTLM Authentication 1400, with subtle differences in the implementation. The MSN Authentication 1430 is only used with POP3 servers on the MSN.

MSN Authentication

Since MSN Authentication is not a standard login mechanism, it must send its unique authentication command, e.g.,

AUT MSN

MSN Handshake

When an Email client needs to authenticate itself to a server using the MSN mechanism then the following four-way handshake takes place (illustrated as “C” being the client, “S” the server):

| | | |
|---|---|---|
| 1: | C --> S | AUTH MSN |
| | | Client request MSN authentication |
| 2: | C <-- S | + |
| | | MSN Authentication supported, client should continue |
| 3: | C --> S | Authorization: MSN <base64-encoded type-1-message> |
| 4: | C <-- S | + |
| | | Client need to authentication: MSN <base64-encoded |
| | | type-2-message> |
| 5: | C --> S | Authorization: MSN <base64-encoded type-3-message> |
| 6: | C <-- S | +OK |
| | | Authorization succeeded. Client may continue with |
| | | e-mail transactions. |

Messages Used in the MSN Authentication Process

The messages used in the MSN authentication process include three messages sent in the MSN handshake that are binary structures. These are different from NTLM messages. Each one is described below as a pseudo-C struct and in a memory layout diagram.

By definition byte is an 8-bit field, short is a 16-bit field. All fields are unsigned. Numbers are stored in little-endian order. Struct fields named zero contain all zeroes. An array length of “*” indicates a variable length field. Hexadecimal numbers and quoted characters in the comments of the struct indicate fixed values for the given field.

The field flags are presumed to contain flags, but their significance is unknown; the values given are just those found in the packet traces.

Type-1 Message

The Type-1 Message message comprises the MSN Authentication request:

| | | |
|---|---|---|
| struct { | | |
| byte | protocol [8]; | // ‘N’, ‘T’, ‘L’, ‘M’, ‘S’, ‘S’, ‘P’, |
| ‘\0 ’ | | |
| byte | type; | // 0x01 |
| byte | zero[3]; | |
| short | flags; | // 0x8202 |
| byte | zero[2]; | |
| byte | type; | // 0x01 |
| byte | zero[15]; | |

} type-1-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 1 | 0 | 0 | 0 |
| 12: | 0x02 | 0x82 | 0 | 0 |
| 16: | 0x01 | 0 | 0 | 0 |
| 20: | 0 | 0 | 0 | 0 |
| 24: | 0 | 0 | 0 | 0 |
| 28: | 0 | 0 | 0 | 0 |

Byte 16 is always 0×01 and the meaning is unknown.

Type-2 Message

The Type-2 message comprises the server's MSN challenge:

| | | |
|---|---|---|
| struct { | | |
| byte | protocol[8]; | // ‘N’, ‘T’, ‘L’, ‘M’, ‘S’, ‘S’, ‘P’, |
| ‘/0’ | | |
| byte | type; | // 0x02 |
| byte | zero[3]; | |
| short | host_len; | // 0x0016 |
| short | host_len; | // 0x0016 |
| short | host_offset; | // 0x0028 |
| byte | zero[2]; | |
| short | flags; | // 0x8205 |
| short | extended_flags; | // 0x0002 |
| byte | nonce[8]; | // nonce |
| byte | zero[8]; | |
| byte | host[*]; | // host string (ASCII or ISO-8859-1) |

} type-2-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 2 | 0 | 0 | 0 |
| 12: | 0x16 | 0 | 0x16 | 0 |

| | | | |
|---|---|---|---|
| 16: | message len | 0 | 0 |

| | | | | |
|---|---|---|---|---|
| 20: | 0x05 | 0x82 | 0x02 | 0x00 |

| | |
|---|---|
| 24: | server nonce |
| 28: | |

| | | | | |
|---|---|---|---|---|
| 32: | 0 | 0 | 0 | 0 |
| 36: | 0 | 0 | 0 | 0 |

| | |
|---|---|
| 40: | host string |

The nonce is used by the client to create the LanManager response (see Password Hash section). It is an array of 8 arbitrary bytes. The message length field comprises the length of the complete message, which in this case is 40.

The host string ASCII or ISO-8859-1, is uppercased and not null-terminated. The host name is only the host name, not the FQDN (e.g. just “CPIMSPOPA10”, not “CPIMSPOPA10.POP3.MSN.COM”). The length of the host string is always 11 because the host name is in the format of CPIMSPOPAxx.

Type-3 Message

The Type-3 message comprises the username, local host name, domain name, and the Lan Manager response.

| struct { | | |
|---|---|---|
| byte | protocol[8]; | // ‘N’, ‘T’, ‘L’, ‘M’, ‘S’, ‘S’, ‘P’, |
| ‘\0’ | | |
| byte | type; | // 0x03 |
| byte | zero[3]; | |
| short | lm_resp_len; | // LanManager response length |
| | | (always |
| 0x18) | | |
| short | lm_resp_len; | // LanManager response length |
| | | (always |
| 0x18) | | |
| short | lm_resp_off; | // LanManager response offset |
| | | (always |
| 0x34) | | |
| byte | zero[6]; | |
| short | dom_off; | // domain string offset (always 0x4c) |
| byte | zero[2]; | |
| short | dom_len; | // domain string length |
| | | (always 0x03) |
| short | dom_len; | // domain string length |
| | | (always 0x03) |
| short | dom_off; | // domain string offset (always 0x4c) |
| byte | zero[2]; | |
| short | user_len; | // username string length |
| short | user_len; | // username string length |
| short | user_off; | // username string offset |
| byte | zero[6]; | |
| short | msg_len; | // message length |
| byte | zero[2]; | |
| byte | lm_resp[*]; | // LanManager response |
| byte | host[*]; | // host string (ASCII or ISO-8859-1) |
| byte | user[*]; | // username string (ASCII or ISO- |
| 8859-1) | | |

} type-3-message

| | 0 | 1 | 2 | 3 |
|---|---|---|---|---|
| 0: | ‘N’ | ‘T’ | ‘L’ | ‘M’ |
| 4: | ‘S’ | ‘S’ | ‘P’ | 0 |
| 8: | 3 | 0 | 0 | 0 |

| | | |
|---|---|---|
| 12: | LM-resp len | LM-Resp len |

| | | | |
|---|---|---|---|
| 16: | LM-resp off | 0 | 0 |

| | | | | |
|---|---|---|---|---|
| 20: | 0 | 0 | 0 | 0 |

| | | | |
|---|---|---|---|
| 24: | LM-resp off | 0 | 0 |

| | | |
|---|---|---|
| 28: | domain length | domain length |

| | | | |
|---|---|---|---|
| 32: | domain offset | 0 | 0 |

| | | |
|---|---|---|
| 36: | user length | user length |

| | | | |
|---|---|---|---|
| 40: | user offset | 0 | 0 |

| | | | | |
|---|---|---|---|---|
| 44: | 0 | 0 | 0 | 0 |

| | | | |
|---|---|---|---|
| 48: | message len | 0 | 0 |

| | |
|---|---|
| 52: | LanManager-response |

domain string

user string

The host, domain, and username strings are in ASCII or ISO-8859-1 and are not nul-terminated; the host and domain names are in upper case. The length of the response string is always 24.

The password hash calculation for MSN Authentication is the same as the NTLM Authentication.

This scheme authenticates connections, not requests. The network connection must be kept alive during the second part of the handshake, or the whole process must restart.

### EXAMPLE

### POP3 Session

Sample Session performed on pop3.email.msn.com Port 110 POP3.

| | | |
|---|---|---|
| 1: | C - -> S | AUTH MSN |
| 2: | C <- - S | + |
| | | Client request MSN authentication |
| 3: | C - -> S | TlRMTVNTUAABAAAAAoIAAAEAAAAAAAAAAAAAAAAAAAA= |
| | | Authorization: MSN <base64-encoded type-1-message> |
| 4: | C <- - S | + |
| | | TlRMTVNTUAACAAAAFgAWACgAAAAFggIAjbjJSkxNB3MAAAAAAAAAAEMAUABJAE0AUwBQAE |
| | | 8AUABBADEAMAA= |
| | | Client need to authentication: MSN <base64-encoded type- |
| | | 2-message> |
| 5: | C - -> S | TlRMTVNTUAADAAAAGAAYADQAAAAAAAAATAAAAAMAAwBMAAAABgAGAE8AAAAAAAAAVQAAAJ |
| | | nyfTDdQ28v5SVoSYQCwa0J1EJ4ivwaQk1TTmNsZXZyYQ== |
| | | Authorization: MSN <base64-encoded type-3-message> |
| 6: | C <- - S | +OK |
| | | Authorization succeeded. Client may continue with e-mail |
| | | transactions. |

Once the e-mail client is successfully authenticated, the client may continue with further e-mail transactions using standard POP3/IMAP commands. Currently, e-mail servers supporting MSN Authentication include only MSN POP e-mail servers (pop3.email.msn.com).

Detailed information on the MSN POP system access method 1400 useful in embodiments of the present invention is disclosed in the U.S. Provisional Patent Application of the present inventor, Baohua HUANG, serial No. 60/371,248, filed Apr. 10, 2002, and titled MSN POP E-MAIL SYSTEM ACCESS METHOD. Such is incorporated herein by reference.

Although particular embodiments of the present invention have been described and illustrated, such is not intended to limit the invention. After viewing this document, modifications and changes will no doubt become apparent to those skilled in the art, and it is intended that the invention only be limited by the scope of the appended claims.

The invention claimed is:

1. A personal e-mail system, comprising:
a single interface mechanism for providing one standardized user interface for the same user experience on any mobile or desktop device and computer in the sending and receiving of e-mail messages through a plurality of remote e-mail servers;
an e-mail messaging abstraction mechanism for providing a generic interface to higher-level system calls, and connected to the single interface mechanism;
a first e-mail protocol engine for accessing a preexisting user e-mail account at a first proprietary and unique e-mail server connected to the Internet, and connected between Internet and the e-mail messaging abstraction mechanism; and
a second e-mail protocol engine for accessing another preexisting user e-mail account at a second proprietary e-mail server having a protocol not compatible with the first proprietary e-mail server, and connected between the internet and the e-mail messaging abstraction mechanism.

2. The system of claim 1, wherein:
the single interface mechanism formats and converts a graphical user interface to suit a particular ad-hoc user computer platform.

3. The system of claim 1, wherein:
the e-mail messaging abstraction mechanism includes authentication, mailbox-manipulation, message-manipulation, and logout processing.

4. The system of claim 1, wherein:
the e-mail messaging abstraction mechanism includes authentication processing that supplies user id entity and passwords that satisfy at each of said first and second proprietary e-mail servers.

5. The system of claim 1, wherein:
the first and second e-mail protocol engines respectively handshake satisfactorily with the peculiar protocol requirements of each respective one of said first and second proprietary e-mail servers.

6. The system of claim 1, wherein:
at least one of the first and second e-mail protocol engines handshake satisfactorily with the peculiar protocol requirements of at least one of America On-Line, MSN Webmail, and HOTMAIL proprietary e-mail servers connected to the Internet.

7. The system of claim 1, wherein:
e-mail accounts and e-mail messages from different e-mail systems and servers are consolidated through download and synchronization, with duplicate detection for the removal of duplicated messages.

8. The system of claim 1, wherein a user is enabled to receive e-mails from all their corporate, ISP, AOL, Hotmail, and MSN e-mail accounts on any of a mobile device, Palm computer, PocketPC, cell phone, Blackberry wireless device, NTTDoCoMo, pager, and a personal computer.

9. The system of claim 1, wherein a user is enabled to reply, send, and forward e-mails such that the recipient appears to receive it from a respective corporate, ISP, AOL, Hotmail, and MSN e-mail account, while the sender is actually using any of a mobile device, Palm computer, PocketPC, cell phone, Blackberry wireless device, NTTDoCoMo, pager, and a personal computer.
